(19) United States
(12) Patent Application Publication
(10) Pub. No.: US 2014/0313468 A1
(43) Pub. Date: Oct. 23, 2014

(54) LIQUID CRYSTAL DISPLAY ELEMENT

(71) Applicant: DIC CORPORATION, Tokyo (JP)

(72) Inventors: Toru Fujisawa, Kita-adachi-gun (JP); Kazuaki Hatsusaka, Kita-adachi-gun (JP); Kazunori Maruyama, Kita-adachi-gun (JP); Isa Nishiyama, Kita-adachi-gun (JP)

(73) Assignee: DIC CORPORATION, Tokyo (JP)

(21) Appl. No.: 14/359,022

(22) PCT Filed: Nov. 15, 2012
(86) PCT No.: PCT/JP2012/079651

§ 371 Date: May 16, 2014

(30) Foreign Application Priority Data
Nov. 18, 2011 (JP) 2011-252481
Jul. 13, 2012 (JP) 2012-157689

(51) Int. Cl. G02F 1/141

(52) U.S. Cl. CPC G02F 1/141; G02F 1/1418
USPC 349/168; 349/184

(57) ABSTRACT

A ferroelectric liquid crystal composition having a chiral smectic C-phase is disposed as a liquid crystal composition layer between a first substrate and a second substrate arranged between two polarizing plates of which the planes of polarization are orthogonal to each other. The substrates are provided with vertically oriented films, respectively, and at least one of them is provided with orientation treatment that can form a pretilt angle in a certain direction. The C-director of the liquid crystal molecule is oriented in the certain direction at a portion being in contact with the substrate provided with the orientation treatment and is twisted by at least 180° between the first substrate and the second substrate. At least one of the substrates is provided with a pair of electrode structures generating electric fields approximately parallel to each other.

### TECHNICAL FIELD

The present invention relates to a liquid crystal display device including a ferroelectric liquid crystal composition.

### BACKGROUND ART

Ferroelectric liquid crystal (FLC) shows ferroelectricity through spontaneous polarization. It is known that liquid crystal having a permanent dipole moment in a direction vertical to the molecular long axis direction forms a layer structure of a smectic phase and that the permanent dipole moment is not cancelled as an average whole in changing to a chiral smectic C (hereinafter, abbreviated to SmC*) phase by tilting of the molecular long axis in this layer and thereby spontaneous polarization is caused to show ferroelectricity. Application of a voltage to the ferroelectric liquid crystal allows the permanent dipole moment to be directed to the electric field and simultaneously allows the whole molecule to be aligned. The ferroelectric liquid crystal widely used in displays is of SmC* phase. Ferroelectric liquid crystal imparts optical activity (chirality) to smectic liquid crystal itself, such as p-decyloxybenzylidene p′-amino 2-methylbutyl cinnamate (DOBAMBC) molecular-designed and synthesized by R. B. Meyer et al. in 1975. Even if an optically active compound itself does not have liquid crystalline properties (non-liquid crystal compound), a SmC* phase can be expressed by addition of the optically active compound. In such a case, a liquid crystal matrix having a non-chiral smectic C (hereinafter, abbreviated to SmC) phase is usually used.

Among smectic phases having layer structures, in the SmC* phase, the orientation direction of the liquid crystal molecule has a certain tilt with respect to the layer normal. In addition, the angle (azimuth) of the tilt with respect to a layer plane slightly shifts for each layer, which forms a helical structure in the molecular orientation.

The response of display devices using ferroelectric liquid crystal is characteristically 10 times or more rapid compared to display devices using nematic liquid crystal. Clark and Lagerwall first applied surface-stabilized ferroelectric liquid crystal (SSFLC) to displays. After this, ferroelectric liquid crystal has been actively investigated.

In SSFLC, the helix is loosened by orienting the liquid crystal with a parallel-oriented substrate such that the layer normal is parallel to the substrate surface of a cell (homogeneous orientation) and reducing the thickness of the liquid crystal layer. Consequently, the liquid crystal molecule hardly orients in a direction tilting with respect to the substrate surface, and the range of the azimuth is controlled by two ways, the memory (bistability) of the orientation is expressed by the function of the surface stabilization to give a display by black and white binary display having memory, and a rapid response is achieved. However, the binary display has a problem of a difficulty in provision of gradation display. Furthermore, when the liquid crystal having increased temperature is disposed between substrates and then cooled to form a SmC* phase, the liquid crystal tilts to decrease the distance between the substrates. As a result, the layer plane is bent from the waist to form a chevron structure, and a zigzag defect is apt to occur, resulting in difficulty in provision of high contrast. Accordingly, investigation of orientation for applying to displays has been enthusiastically performed (see NPL 1).

In order to solve the difficulty in gradation display due to bistability, as a system of restricting the range of an azimuth, twisted helix (or modified helix) ferroelectric liquid crystal (DHFLC: distorted (or deformed) helix FLC) is also known (see NPL 2). In this system, the helical pitch of the FLC is sufficiently short so as to be smaller than the thickness of the liquid crystal layer between substrates. This system has a uniaxial birefringence having the axis in the helical axis direction in a no-voltage-application state. In a voltage-application state, the helical array of the liquid crystal orientation is gradually released to change the birefringence and thereby provides continuous gradation display. However, the DHFLC described in NPL 2 has a layered structure vertical to the substrate surface, that is, the layer normal direction is approximately parallel to the substrate surface, and the DHFLC therefore has a problem in the viewing angle of the display device.

In order to improve the viewing angle of ferroelectricity liquid crystal display devices, the technology developed in the nematic liquid crystal display field has been applied to ferroelectric liquid crystal. In the case of using nematic liquid crystal, though the vertical orientation system uses an electric field in the direction vertical to the substrates, the improvement of the viewing angle has been done by using the vertical orientation of a liquid crystal molecule. In-plane switching (IPS) is a method of improving the viewing angle by switching a horizontally oriented liquid crystal molecule with the transverse electric field in the horizontal direction relative to the substrates. As combination of vertical orientation and IPS, for example, NPLs 3 and 4 describe liquid crystal display devices in which a transverse electric field is applied to vertically oriented DHFLC by in-plane electrodes composed of a pair of comb electrodes provided to the substrate on the lower side. NPL 5 describes an optical modulator by incidence of laser beams from various directions for readout in a state of applying a transverse electric field to vertically oriented DHFLC. However, in order to obtain high contrast equivalent to that of a VA mode, which has been developed in nematic liquid crystal, with ferroelectric liquid crystal, it is necessary to remove the orientation defect specific to SmC*. In order to do that, it is known a method of vertically orienting ferroelectric liquid crystal with a short helical pitch of 400 nm or less. In this case, however, the chiral dopant concentration is high, resulting in a high melting point. Consequently, the temperature range of the SmC* phase is narrow to restrict the operating temperature range of the liquid crystal display device, and a strong electric field is necessary for loosening the short pitch helix, resulting in a high driving voltage. The production of the chiral dopant is complicated, and therefore the use of a large amount of the chiral dopant inhibits efficient production of the ferroelectricity liquid crystal display device, which is also an obstacle for practical applications from an economical viewpoint. In SSFLCD, if the orientation is disturbed once by deformation of a device due to, for example, an external pressure, it is difficult to return from the disturbed orientation. Though the cell structure and polymer stabilization have been designed to overcome it, an increase in size has not been achieved.

### CITATION LIST

### Non Patent Literature

NPL 1: Chenhui Wang and Philip J. Bos, “5.4: A Defect Free Bistable C1 SSFLC Display”, SID 02 Digest, 2002, pp. 34-36
NPL 2: J. Funfschilling and M. Schadt, “Fast responding and highly multiplexible distorted helix ferroelectric liquid crystal display devices”, J. Appl. Phys., 1989, October, Vol. 66, No. 8, pp. 3877-3882
NPL 3: Ju Hyun Lee, Doo Hwan You, Jae Hong Park, Sin Doo Lee, and Chang Jae Yu, “Wide-Viewing Display Configuration of Helix-Deformed Ferroelectric Liquid Crystals”, Journal of Information display, 2000, December, Vol. 1, No. 1, pp. 20-24
NPL 4: John W. McMurdy, James N. Eakin, and Gregory P. Crawford, “P-127: Vertically Aligned Deformed Helix Ferroelectric Liquid Crystal Configuration for Reflective Display Device”, SID 06 Digest, 2006, pp. 677-680
NPL 5: A. Parfenov, “Deformation of ferroelectric short-pitch helix liquid crystal by transverse electric field: Application for diffraction-based light modulator”, Applied Physics Letters, 1998, December, Vol. 73, No. 24, pp. 3489-3491

### SUMMARY OF INVENTION

### Technical Problem

The present invention provides a liquid crystal display using a ferroelectric liquid crystal composition having homeotropic orientation showing a rapid response. The liquid crystal display achieves high contrast, equivalent to that of a VA mode in nematic liquid crystal, by inhibiting appearance of schlieren texture causing absence of light and solving other orientation defects to inhibit a reduction in contrast.

### Solution to Problem

The present inventors have investigated on a reduction in the amount of chiral dopant added and elongating the helical pitch for solving the problems. As a result, the inventors have found that appearance of schlieren texture based on the fluctuation of the C-director similar in the behavior of the director of nematic liquid crystal molecule, which occurs when liquid crystal showing a SmC* phase having a long helical pitch is homeotropically oriented, and the orientation defect due to focal conic can be effectively prevented by combining horizontal orientation processing capable of providing a pretilt angle in a certain direction with a chiral smectic C-phase, and the present invention has been accomplished.

The present invention provides a liquid crystal display device including a first substrate provided with an oriented film and a second substrate provided with an oriented film between two polarizing plates of which the planes of polarization are orthogonal to each other; and a ferroelectric liquid crystal composition layer having a chiral smectic C-phase between the first and the second substrates. At least one of the vertically oriented films of the first substrate and the second substrate is provided with orientation treatment capable of forming a pretilt angle in a certain direction in a nematic liquid crystal phase; the ferroelectric liquid crystal composition layer in which the C-director of the liquid crystal molecule is oriented in the certain direction at a portion being in contact with the substrate having the vertically oriented film provided with the orientation treatment; the director of the liquid crystal is twisted by at least 180° between the first substrate and the second substrate; a substrate surface of at least one of the first substrate and the second substrate is provided with a pair of electrode structures generating electric fields approximately parallel to each other; and the light transmittance is modulated by varying the birefringence of the ferroelectric liquid crystal composition layer with the electric fields generated by the electrode structures.

### Advantageous Effects of Invention

In liquid crystal display devices using homeotropically oriented ferroelectric liquid crystal compositions, when the selective reflection is near infrared or longer, schlieren texture appears to cause a reduction in contrast. In the liquid crystal display device of the present invention, impartment of a pretilt angle by, for example, rubbing orientation treatment of a vertically oriented film surface allows the C-director of a SmC* phase to align in the rubbing director and thereby can solve the appearance of schlieren texture, resulting in high contrast display without causing orientation defects. In addition, though the orientation is disturbed by pushing the display face, the orientation returns, which is impossible in SSFLCD, and a highly reliable liquid crystal display device can be achieved.

### BRIEF DESCRIPTION OF DRAWINGS

FIG. 1 includes schematic diagrams illustrating a first example of the liquid crystal display device of the present invention, wherein diagram (a) illustrates the OFF state, and diagram (b) illustrates the ON state.

FIG. 2 includes schematic diagrams illustrating a second example of the liquid crystal display device of the present invention, wherein diagram (a) illustrates the OFF state, and diagram (b) illustrates the ON state.

FIG. 3 is a graph showing a relationship between cell thickness d and Δn at maximum transmittance.

FIG. 4 includes schematic diagrams illustrating refractive index distributions in plan view.

FIG. 5 is a graph showing V-T characteristics in the liquid crystal display device of Example 1.

### DESCRIPTION OF EMBODIMENTS

The present invention will now be described based on preferred embodiments with reference to the drawings.

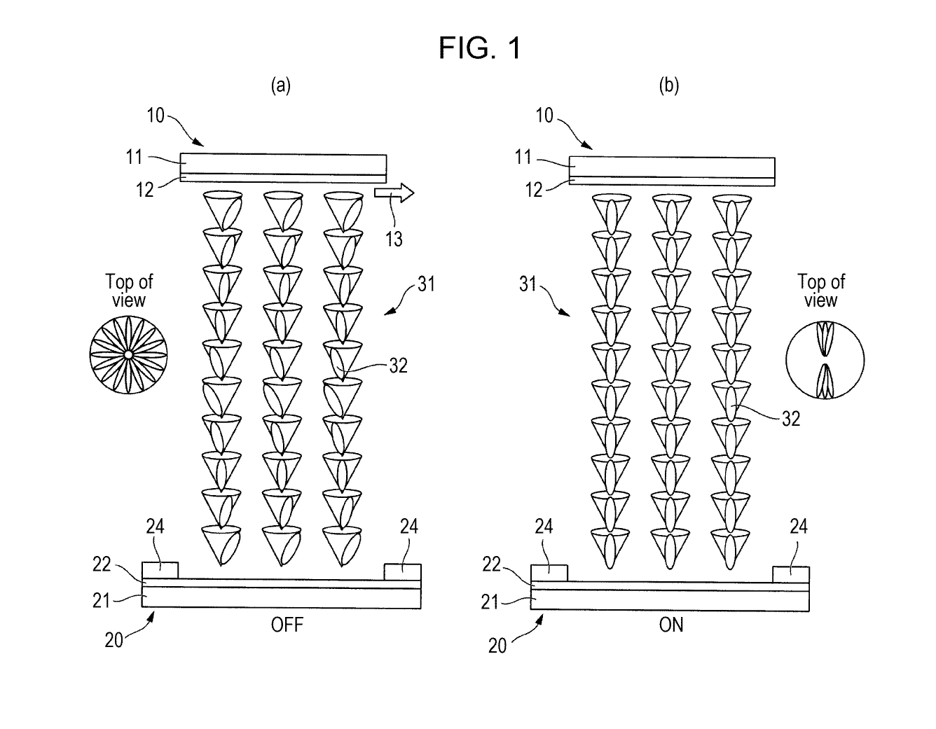

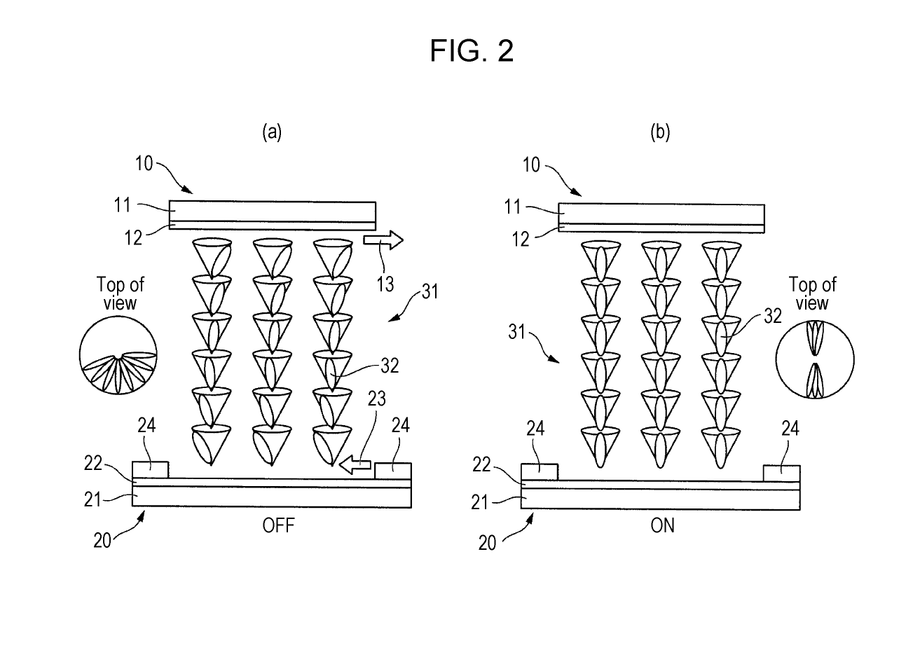

FIG. 1 shows a first example of the liquid crystal display device of the present invention, and FIG. 2 shows a second example of the liquid crystal display device of the present invention, wherein each diagram (a) shows the OFF state, and each diagram (b) shows the ON state.

The liquid crystal display devices shown in the drawings each has a cell structure including a pair of substrates 10 and 20 each composed of a transparent base material such as a glass plate 11, 21 and an oriented film 12, 22, and a ferroelectric liquid crystal composition layer 31 having a chiral smectic C-phase disposed between the first substrate 10 and the second substrate 20. The substrates 10 and 20 and the liquid crystal composition layer 31 is disposed between two polarizing plates (not shown) of which the planes of polarization are orthogonal to each other (i.e., in a cross Nicol state).

In the voltage-OFF state, the molecular long axis of the ferroelectric liquid crystal composition forms a helix, and the helical axis of the chiral smectic C-phase is in the direction vertical to the substrate surface. Selective reflection centered on a given wavelength depending on the helical pitch is induced. The central wavelength of the selective reflection can be denoted by the product of the average refractive index n of the composition and the helical pitch P of the SmC*, n·P, and the central wavelength thereof depends on not only the refractive index but also the type and amount of the chiral dopant composition. In the liquid crystal display device of the present invention, the selective reflection preferably has a near infrared or longer wavelength, e.g., 700 to 3000 nm. The helical pitch is affected by the average refractive index of the composition and corresponds to about 450 to 2000 nm. The shift of the selective reflection from the visible light region inhibits the coloring due to selective reflection, and two substrates on both sides of the composition layer hardly transmit visible light to give a dark field, which is useful for full-color display and high contrast display. However, it is limited to the case that the C-director is aligned in a certain direction. In the method of aligning the C-director in a certain direction, orientation treatment having a property of imparting a pretilt angle to a certain direction in a nematic liquid crystal phase with a vertically oriented film is applied to a vertically oriented SmC* phase. If this orientation treatment is not performed, the direction of the C-director becomes random, and vibration caused by thermal fluctuation scatters visible light, which gives schlieren texture in polarizing microscopic observation. Application of this to display devices causes slight white turbidity, resulting in difficulty of high contrast display. However, for example, rubbing treatment of a vertically oriented film to impart a pretilt angle to the layer such that the director of the liquid crystal molecule tilts to a certain direction relative to the substrate surface allows the C-director to align in the rubbing direction and the schlieren texture to disappear to provide a dark field equivalent to that of polarizing plates and allows high contrast display, which are notable characteristics.

The orientation treatment having a property of imparting a pretilt angle to a certain direction in a nematic liquid crystal phase with a vertically oriented film is rubbing treatment of the surface with a vertically oriented film of, for example, polyimide. Application of the orientation treatment to a nematic liquid crystal cell having a VA mode imparts a pretilt angle to the vertically oriented liquid crystal molecular long axis, and the orientation direction of tilting of the liquid crystal molecular long axis during the switching is restricted by the rubbing treatment direction. Application of an oriented film having such a property to a vertically oriented SmC* phase characteristically allows the C-director to align in the rubbing direction, and any oriented film having such a property can be used. The oriented film that can be used is, for example, a polyimide oriented film showing vertical orientation or a photo-oriented film for vertical orientation that can impart a pretilt angle to nematic liquid crystal. The pretilt angle has any size that can solve the schlieren texture in a vertically oriented SmC* phase and align the C-director in the rubbing orientation direction.

The first substrate 10 and the second substrate 20 respectively have vertically oriented films 12 and 22, and at least one of the vertically oriented films 12 and 22 is provided with orientation treatment capable of providing a pretilt angle in a certain direction 13, 23. As a result, in the OFF state not applying an electric field, the ferroelectric liquid crystal composition layer 31 in which the C-director of the liquid crystal molecule 32 is oriented in the certain direction 13, 23 at a portion being in contact with the vertically oriented film 12, 22 provided with the orientation treatment to align the C-director of the SmC* phase in the orientation treatment direction. Consequently, appearance of schlieren texture caused by a reduction in chiral dopant amount can be solved, resulting in high contrast display precluding orientation defects.

When orientation treatment capable of providing a pretilt angle in a certain direction is applied to both vertically oriented films 12, 22, the direction 13 of orientation treatment for the first vertically oriented film 12 and the direction 23 of orientation treatment for the second vertically oriented film 22 may be different. A difference (an integer multiple of)+360° between the orientation directions 13, 23 corresponding to the twist angle of the C-director between the substrates allows the C-director to easily align in a certain direction 13, 23 near the respective substrates and is therefore preferred. Alternatively, orientation treatment capable of providing a pretilt angle may be applied to only one of the vertically oriented films 12, 22.

The substrate surface of at least one of the first substrate 10 and the second substrate 20 includes a pair of electrode structures 24, 24 generating approximately parallel electric fields. The birefringence of the ferroelectric liquid crystal composition layer 31 is changed by means of the electric fields generated by the electrode structures 24, 24 to modulate the transmittance of transmitted light. In the example shown in the drawing, in the OFF state, the C-director of the liquid crystal molecule 32 can direct in various directions of the helical structure (see Top of views in diagrams (a) of FIGS. 1 and 2). Therefore, the incident light from one of the two polarizing plates in a cross Nicol state cannot transmit through the other polarizing plate, resulting in a dark field (black display) as described above. Examples of the electrode structures 24, 24 include interdigitated array electrodes (IPS electrodes) and fringe field switching (FFS) electrodes. Both of the substrates 10 and 20 may have the electrode structures 24, 24.

The helix is loosened by gradually increasing the transverse electric field applied through the interdigitated array electrodes (IPS electrodes) disposed on the substrate surface, and the liquid crystal molecular long axis is aligned in the direction vertical to the transverse electric field, resulting in an increase in transmittance. The change in retardation (Δn·d, Δn: birefringence, d: cell thickness) on this occasion is similar to the ECB mode in nematic liquid crystal. Accordingly, in order to maximize the transmittance, it is necessary to adjust the retardation to λ/2, where λ denotes the wavelength of transmitted light (representative value). In general, a wavelength of about 550 nm, which gives highest visual sensitivity, is used.

The intensity I of emitted light passed through a cell having retardation (Δn·d) is represented by (Expression 1).

$$\begin{matrix}[ Math . 1 ] & \\ I = {I}_{0} {sin}^{2} ( \frac{π \cdot Δ n \cdot d}{λ} ) & ( Expression 1 )\end{matrix}$$

In Expression 1, I₀ represents incident light intensity; and the transmittance is represented by a ratio I/I₀. Expression 1 demonstrates that when Δn·d is π/2, transmittance is the highest. In order to determine Δn from (Expression 1), (Expression 1) can be modified into (Expression 2).

$$\begin{matrix}[ Math . 2 ] & \\ Δ n = \frac{λ}{π \cdot d} {sin}^{- 1} \sqrt{\frac{I}{{I}_{0}}} & ( Expression 2 )\end{matrix}$$

Ideally, the emitted light intensity I is 1 for an incident light intensity I₀ of 1, which is achieved when the retardation (the product of Δn and d) is equal to a λ/2 of 275 nm.

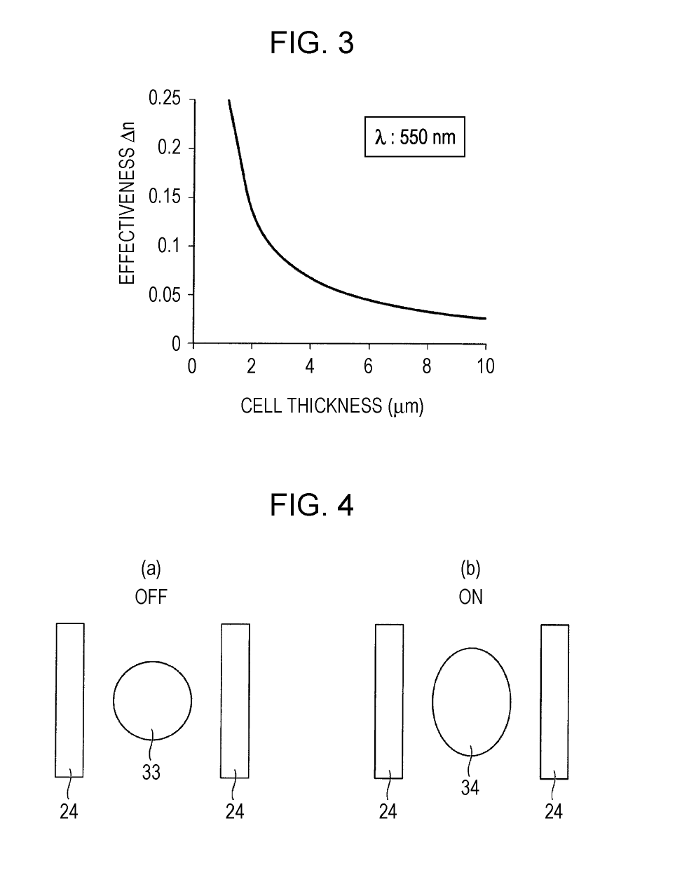

The graph shown in FIG. 3 shows a relationship between cell thickness d and Δn at maximum transmittance. Accordingly, light with a wavelength of about 550 nm can be transmitted substantially without loss by adjusting the cell thickness depending on the Δn of the ferroelectric liquid crystal material to be used. In full-color display, it is necessary to consider color balance. Accordingly, the wavelength of λ/2 may be adjusted depending on the wavelength dispersion characteristics of retardation and the spectra of the color filter and backlight used.

The Δn of liquid crystal in the present invention refers to a Δn determined from (Expression 3) using the refractive index nₑ in the molecular long axis direction determined when the helix is loosened by application of a voltage to a smectic C* phase or when the helix is loosened by using surface-stabilized ferroelectric liquid crystal (SSFLC: surface-stabilized FLC) and the refractive index nₒ in the molecular short axis direction. The θ (tilt angle) in (Expression 3) denotes the value of ½ of the cone angle 20 of a smectic C* phase. That is, a Δn effective for the voltage-transmittance characteristics of the liquid crystal display device is represented by (Expression 3) and depends on the tilt angle θ and the nₑ and nₒ described above. For example, when the tilt angle θ is 30°, in the liquid crystal display device of the present invention, the cell thickness may be adjusted such that the transmittance is maximum depending on Δn. In liquid crystal having a small difference Δn_{lc} between nₑ and nₒ of 0.13 or less, the effective Δn is 0.0296, and a necessary cell thickness is 10 μm or more, from (Expression 2). When the Δn_{lc} is 0.15 or more, the effective Δn is 0.0336, and a necessary cell thickness is 8.5 μm or less, from (Expression 2). Furthermore, when the tilt angle θ is 35° or more, the effective Δn is 0.0447 or more, and a necessary cell thickness is 6.4 μm or less, which is further preferred. That is, the cell thickness can be reduced with a large Δn_{lc} of 0.15 or more of liquid crystal and a tilt angle θ of 35° or more, which improves the display quality and is further preferred.

$$\begin{matrix}[ Math . 3 ] & \\ Δ n = {n}_{eff} - {n}_{o} = \frac{{n}_{e} {n}_{o}}{\sqrt{{n}_{o}^{2} {sin}^{2} θ + {n}_{e}^{2} {cos}^{2} θ}} - {n}_{o} & ( Expression 3 )\end{matrix}$$

The minimum value of the retardation is a value when in a voltage-OFF state, the helix of which the axis is in a normal direction of the substrate turns at least one time, and is preferably a dark field having a transmittance equivalent to that of the polarizing plates in a cross Nicol state. A smaller value provides better blackness and higher contrast. For example, when the birefringence Δnₕₑₗᵢₓ in a helical state is 0 to 0.007, a cell thickness of 15 μm or less allows a retardation of 75 nm or less to give blackness necessary for high contrast and is therefore preferred. This is because that when the helix of a SmC* phase turns at least 360°, the refractive-index anisotropy distributes so as to draw an arc with the helical axis as the center, and as shown in FIG. 1(a), the distribution of the refractive index is homogenous in all directions to be approximately isotropic. The Δn converges to 0 with an increase in the number of turning of the helix to enhance the blackness. Therefore, the retardation is reduced by adjusting the Δnₕₑₗᵢₓ to 0.002 or less and thereby preferably reduce the transmittance.

In order to obtain a dark field in the OFF state, the helical structure of ferroelectric liquid crystal is required to have a unit that is repeated one or more times. Black equivalent to that of polarizing plates in a cross Nicol state can be theoretically obtained by uniformizing the distribution of refractive-index anisotropy in the X-Y plane. An increase in helical pitch when the helix is in a normal direction of the substrate may increase the retardation. In such a case, an optical phase compensation film is preferably disposed between two polarizing plates in a cross Nicol state, in addition to the liquid crystal layer, as necessary. The pitch of the helical structure is the length in a direction vertical to the layer when a rotation of 360° of the C-director is defined as one cycle. The spontaneous polarization of a liquid crystal molecule is in a direction vertical to the liquid crystal molecular long axis. The liquid crystal molecule can be aligned in such a manner that the head and the tail of the liquid crystal molecular long axis are in opposite directions. Assuming that a half of molecules and the other half of the molecules are arranged with the head and the tail thereof in opposite directions, it is possible to regard the range of a rotation of the C-director by 180° as one cycle of a repeating unit. Accordingly, it is required that the C-director of the liquid crystal molecule 32 is twisted by at least 180° between the first substrate 10 and the second substrate 20. That is, the twist angle of the C-director between the substrates may be 180° or more. There is no upper limit, but from the viewpoint of an increase in cell thickness by lengthening the pitch of the helical structure, the twist angle is preferably, for example, 180° to 1800°.

On the other hand, the retardation in the voltage-ON state varies depending on the applied voltage. FIG. 4 shows the distributions in size of refractive index between IPS electrodes 24 in plan view. As described above, in the OFF state, the distribution forms a circle 33. Application of a voltage allows the permanent dipole vertical to the molecular long axis to align by the action of the transverse electric field of the electrodes and simultaneously allows the molecular long axis to align in the major axis direction of the ellipse. As a result, the refractive index forms an elliptical distribution 34, and a further increase in voltage elongates the major diameter of the ellipse along the IPS electrodes to increase the Δn, resulting in an increase of ellipticity. Light can be extracted with the highest emission intensity by arranging the polarization axis of one of the polarizing plates orthogonal to the state mentioned above so as to form an angle of 45° with respect to the major axis of the ellipse. However, as described above, a retardation value of λ/2 can give a high emission light intensity and is therefore preferred. Since an increase in transmittance as the whole visible region is important for brightness of display and color balance, the retardation may be about 275 nm depending on the color tone of the display device and can be, for example, 225 to 330 nm as necessary. Accordingly, the cell thickness is determined by the value obtained by dividing the maximum retardation in the ON state by the Δn of the ferroelectric liquid crystal composition used and is preferably within a range of 2 to 15 μm.

Even if the orientation is disturbed by deformation of the device due to, for example, external pressure, within the range of the selective reflection of the liquid crystal used in the present invention, it is possible to return to the original orientation state by the helical winding force. Thus, high reliability can be characteristically achieved.

In order to fill between the substrates with liquid crystal without causing orientation defects, conventional vacuum injection, liquid crystal drop injection (One Drop Fill), or flexographic printing can be employed, and it is preferable to at least perform phase transition by slow cooling from an isotropic phase or a nematic phase, formed by heating, to a smectic phase. In order to achieve high contrast display, orientation defects are required to be removed; and in the phase sequence of the ferroelectric liquid crystal composition composed of at least, from the high temperature side, an isotropic phase, a chiral nematic phase, a smectic A phase, and a chiral smectic C-phase (ISO-N*-SmA-SmC*), from the viewpoint of increasing the tilt angle of the liquid crystal compound, the phase sequence preferably does not include the smectic A phase. A preferred example thereof is (ISO-N*-SmC*). In such a case, another phase such as a blue phase (BP) may be expressed on the higher temperature side than the nematic phase, and examples the phase sequence include isotropic liquid-blue phase-chiral nematic phase-smectic A phase-chiral smectic C-phase, isotropic liquid-blue phase-chiral nematic phase-chiral smectic C-phase. In addition, liquid crystal expressing phase sequence of isotropic liquid-chiral smectic C-phase (ISO-SmC*) can be employed.

In the phase sequence of the ferroelectric liquid crystal composition, the helical pitch of a chiral nematic phase is preferably at least 5 times larger than the cell thickness at a temperature of phase transition from a chiral nematic phase to a smectic A phase or a chiral smectic C-phase during a decrease in temperature or a temperature higher than the lower limit temperature of the chiral nematic phase by 2° C. Furthermore, a homeotropic orientation state is more preferred by that the helix is loosened during transition to a smectic phase, which appears at a temperature lower than that of an N* phase. In this case, since the helical pitch is sufficiently longer that the cell thickness (gap) when the liquid crystal is a chiral nematic phase, the chiral nematic phase does not form a helical structure and gives a satisfactory homeotropic orientation without causing orientation defects before transition to a smectic phase, resulting in further uniform orientation. In order to loosen the helical pitch of a chiral nematic phase for transition to a smectic phase, the temperature width is preferably at least 10° C. A narrow temperature width cannot loosen the helix and may cause transition to a smectic phase, which causes an orientation defect. Alternatively, helix can be adjusted by addition of a pitch canceller showing reverse helix for loosening the helix of a chiral nematic phase.

Since the orientation state in the OFF state is similar to vertical uniaxial orientation in a nematic liquid crystal display device having a VA mode, the contrast and the viewing angle can be improved by using an A-plate, which is used in a VA mode, or an optical phase compensation film such as a negative C-plate in uniaxial stretching or a Z-plate in biaxial stretching. Among a variety of types of preferred optical phase compensation films, films having a function of improving viewing angle used in, for example, a VA mode and a function of improving contrast can improve the viewing angle and the contrast and are therefore preferred. In order to improve contrast, an optical phase compensation film that can reduce the minimum transmittance is preferred. In a liquid crystal layer between two polarizing plates in a cross Nicol state, linearly polarized light passed through the liquid crystal layer may be changed to elliptically polarized light and be then emitted. In such a case, when the polarization axis of linearly polarized light entering the liquid crystal layer and having the same ellipticity as that of the elliptically polarized light emitted from the liquid crystal layer is defined as a center of symmetry, an optical phase compensation film showing an opposite phase symmetrical relative to the azimuth of elliptically polarized light emitted from the liquid crystal layer is preferably disposed between two polarizing plates in a cross Nicol state, as necessary.

The liquid crystal display device may have any light source. LED is low power consumption and is therefore preferred. In order to further reduce power consumption, it is preferred to use flash controlling (technology of reducing the light quantity at a dark region or switching the light off), a multi-field driving method (technology of distinguishing the driving frequencies in moving picture display and still picture display), a technology of switching light quantity modes between indoors and outdoors or between night and day, or a technology of temporarily stopping the driving using the memory of a liquid crystal display device. A reflective display device can use exterior lighting means (e.g., sunlight or indoor light), even if the apparatus does not have a light source, and is therefore preferred.

The liquid crystal display device can also three-dimensionally display by, for example, time sharing such as a field sequential system, space sharing such as a polarization system, parallax barrier system, or integral imaging system, wavelength sharing such as a spectral system or anaglyph, or an FPS mode.

In order to drive at a low voltage, the pair of substrates may each have a structure having a pair of a pixel electrode and a common electrode. In order to drive at a low voltage, the pair of substrates may be each provided with an in-plane switching (IPS) electrode; confined geometry (Lee, S.-D., 2009, IDW '09-Proceeding of the 16th International Display Workshots 1, pp. 111-112) may be utilized in a device by an electrode protruding inside the cell in which the electric field strength distribution hardly decreases, or the pair of substrates may be each provided with a fringe-field switching (FFS) electrode.

The contrast is preferably improved by flash controlling (technology of reducing the light quantity at a dark region or switching the light off), a device having an aperture ratio of 50% or more, use of a highly oriented film or antiglare film, or use of a field sequential system (colorizing system allowing recognition of a color, without using color films, by sequentially lighting LEDs of RGB three colors each for a short time less than the temporal resolution of the human eyes).

For a rapid response, it is preferable to use an over drive function (allowing the voltage for expressing a tone to be high at the rise time and to be low at the fall time) or use smectic liquid crystal having negative dielectric anisotropy.

The film covering the surface of a touch panel preferably has water and oil repellency, antifouling properties, and fingerprint resistance for inhibiting a decrease in display quality by fouling. At least the electrode substrate on the pressing side is preferably a flexible substrate such as a plastic substrate or thin film glass substrate. The electrode is preferably made of graphene (a sheet consisting of carbon monoatomic layer) or an organic semiconductor.

The two substrates of a liquid crystal cell can be made of a transparent material having flexibility, such as glass or plastic, and one of two may be made of an opaque material such as silicon. A transparent substrate provided with a transparent electrode layer can be prepared by sputtering indium tin oxide (ITO) on a transparent substrate such as a glass plate.

A color filter can be produced by, for example, pigment dispersion, printing, electrodeposition, or dyeing. Production of a color filter by pigment dispersion will be described as an example of the method. A curable coloring composition for a color filter is applied onto the transparent substrate, patterned, and is cured by heating or light irradiation. This step is performed for each of three colors: red, green, and blue, to produce a pixel portion for a color filter. In addition, a thin-film transistor (TFT) with an organic semiconductor, inorganic semiconductor, or oxide semiconductor, a thin-film diode, or a pixel electrode provided with an active element such as a metal insulator metal resistance element, may be disposed on the substrate.

The ferroelectric liquid crystal composition may be subjected to removal of impurities for improving reliability or for TFT driving or may be subjected to purification with, for example, silica or alumina for further increasing the resistivity. The resistivity for TFT driving of a liquid crystal composition is preferably 10¹¹ Ω·cm or more, more preferably 10¹² Ω·cm or more, and more preferably 10¹³ Ω·cm or more. In order to prevent the influence of cations present as impurities in a liquid crystal composition, a cationic inclusion compound such as podand, coronand, or cryptand may be added to the composition. In TFT driving, image information is recorded at a certain time interval, and a charge is maintained between electrodes during the time to display an image. Since switching reduces the charge maintained between the electrodes due to the influence of polarization inversion current by spontaneous polarization, an auxiliary capacitance is preferably connected to the pixel. An auxiliary capacitance suitable for spontaneous depolarization of liquid crystal used can be connected.

In order to maintain the performance of the liquid crystal display device under low temperature environment, the ferroelectric liquid crystal composition preferably has low-temperature storage stability. The low-temperature storage stability of the liquid crystal composition is preferably that SmC* is maintained at 0° C. or less for 24 hours, more preferably that SmC* is maintained at −20° C. or less for 500 hours, and more preferably at −30° C. or less for 700 hours.

### <Ferroelectric Liquid Crystal Composition>

The ferroelectric liquid crystal composition used in the present invention can contain a chiral compound (dopant) in the host liquid crystal (liquid crystal matrix) and further appropriately contain a monomer (polymerizable compound) for polymer stabilization.

The use of such a ferroelectric liquid crystal composition can stabilize the orientation and improve the response speed in intermediate gradation. In order to fix a state of liquid crystal oriented with, for example, an oriented film without causing orientation defects, at least phase transition from a nematic phase to a smectic phase by slow cooling is preferably performed, as in the case of not containing the monomer. More preferably, the substrate surface of the liquid crystal cell used is flat. In addition, it is necessary to polymerize the monomer in a mesh shape or in a dispersed state in a liquid crystal phase such as a nematic phase or a smectic phase. Furthermore, in order to inhibit the formation of a phase separation structure, it is preferable to use a small amount of a monomer and adjust the content and the composition of a polymer precursor such that a mesh-like polymer is formed among oriented liquid crystal molecules. In photopolymerization, it is preferably to adjust UV exposure time, UV exposure strength, and temperature to form a mesh-like polymer not to cause liquid crystal orientation defects.

### <Liquid Crystalline Compound>

The liquid crystalline compound as the host is preferably represented by the following Formula:

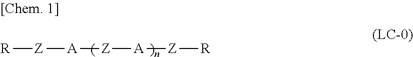

(where, R's each independently represent a linear or branched alkyl group having 1 to 18 carbon atoms, a hydrogen atom, or a fluorine atom, in which one —CH₂— group or two non-adjacent —CH₂— groups of the alkyl group are each optionally substituted with —O—, —S—, —CO—, —CO—O—, —O—CO—, —CO—S—, —S—CO—, —O—SO₂—, —SO₂—O—, —O—CO—O—, —CH═CH—, —C≡C—, a cyclopropylene group, or —Si(CH₃)₂—, and one or more hydrogen atoms of the alkyl group are each optionally substituted with a fluorine atom, a chlorine atom, a bromine atom, or a CN group;

Z's each independently represent —O—, —S—, —CO—, —CO—O—, —O—CO—, O—CO—, —O—CO—O—, —CO—N(R^{a})—, —N(R^{a})—CO—, —OCH₂—, —CH₂O—, —SCH₂—, —CH₂S—, —O—SO₂—, —SO₂—O—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—CO—O—, —O—CO—CH═CH—, or a single bond, in which R^{a} of —CO—N(R^{a})— or —N(R^{a})—CO— represents a hydrogen atom or a linear or branched alkyl group having 1 to 4 carbon atoms;

A's each independently represent a cyclic group selected from a phenylene group, a cyclohexylene group, a dioxolanediyl group, a cyclohexenylene group, a bicyclo[2.2.2]octylene group, a piperidinediyl group, a naphthalenediyl group, a decahydronaphthalenediyl group, a tetrahydronaphthalenediyl group, and an indanediyl group, in which in the phenylene group, the naphthalenediyl group, the tetrahydronaphthalenediyl group, and the indanediyl group, one or more —CH═ groups in each ring are each optionally substituted with a nitrogen atom; in the cyclohexylene group, the dioxolanediyl group, the cyclohexenylene group, the bicyclo[2.2.2]octylene group, the piperidinediyl group, the decahydronaphthalenediyl group, the tetrahydronaphthalenediyl group, and the indanediyl group, one —CH₂— group or two non-adjacent —CH₂— groups of each ring are each optionally substituted with —O— or —S—; and one or more hydrogen atoms of each cyclic group are each optionally substituted with a fluorine atom, a chlorine atom, a bromine atom, a CN group, a NO₂ group, or an alkyl, alkoxy, alkylcarbonyl, or alkoxycarbonyl group having 1 to 7 carbon atoms in which one or more hydrogen atoms are each optionally substituted with a fluorine atom or a chlorine atom; and

n represents 1, 2, 3, 4, or 5).

The liquid crystalline compound is also preferably one of liquid crystalline compounds represented by Formulae (LC-I) to (LC-III):

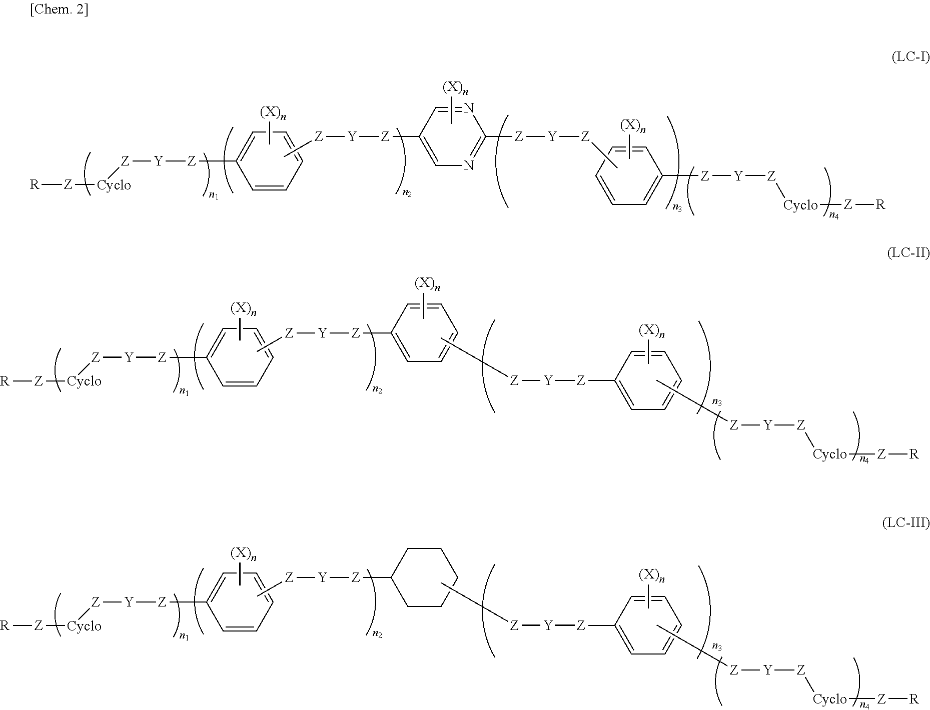

(where, R's each independently represent a linear or branched alkyl group having 1 to 18 carbon atoms, a hydrogen atom, or a fluorine atom, in which one —CH₂— group or two non-adjacent —CH₂— groups of the alkyl group are each optionally substituted with —O—, —S—, —CO—, —CO—O—, —O—CO—, —CO—S—, —S—CO—, —O—SO₂—, —SO₂—O—, —O—CO—O—, —CH═CH—, —C≡C—, a cyclopropylene group, or —Si(CH₃)₂—, and one or more hydrogen atoms of the alkyl group are each optionally substituted with a fluorine atom, a chlorine atom, a bromine atom, or a CN group;

Z's each independently represent —O—, —S—, —CO—, —CO—O—, —O—CO—, —O—CO—O—, —CO—N(R^{a})—, —N(R^{a})—CO—, —OCH₂—, —CH₂O—, —SCH₂—, —CH₂S—, —O—SO₂—, —SO₂—O—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—CO—O—, —O—CO—CH═CH—, or a single bond, in which R^{a} of —CO—N(R^{a})— or —N(R^{a})—CO-represents a hydrogen atom or a linear or branched alkyl group having 1 to 4 carbon atoms or a linear or branched alkyl group having 1 to 4 carbon atoms;

Y's each independently represent a single bond or a linear or branched alkylene group having 1 to 10 carbon atoms, in which one or more methylene groups of the alkylene group are each independently optionally substituted with —O—, —CO—, —COO—, or —OCO—, provided that oxygen atoms are not directly bound to each other, and one or more hydrogen atoms of the alkylene group are each independently optionally substituted with a halogen atom or an alkyl group having 1 to 9 carbon atoms;

X's each independently represent a halogen atom, a cyano group, a methyl group, a methoxy group, —CF₃, or —OCF₃;

n's each independently represent an integer of 0 to 4;

n₁, n₂, n₃, and n₄ each independently represent 0 or 1, provided that n₁+n₂+n₃+n₄=1 to 4; and

Cyclo's each independently represent cycloalkane having 3 to 10 carbon atoms and optionally containing a double bond).

Here, Cyclo is preferably cyclohexane (cyclohexylene group), and the liquid crystalline compound is preferably, for example, one of liquid crystalline compounds represented by Formulae (LC-I′) to (LC-III′):

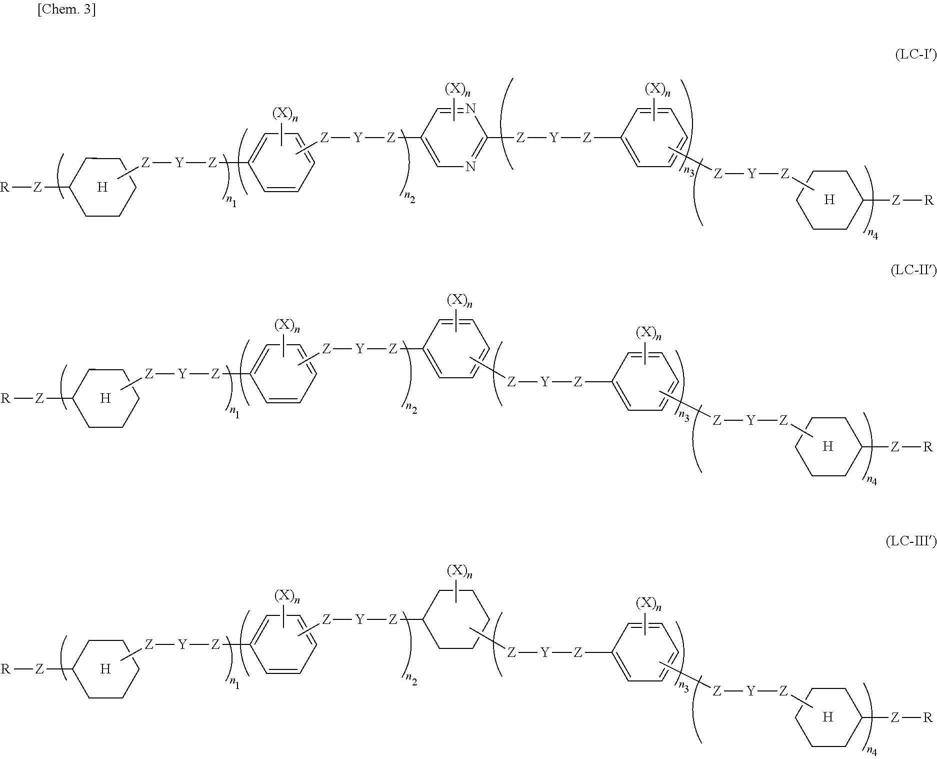

(where, R's each independently represent a linear or branched alkyl group having 1 to 18 carbon atoms, a hydrogen atom, or a fluorine atom, in which one —CH₂— group or two non-adjacent —CH₂— groups of the alkyl group are each optionally substituted with —O—, —S—, —CO—, —CO—O—, —O—CO—, —CO—S—, —S—CO—, —O—SO₂—, —SO₂—O—, —O—CO—O—, —CH═CH—, —C≡C—, a cyclopropylene group, or —Si(CH₃)₂—, and one or more hydrogen atoms of the alkyl group are each optionally substituted with a fluorine atom, a chlorine atom, a bromine atom, or a CN group;

Z's each independently represent —O—, —S—, —CO—, —CO—O—, —O—CO—, —O—CO—O—, —CO—N(R^{a})—, —N(R^{a})—CO—, —OCH₂—, —CH₂O—, —SCH₂—, —CH₂S—, —O—SO₂—, —SO₂—O—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—CO—O—, —O—CO—CH═CH—, or a single bond, in which R^{a} of —CO—N(R^{a})— or —N(R^{a})—CO— represents a hydrogen atom or a linear or branched alkyl group having 1 to 4 carbon atoms;

Y's each independently represent a single bond or a linear or branched alkylene group having 1 to 10 carbon atoms, in which one or more methylene groups of the alkylene group are each independently optionally substituted with —O—, —CO—, —COO—, or —OCO—, provided that oxygen atoms are not directly bound to each other, and one or more hydrogen atoms of the alkylene group are each independently optionally substituted with a halogen atom or an alkyl group having 1 to 9 carbon atoms;

X's each independently represent a fluorine atom, a chlorine atom, a bromine atom, a cyano group, a methyl group, a methoxy group, a CF₃ group, or a OCF₃ group;

n's each independently represent an integer of 0 to 4; and

n₁, n₂, n₂, and n₄ each independently represent 0 or 1, provided that n₁+n₂+n₃+n₄ is 1 to 4).

In order to express liquid crystalline properties, substitutions at 1- and 4-positions of a ring is preferred. That is, a divalent cyclic group of the liquid crystalline compound is preferably, for example, a 1,4-cyclohexylene group, a 1,4-phenylene group, or a 2,5-pyrimidinediyl group.

For example, the liquid crystalline compound is preferably one of liquid crystalline compounds represented by Formulae (LC-Ia) to (LC-IIIa):

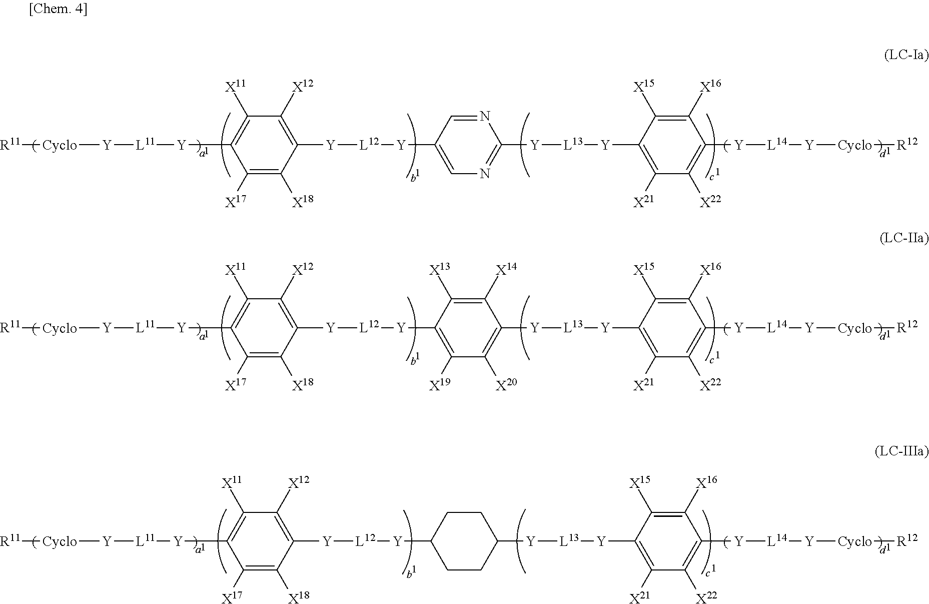

(where, R¹¹ and R¹² each independently represent a linear or branched alkyl group having 1 to 18 carbon atoms or a fluorine atom, provided that R¹¹ and R¹² are not simultaneously fluorine atoms, in which one —CH₂— group or two non-adjacent —CH₂— groups of the alkyl group are each optionally substituted with —O—, —S—, —CO—, —CO—O—, —O—CO—, —CO—S—, —S—CO—, —O—CO—O—, —CH═CH—, —C≡C—, a cyclopropylene group, or —Si(CH₃)₂—, and one or more hydrogen atoms of the alkyl group are each optionally substituted with a fluorine atom or a CN group;

X¹¹ to X²² each independently represent a hydrogen atom, a fluorine atom, a CF₃ group, or a OCF₃ group;

L¹¹ to L¹⁴ each independently represent a single bond, —O—, —S—, —CO—, —CH₂O—, —OCH₂—, —CF₂O—, —OCF₂—, —CO—O—, —O—CO—, —CO—S—, —S—CO—, —O—CO—O—, —CH₂CH₂—, —CH═CH—, or —C≡C—;

Y's each independently represent a single bond or a linear or branched alkylene group having 1 to 10 carbon atoms, in which one or more methylene groups of the alkylene group are each independently optionally substituted with —O—, —CO—, —COO—, or —OCO—, provided that oxygen atoms are not directly bound to each other, and one or more hydrogen atoms of the alkylene group are each independently optionally substituted with a halogen atom or an alkyl group having 1 to 9 carbon atoms;

a¹, b¹, c¹, and d¹ each independently represent an integer of 0 or 1, provided that a¹+b¹+c¹+d¹ is 1, 2, or 3, where when a¹ represents 0, d¹ represents 0; when a¹ represents 1, c¹ represents 0; when c¹ represents 1, a¹ represents 0; and when b¹ and c¹ are each 1, a¹ and d¹ are each 0; and

Cyclo's each independently represent cycloalkane having 3 to 10 carbon atoms and optionally containing a double bond).

The liquid crystalline compound is also preferably a liquid crystalline compound represented by Formula (LC-IV):

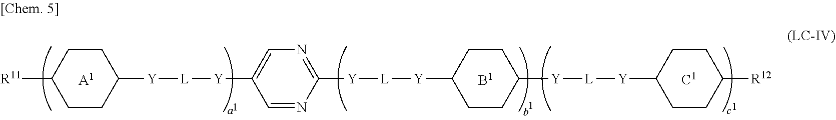

(where, R¹¹ and R¹² each independently represent a linear or branched alkyl group having 1 to 18 carbon atoms or a fluorine atom, provided that R¹¹ and R¹² are not simultaneously fluorine atoms, in which one —CH₂— group or two non-adjacent —CH₂— groups of the alkyl group are each optionally substituted with —O—, —S—, —CO—, —CO—O—, —O—CO—, —CO—S—, —S—CO—, —O—CO—O—, —CH═CH—, —C≡C—, a cyclopropylene group, or —Si(CH₃)₂—, and one or more hydrogen atoms of the alkyl group are each optionally substituted with a fluorine atom or a CN group;

ring A¹ represents a 1,4-phenylene group or a 1,4-cyclohexylene group, in which 1 to 4 hydrogen atoms are each optionally substituted with a fluorine atom, a CF₃ group, a OCF₃ group, a CN group, or a combination thereof;

ring B¹ represents a 1,4-phenylene group, in which 1 to 4 hydrogen atoms are each optionally substituted with a fluorine atom, a CF₃ group, a OCF₃ group, a CN group, or a combination thereof;

ring C¹ represents a 1,4-cyclohexylene group, in which 1 to 4 hydrogen atoms are each optionally substituted with a fluorine atom, a CF₃ group, a OCF₃ group, a CN group, or a combination thereof;

L's each independently represent a single bond, —O—, —S—, —CO—, —CH₂O—, —OCH₂—, —CF₂O—, —OCF₂—, —CO—O—, —O—CO—, —CO—S—, —S—CO—, —O—CO—O—, —CH₂CH₂—, —CH═CH—, or —C≡C—;

Y's each independently represent a single bond or a linear or branched alkylene group having 1 to 10 carbon atoms, in which one or more methylene groups of the alkylene group are each independently optionally substituted with —O—, —CO—, —COO—, or —OCO—, provided that oxygen atoms are not directly bound to each other, and one or more hydrogen atoms of the alkylene group are each independently optionally substituted with a halogen atom or an alkyl group having 1 to 9 carbon atoms; and

a¹ represents 0, 1, or 2; b¹ and c¹ each represent an integer of 0, 1, or 2; and the total of a¹, b¹, and c¹ represents 1, 2, or 3).

The liquid crystalline compound is also preferably a liquid crystalline compound represented by Formula (LC-V):

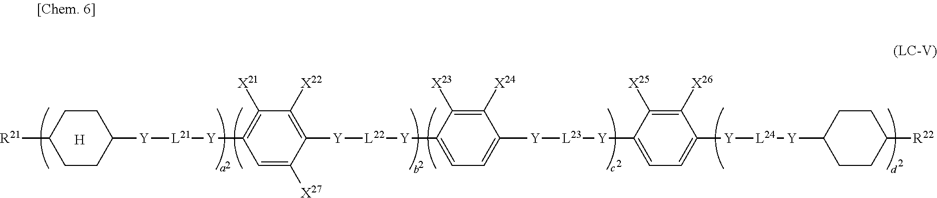

(where, R²¹ and R²² each independently represent a linear or branched alkyl group having 1 to 18 carbon atoms or a fluorine atom, provided that R²¹ and R²² are not simultaneously fluorine atoms, in which one —CH₂— group or two non-adjacent —CH₂— groups of the alkyl group are each optionally substituted with —O—, —S—, —CO—, —CO—O—, —O—CO—, —CO—S—, —S—CO—, —O—CO—O—, —CH═CH—, —C≡C—, a cyclopropylene group, or —Si(CH₃)₂—, and one or more hydrogen atoms of the alkyl group are each optionally substituted with a fluorine atom or a CN group;

X²¹ to X²⁷ each independently represent a hydrogen atom, a fluorine atom, a CF₃ group, or a OCF₃ group;

L²¹ to L²⁴ each independently represent a single bond, —O—, —S—, —CO—, —CH₂O—, —OCH₂—, —CF₂O—, —OCF₂—, —CO—O—, —O—CO—, —CO—S—, —S—CO—, —O—CO—O—, —CH₂CH₂—, —CH═CH—, or —C≡C—; and

a², b², c², and d² each independently represent an integer of 0 or 1, provided that a²+b²+c²+d² is 1, 2, or 3, where when a² represents 0, d² represents 0; when a² represents 1, c² represents 0; and b² and c² are each 1, a² and d² are each 0).

A phenylpyrimidine compound preferably has at least one fluorine atom, CF₃ group, or OCF₃ group as a substituent in the cyclic moiety of the molecule, for giving a tilted smectic phase necessary for expressing ferroelectricity or increasing the tilting angle of the molecule or reducing the melting point. The substituent to be introduced is preferably a fluorine atom, which has a small size, for stabilizing the liquid crystal phase and also maintaining the rapid response. The number of the substituent is preferably one to three.

In order to reduce the viscosity and achieve rapid response, the linker group (—Z—Y—Z— or —Y-L-Y—) linking rings is preferably selected from the group consisting of a single bond, —CH₂O—, —OCH₂—, —CF₂O—, —OCF₂—, —CH₂CH₂—, —CH═CH—, and —C≡C—, and is most preferably a single bond. A single bond can prevent local polarization of a molecule and is therefore preferred also from the aspect of reducing a bad influence on the switching behavior. On the other hand, a material having a higher viscosity is preferred for maintaining the stability of a layer structure. In such a case, the linker group is preferably selected from the group consisting of —CO—O—, —O—CO—, —CO—S—, and —S—CO—. In particular, —CO—O— and —O—CO— are preferred.

From the aspect of enhancing the effect of reducing the melting point, one or both of the side chains (R, R¹¹, R¹², R²¹, and R²²) is preferably a hydrogen atom, a methyl group, an ethyl group, a propyl group, a pentyl group, a hexyl group, a pentyl group, an octyl group, a nonyl group, an isopropyl group, an alkylcarbonyloxy group, an alkyloxycarbonyl group, or an alkyloxycarbonyloxy group.

A compound that is suitable for increasing the Δn, showing a stable ferroelectric liquid crystal phase, and having a low viscosity suitable for rapid response is preferably a liquid crystalline compound represented by Formula (LC-VI):

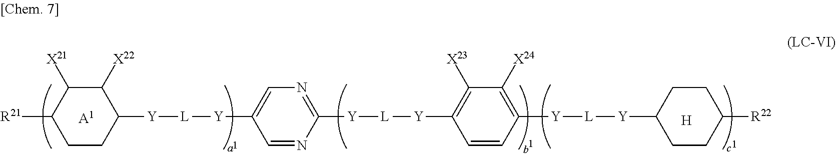

(where, R²¹ and R²² each independently represent a linear or branched alkyl group having 1 to 18 carbon atoms, a hydrogen atom, or a fluorine atom, in which one —CH₂— group or two non-adjacent —CH₂— groups of the alkyl group are each optionally substituted with —O—, —S—, —CO—, —CO—O—, —O—CO—, —CO—S—, —S—CO—, —O—SO₂—, —SO₂—O—, —O—CO—O—, —CH═CH—, —C≡C—, a cyclopropylene group, or —Si(CH₃)₂—, and one or more hydrogen atoms of the alkyl group are each optionally substituted with a fluorine atom, a chlorine atom, a bromine atom, or a CN group;

X²¹ to X²⁴ each independently represent a hydrogen atom, a halogen, a cyano group, a methyl group, a methoxy group, a CF₃ group, or a OCF₃ group;

ring A¹ represents a phenylene group or a cyclohexylene group;

L's each independently represent a single bond, —O—, —S—, —CO—, —CH₂O—, —OCH₂—, —CF₂O—, —OCF₂—, —CO—O—, —O—CO—, —CO—S—, —S—CO—, —O—CO—O—, —CH₂CH₂—, —CH═CH—, or —C≡C—; and

a¹ represents 0, 1, or 2; b¹ and c¹ each represent an integer of 0, 1, of 2; the total of a¹+b¹+c¹ is 1 or 2, where when a¹ represents 1, c¹ represents 0; and when c¹ represents 1, a¹ represents 0).

Y's in Formulae (LC-I) to (LC-VI) preferably each independently represent a single bond or an alkylene group having 1 to 7 carbon atoms (where, one or more methylene groups of the alkylene group are each independently optionally substituted with —O—, —CO—, —COO—, or —OCO—, provided that oxygen atoms are not directly bound to each other),

Y's, more preferably, each independently represent a single bond or an alkylene group having 1 to 5 carbon atoms (where, one or more methylene groups of the alkylene group are each independently optionally substituted with —O—, —CO—, —COO—, or —OCO—, provided that oxygen atoms are not directly bound to each other), and

Y's, more preferably, each independently represent a single bond or an alkylene group having 1 to 3 carbon atoms (where, one or more methylene groups of the alkylene group are each independently optionally substituted with —O—, —CO—, —COO—, or —OCO—, provided that oxygen atoms are not directly bound to each other).

A compound that is suitable for TFT driving, showing a stable ferroelectric liquid crystal phase, and having a low viscosity suitable for rapid response is particularly preferably a liquid crystalline compound represented by Formula (LC-VII):

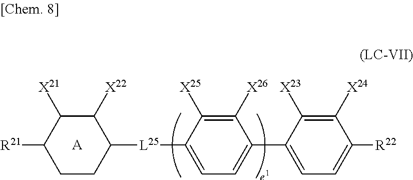

(where, e¹ represents 0, 1, or 2;

X²¹ to X²⁶ each independently represent a hydrogen atom or a fluorine atom group, provided that when e¹ represents 0, at least one of X²¹ to X²⁴ is a fluorine atom and that when e¹ represents 1, at least one of X²¹ to X²⁶ is a fluorine atom;

R²¹ and R²² each independently represent a linear or branched alkyl group having 1 to 18 carbon atoms, in which one —CH₂— group of the alkyl group is optionally substituted with —O—;

L²⁵ represents a single bond, —CH₂O—, or —OCH₂—; and ring A¹ represents a phenylene group or a cyclohexylene group).

The liquid crystalline compound that is used in the ferroelectric liquid crystal composition of the present invention may be one or a combination of two or more of, for example, compounds represented by any of Formulae (LC-0), (LC-I) to (LC-III), (LC-IV), (LC-V), (LC-VI), and (LC-VII).

### <Chiral Compound>

The ferroelectric liquid crystal composition in the liquid crystal display apparatus of the present invention may contain a chiral compound. The chiral compound may be a compound having an asymmetric atom, a compound having axial asymmetry, or a compound having planar asymmetry and may have a polymerizable group or not. These chiral compounds may be used alone or in combination of two or more thereof. Herein, examples of the compound having axial asymmetry include atropisomers.

The chiral compound is preferably a compound having an asymmetric atom or a compound having axial asymmetry, and most preferably a compound having an asymmetric atom. In the compound having an asymmetric atom, an asymmetric carbon atom hardly causes stereoinversion and is therefore preferred. A hetero atom may be an asymmetric atom. The asymmetric atom may be introduced into a part of a chain structure or may be introduced into a part of a cyclic structure. When a large helical twisting power is particularly required, a compound having axial asymmetry is preferred.

The compound having an asymmetric atom is, for example, a compound having asymmetric carbon in a side chain moiety, a compound having asymmetric carbon in cyclic structure moiety, or a compound having asymmetric compound both the side chain and cyclic structure moieties. Specifically, examples of the compound having an asymmetric atom include the compounds represented by Formula (Ch-I):

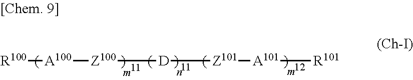

R¹⁰⁰ and R¹⁰¹ each independently represent a hydrogen atom, a cyano group, NO₂, a halogen, OCN, SCN, SF₅, a chiral or achiral alkyl group having 1 to 30 carbon atoms, or a chiral group containing a polymerizable group or a cyclic structure, in which one CH₂ group or two or more non-adjacent CH₂ groups of the alkyl group are each independently optionally substituted with —O—, —S—, —NH—, —N(CH₂)—, —CO—, —COO—, —OCO—, —OCO—O—, —S—CO—, —CO—S—, —CH═CH—, —CF₂—, —CF═CH—, —CH═CF—, —CF═CF—, or —C≡C—, one or more hydrogen atoms of the alkyl group are each independently optionally substituted with a halogen or a cyano group, and the alkyl group may be a linear or branched and may contain a cyclic structure.

The chiral alkyl group is preferably represented by any of Formulae (Ra) to (Rk):

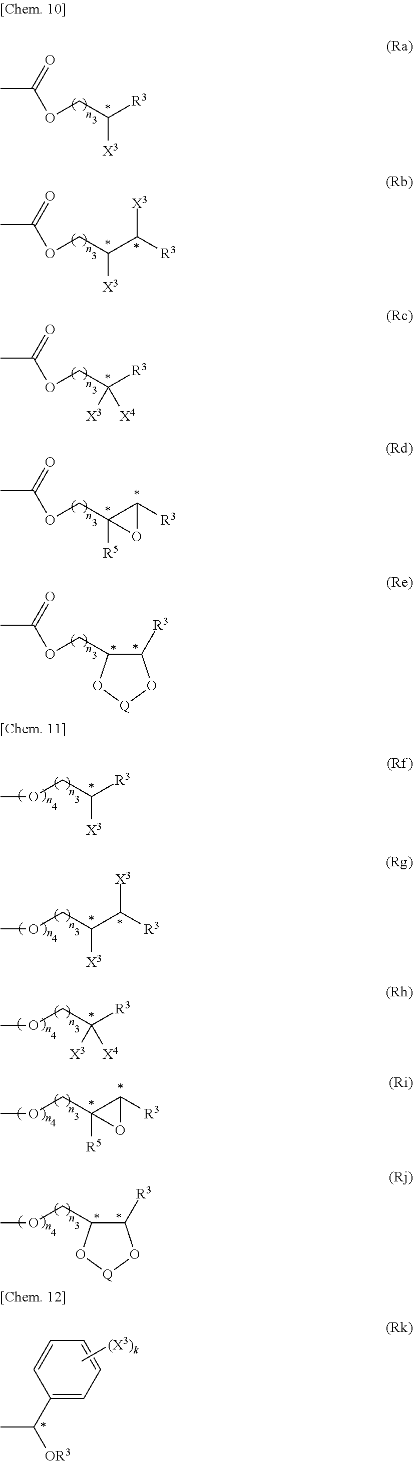

R³ and R⁵ each independently represent a linear or branched alkyl group having 1 to 10 carbon atoms or a hydrogen atom, in which one or more —CH₂— groups of the alkyl group are each optionally substituted with —O—, —S—, —NH—, —N(CH₃)—, —CO—, —CO—O—, —O—CO—, —O—CO—O—, —S—CO—, —CO—S—, —O—SO₂—, —SO₂—O—, —CH═CH—, —C≡C—, a cyclopropylene group, or —Si(CH₃)₂—, provided that oxygen atoms or sulfur atoms are not directly bound to each other, and one or more hydrogen atoms of the alkyl group are each optionally substituted with a fluorine atom, a chlorine atom, a bromine atom, or a cyano group, and the alkyl group optionally contains a polymerizable group. The polymerizable group preferably has a structure represented by any of Formulae (R−1) to (R-15):

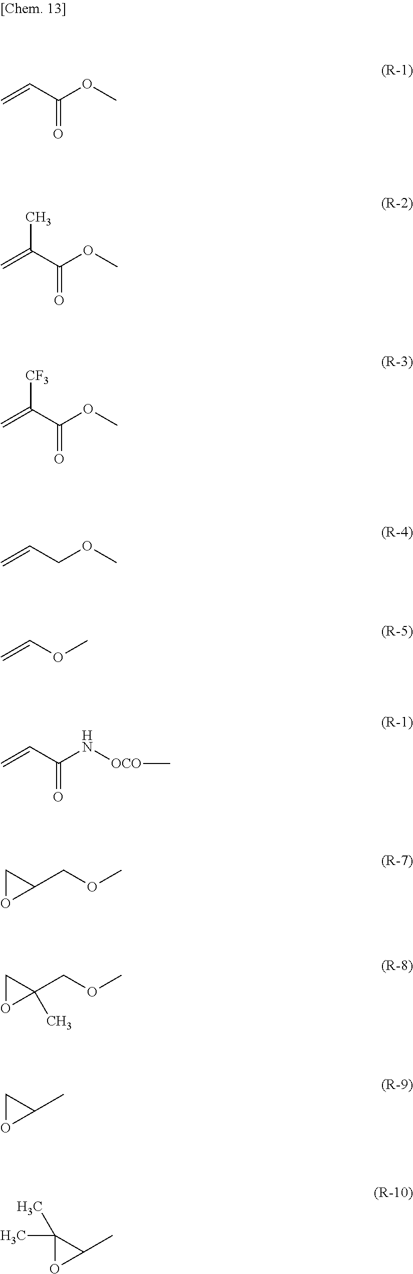

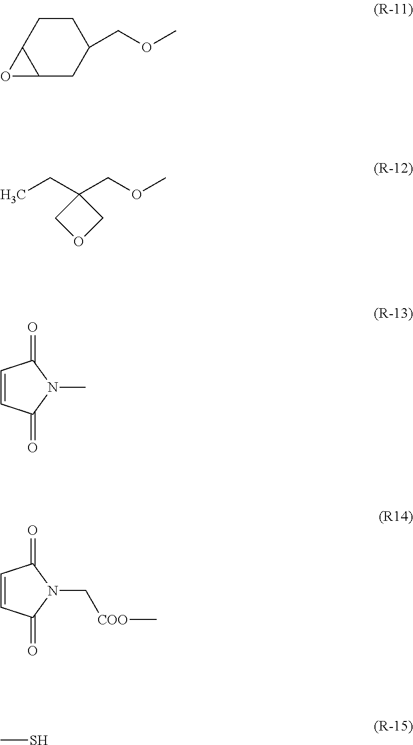

These polymerizable groups are cured through radical polymerization, radical addition polymerization, cationic polymerization, or anionic polymerization. In particular, in ultraviolet polymerization, the polymerizable groups represented by Formula (R−1), (R-2), (R-4), (R-5), (R-7), (R-11), (R-13), or (R-15) are preferred; the polymerizable groups represented by Formula (R−1), (R-2), (R-7), (R-11), or (R-13) are more preferred; and the polymerizable groups represented by Formula (R−1) or (R-2) are more preferred. In the chiral group containing a cyclic structure, the cyclic structure may be aromatic or aliphatic. The cyclic structure of the alkyl group can be a monocyclic structure, fused cyclic structure, or spirocyclic structure and can contain one or more hetero atoms.

X³ and X⁴ are each preferably a halogen atom (F, Cl, Br, or I), a cyano group, a phenyl group (where, one or more arbitrary hydrogen atoms of the phenyl group are each optionally substituted with a halogen atom (F, Cl, Br, or I), a methyl group, a methoxy group, —CF₃, or —OCF₃), a methyl group, a methoxy group, —CF₃, or —OCF₃. However, in Formulae (Rc) and (Rh), in order to that the atoms at the positions indicated with asterisk are asymmetric, the groups represented by X⁴ and X³ are different from each other.

n₃ represents an integer of 0 to 20, and n₄ represents 0 or 1.

In Formulae (Rd) and (Ri), R⁵ is preferably a hydrogen atom or a methyl group.

In Formulae (Re) and (Rj), Q is a divalent hydrocarbon group such as a methylene group, an isopropylidene group, or a cyclohexylidene group.

In Formula (Rk), k represents an integer of 0 to 5.

More preferably, R³ represents a linear or branched alkyl group having 4 to 8 carbon atoms, such as C₄H₉, C₆H₁₃, and C₈H₁₇; and X³ is F, CF₃, or CH₃.

In particular, the chiral alkyl group is preferably represented by any of the following Formulae:

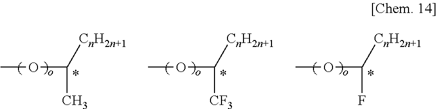

(where, o represents 0 or 1; n represents an integer of 2 to 12, preferably 3 to 8, and more preferably 4, 5, or 6; and asterisk * represents a chiral carbon atom).

The chiral compound is more preferably a dichiral compound in which both R¹⁰⁰ and R¹⁰¹ are chiral groups in Formula (Ch-I). A dichiral compound having an ester bond is preferred for increasing the spontaneous polarization. A dichiral compound having an ether bond is preferred for increasing the tilt angle or stabilizing the orientation in a voltage-application state.

Z¹⁰⁰ and Z¹⁰¹ each independently represent —O—, —S—, —CO—, —OCO—, —OCO—, —O—OCO—, —CO—N(R^{a})—, —N(R^{a})—CO—, —OCH₂—, —CH₂O—, —SCH₂—, —CH₂S—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—OCO—, —OCO—CH═CH—, or a single bond, in which R^{a} of —CO—N(R^{a})— or —N(R^{a})—CO— represents a hydrogen atom or a linear or branched alkyl group having 1 to 4 carbon atoms. Z¹⁰⁰ and Z¹⁰¹ preferably each independently represent —CF₂O—, —OCF₂—, —CF₂CF₂—, —CF═CF—, —COO—, —OCO—, —CH₂—CH₂—, —C≡C—, or a single bond.

A¹⁰⁰ and A¹⁰¹ each independently represent:

(a) a trans-1,4-cyclohexylene group (one —CH₂— or two or more non-adjacent —CH₂— in this group are each independently optionally substituted with —O— or —S—),
(b) a 1,4-phenylene group (one —CH═ or two or more non-adjacent —CH═ in this group are each independently optionally substituted with a nitrogen atom), or
(c) a group selected from the group consisting of a 1,4-cyclohexenylene group, a 1,4-bicyclo[2.2.2]octylene group, an indan-2,5-diyl group, a naphthalen-2,6-diyl group, a decahydronaphthalen-2,6-diyl group, and a 1,2,3,4-tetrahydronaphthalen-2,6-diyl group (one —CH₂— or two or more non-adjacent —CH₂— of the group selected in the group (c) are each independently optionally substituted with —O— or —S—, and one —CH═ or two or more non-adjacent —CH═ of the group selected in the group (c) are each independently optionally substituted with a nitrogen atom). All of these groups may be unsubstituted or mono- or polysubstituted with a halogen, a cyano group, NO₂, or an alkyl, alkoxy, alkylcarbonyl, alkoxycarbonyl group having 1 to 7 carbon atoms in which one or more hydrogen atoms are optionally substituted with F or Cl.

A¹⁰⁰ and A¹⁰¹ in Formula (Ch-I) are each preferably 1,4-phenylene or trans-1,4-cyclohexylene, and these rings are each preferably unsubstituted or substituted at the 1- to 4-positions with F, Cl, CN, or an alkyl, alkoxy, alkylcarbonyl, or alkoxycarbonyl group having 1 to 4 carbon atoms.

n¹¹ represents 0 or 1, provided that when n¹¹ represents 0, m¹¹ represents 0, and m¹¹ represents 0, 1, 2, 3, 4, or 5, and when n¹¹ represents 1, m¹¹ and m¹² are each independently 0, 1, 2, 3, 4, or 5 and provided that when n¹¹ represents 0, at least one of R¹⁰⁰ and R¹⁰¹ is a chiral alkyl group or a chiral group containing a polymerizable group or a cyclic structure.

When n¹¹ and m¹² are each 0, m¹¹ is preferably 1, 2, or 3. When n¹¹ represents 1, m¹¹ and m¹² are preferably each independently 1, 2, or 3.

D is a substituent represented by any of Formulae (D1) to (D8)

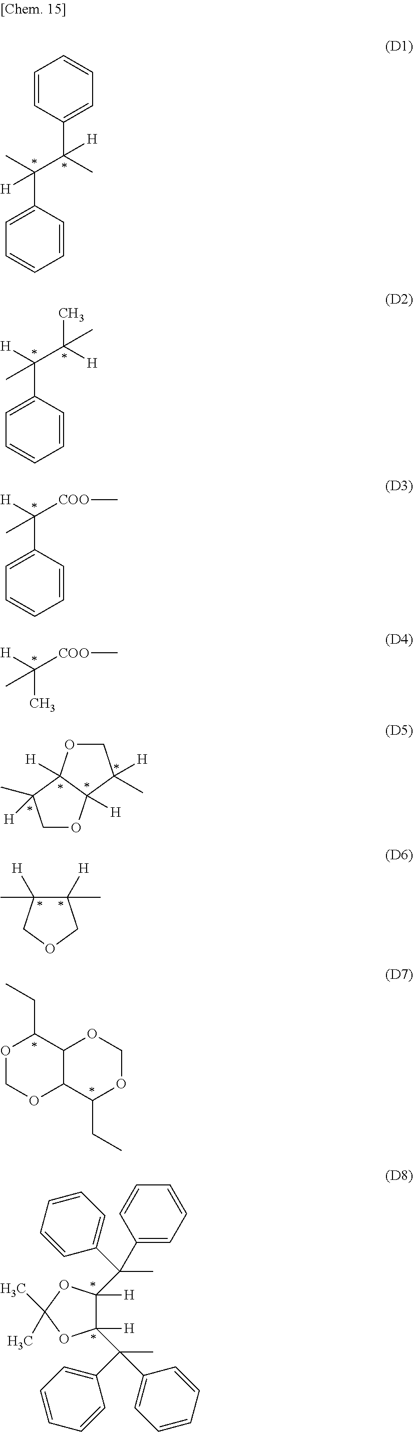

(where, one or more arbitrary hydrogen atoms of the benzene ring are each optionally substituted with a halogen atom (F, Cl, Br, or I) or an alkyl or alkoxy group having 1 to 20 carbon atoms, in which arbitrary hydrogen atoms of the alkyl or alkoxy group are each optionally substituted with a fluorine atom, or the methylene groups of the alkyl or alkoxy group are each optionally substituted with —O—, —S—, —COO—, —OCO—, —CF₂—, —CF═CH—, —CH═CF—, —CF═CF—, or —C≡C—, provided that oxygen atoms or sulfur atoms are not directly bound to each other).

When n¹¹ represents 0 in a partial structure, -(A¹⁰⁰-Z¹⁰⁰)m¹¹-(D)n¹¹-(Z¹⁰¹-A¹⁰¹)m¹²-, of Formula (Ch-I), preferred examples of the partial structure include the following structures:

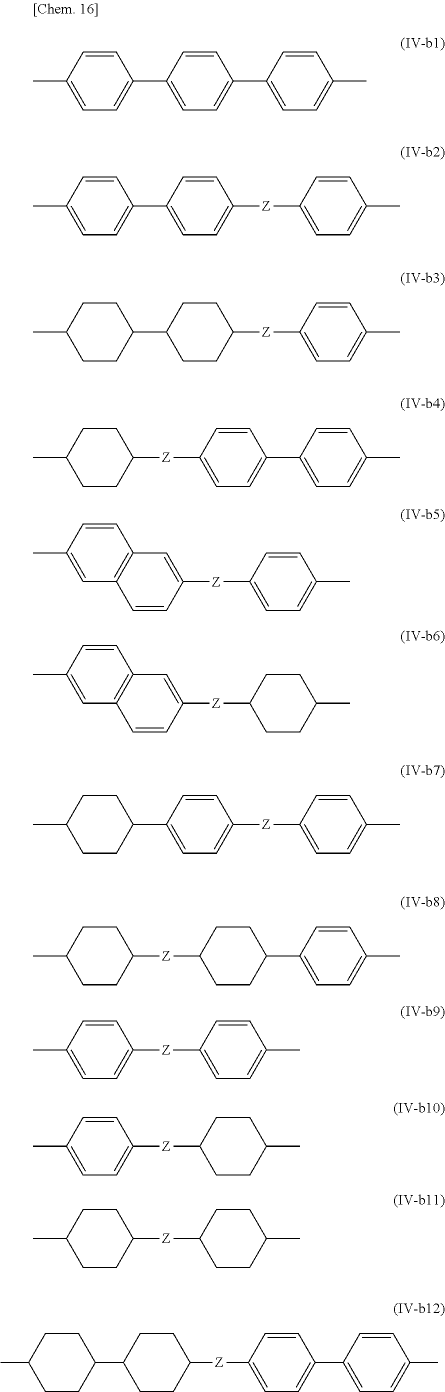

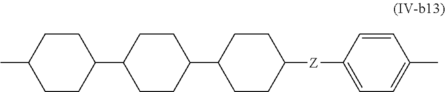

(where, one or more arbitrary hydrogen atoms of the benzene rings in these formulae are each optionally substituted with a halogen atom (F, Cl, Br, or I), a methyl group, a methoxy group, —CF₃, or —OCF₃, and one or more arbitrary carbon atoms of the benzene rings in these formulae are each optionally substituted with a nitrogen atom. The introduction of these substituents and nitrogen atoms is preferred for a reduction in crystallinity and control of the direction or size of the dielectric anisotropy. The definition of Z is the same as in Z¹⁰⁰ and Z¹⁰¹ in Formula (Ch-I)). In the aspect of reliability, benzene rings and cyclohexane rings are preferred than heterocycles such as pyridine rings and pyrimidine rings. In the aspect of increasing the dielectric anisotropy, a compound containing a heterocycle such as a pyridine ring or a pyrimidine ring is preferably used. In such a case, the polarizability of the compound is relatively high, which is preferred for reducing the crystallinity and stabilizing the liquid crystalline properties. In the case of a hydrocarbon ring such as a benzene ring or a cyclohexane ring, the polarizability of the compound is low. Accordingly, an appropriate content is preferably selected depending on the polarizability of a chiral compound.

When n¹¹ and m¹² are 0, the compounds represented by Formula (Ch-I) are preferably as follows:

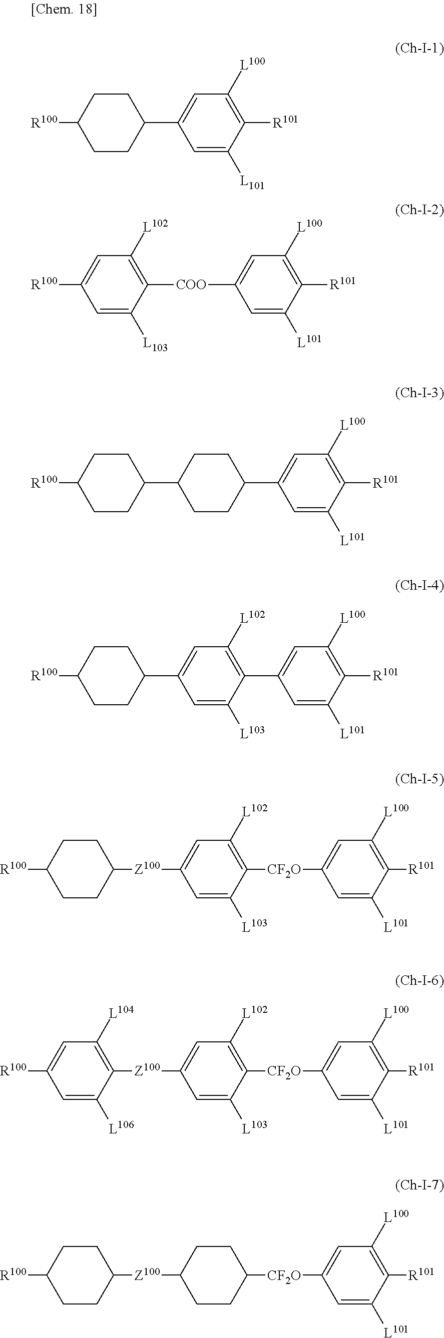

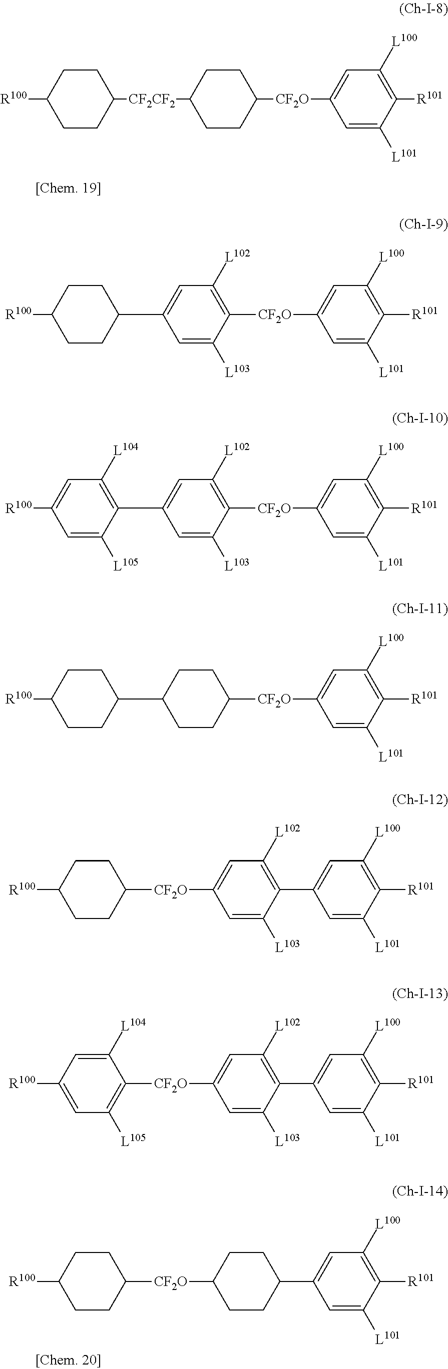

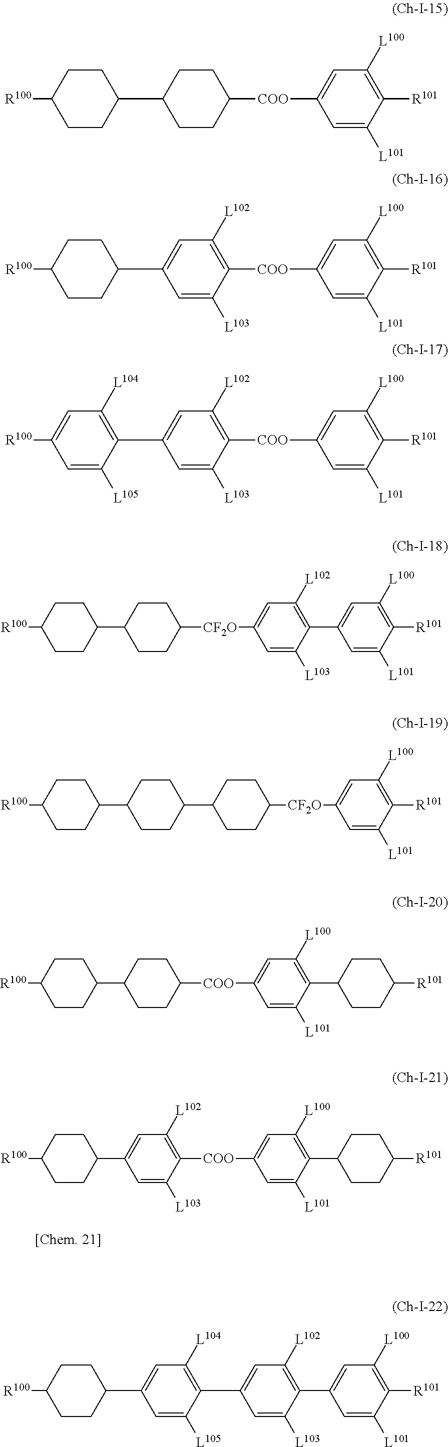

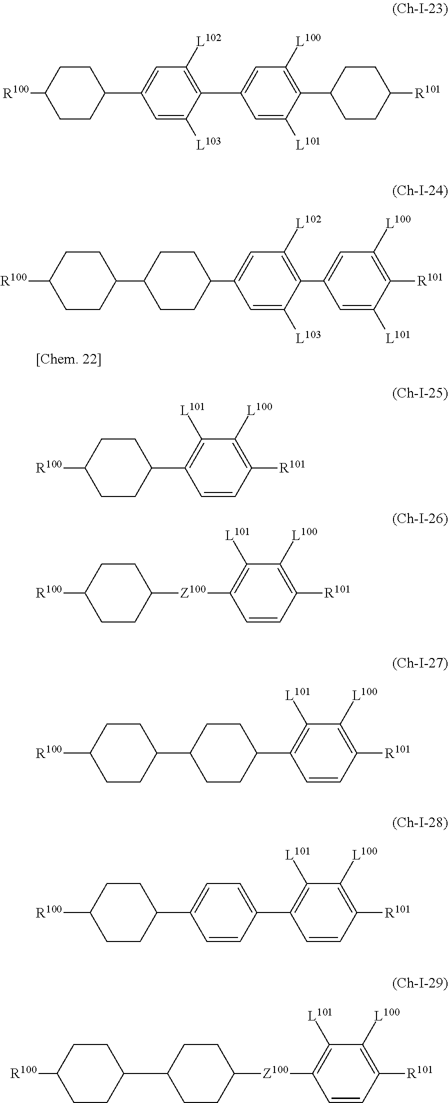

where, R¹⁰⁰, R¹⁰¹, and Z¹⁰⁰ are synonymous with R¹⁰⁰, R¹⁰¹, and Z¹⁰⁰ in Formula (Ch-I), respectively; at least one of R¹⁰⁰ and R¹⁰¹ represents a chiral group; and L¹⁰⁰ to L¹⁰⁵ each independently represent a hydrogen atom or a fluorine atom.

When n¹¹ represents 1, the compound represented by Formula (Ch-I) has a structure containing an asymmetric carbon in the cyclic structure moiety, and the chiral structure D is preferably represented by Formula (D5).

In the compound represented by Formula (Ch-I), when D is represented by Formula (D5), specifically, the compound is preferably represented by any of Formulae (D5-1) to (D5-8):

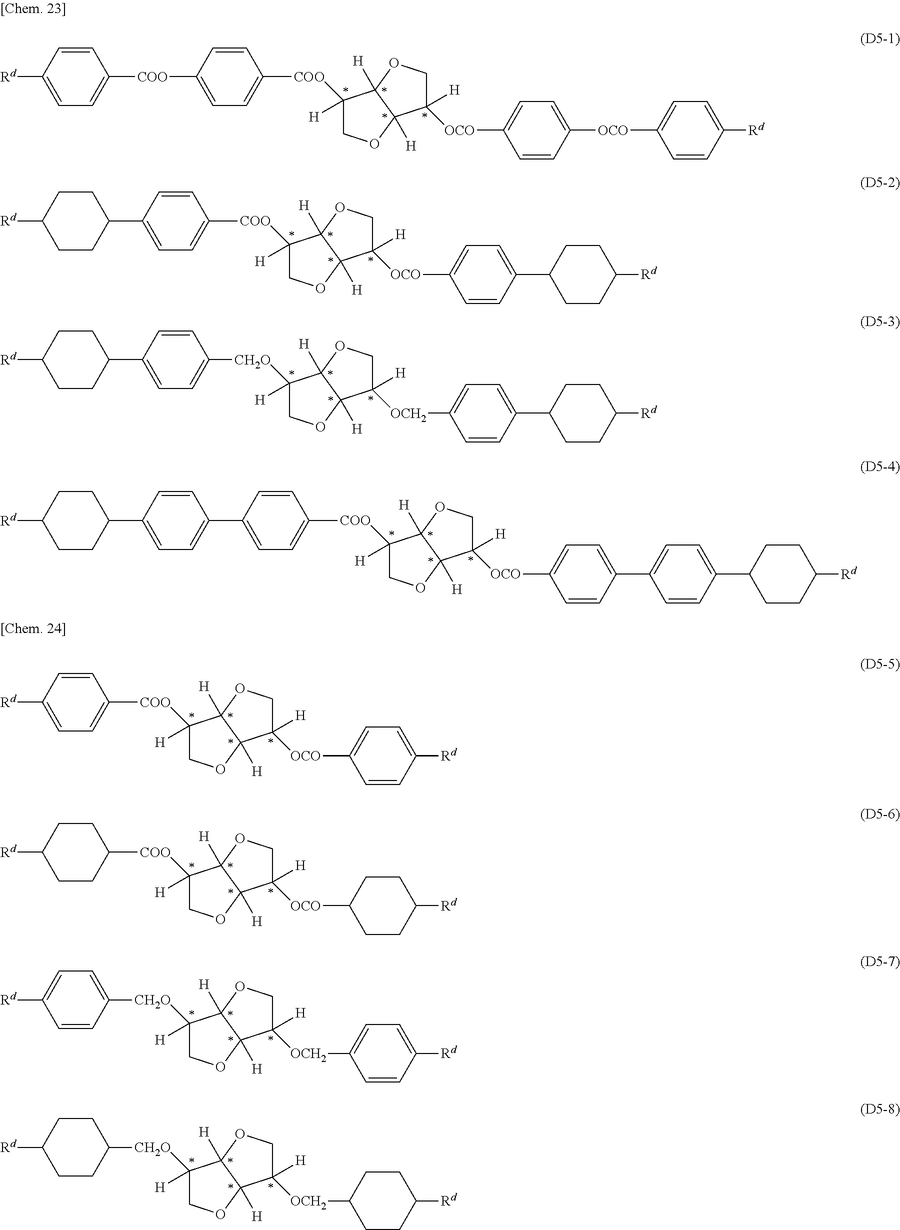

(R^{d}'s each independently represent an alkyl group having 3 to 10 carbon atoms, in which —CH₂—, adjacent to the ring, of the alkyl group is optionally substituted with —O—, and arbitrary —CH₂— is optionally substituted with —CH═CH—).

The axially asymmetric compound is preferably represented by Formula (Ch-II), (Ch-III), or (Ch-IV):

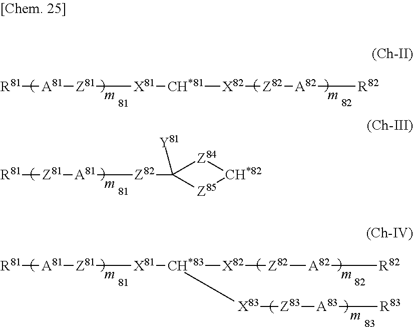

R⁸¹, R⁸², R⁸³, and Y⁸¹ each independently represent a linear or branched alkyl group having 1 to 30 carbon atoms, a hydrogen atom, or a fluorine atom, in which one or more —CH₂— groups of the alkyl group are each optionally substituted with —O—, —S—, —NH—, —N(CH₃)—, —CO—, —CO—O—, —O—CO—, —O—CO—O—, —S—CO—, —CO—S—, —O—SO₂—, —SO₂—O—, —CH═CH—, —C≡C—, a cyclopropylene group, or —Si(CH₃)₂—, provided that oxygen atoms or sulfur atoms are not directly bound to each other, one or more hydrogen atoms of the alkyl group are each optionally substituted with a fluorine atom, a chlorine atom, a bromine atom, or a CN group; the alkyl group optionally contains a polymerizable group, the alkyl group optionally contains a fused or spirocyclic system, and the alkyl group optionally contains one or more aromatic or aliphatic rings optionally containing one or more hetero atoms, in which each of the rings is optionally substituted with an alkyl group, an alkoxy group, or a halogen.

Z⁸¹, Z⁸², Z⁸³, Z⁸⁴, and Z⁸⁵ each independently represent an alkylene group having 1 to 40 carbon atoms, in which one or more CH₂ groups of the alkyl group are each optionally substituted with —O—, —S—, —NH—, —N(CH₂)—, —CO—, —COO—, —OCO—, —OCOO—, —S—CO—, —CO—S—, —CH═CH—, —CH═CF—, —CF═CH—, —CF═CF—, —CF₂—, or —C≡C—, provided that oxygen atoms or sulfur atoms are not directly bound to each other.

X⁸¹, X⁸², and X⁸³ each independently represent —O—, —S—, —P—, —CO—, —COO—, —OCO—, —OCOO—, CO NH, NH CO, CH₂CH₂—, —OCH₂—, —CH₂O—, —SCH₂—, —CH₂S—, —CF═CF—, —CH═CH—, —OCO—CH═CH—, —C≡C—, or a single bond.

A⁸¹, A⁸², and A⁸³ each independently represent a cyclic group selected from a phenylene group, a cyclohexylene group, a dioxolanediyl group, a cyclohexenylene group, a bicyclo[2.2.2]octylene group, a piperidinediyl group, a naphthalenediyl group, a decahydronaphthalenediyl group, a tetrahydronaphthalenediyl group, and an indanediyl group. In the phenylene group, the naphthalenediyl group, the tetrahydronaphthalenediyl group, and the indanediyl group, one or more —CH═ groups in each ring are each optionally substituted with a nitrogen atom. In the cyclohexylene group, the dioxolanediyl group, the cyclohexenylene group, the bicyclo[2.2.2]octylene group, the piperidinediyl group, the decahydronaphthalenediyl group, the tetrahydronaphthalenediyl group, and the indanediyl group, one —CH₂— group or two non-adjacent —CH₂— groups in each ring are each optionally substituted with —O— and/or —S—, and one or more hydrogen atoms of the cyclic group are each optionally substituted with a fluorine atom, a chlorine atom, a bromine atom, a CN group, a NO₂ group, or an alkyl, alkoxy, alkylcarbonyl, or alkoxycarbonyl group having 1 to 7 carbon atoms in which one or more hydrogen atoms are optionally substituted with a fluorine atom or a chlorine atom; and

m₈₁, m₈₂, and m₈₃ each represent 0 or 1, provided that m₈₁+m₈₂+m₈₃ is 1, 2, or 3.

CH*¹, CH*², and CH*⁸³ represent the following groups:

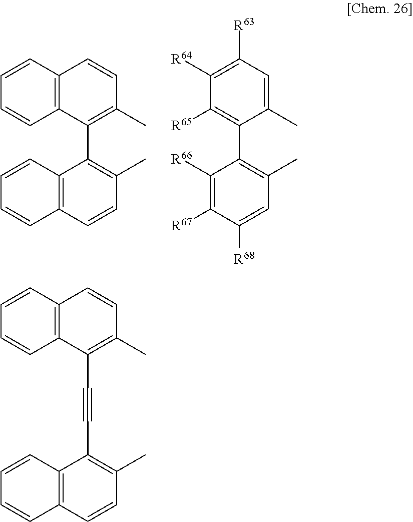

R⁶³, R⁶⁴, R⁶⁵, R⁶⁶, R⁶⁷, and R⁶⁸ each independently represent a hydrogen atom, an alkyl group, an alkoxyl group, an acyloxy group, a halogen atom, a haloalkyl group, or a dialkylamino group; in which two of R⁶³, R⁶⁴, and R⁶⁵ optionally form a methylene chain optionally having a substituent or a mono- or polymethylenedioxy group optionally having a substituent; and two of R⁶⁶, R⁶⁷, and R⁶⁸ optionally form a methylene chain optionally having a substituent or a mono- or polymethylenedioxy group optionally having a substituent, provided that R⁶⁵ and R⁶⁶ are not simultaneously hydrogen atoms.

More specifically, compounds represented by the following Formula (IV-d4), (IV-d5), (IV-c1), or (IV-c2) are preferred. Here, the axis of axial asymmetry is a bond linking the α-positions of two naphthalene rings in Formulae (IV-d4), (IV-d5), and (IV-c2) and is a single bond linking two benzene rings in Formula (IV-c1).

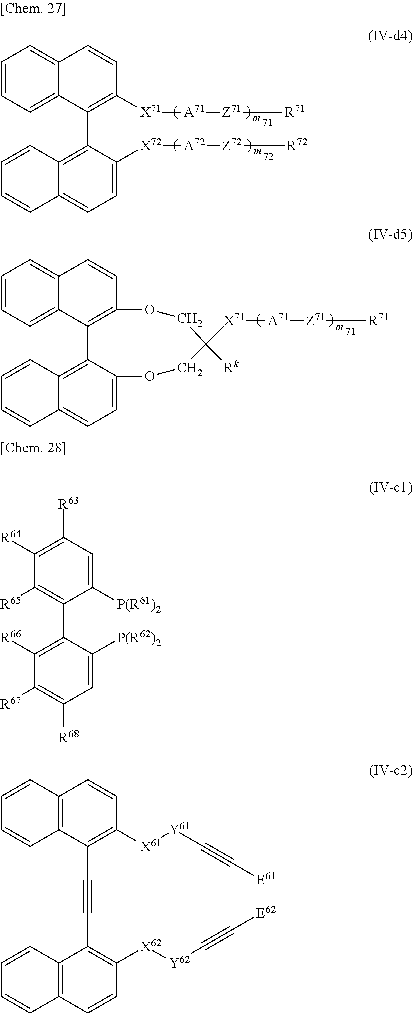

In Formulae (IV-d4) and (IV-d5), R⁷¹ and R⁷² each independently represent hydrogen, a halogen, a cyano (CN) group, an isocyanate (NCO) group, an isothiocyanate (NCS) group, or an alkyl group having 1 to 20 carbon atoms, in which one or more arbitrary —CH₂— in the alkyl group are each optionally substituted with —O—, —S—, —COO—, —OCO—, —CH═CH—, —CF═CF—, or —C≡C—, and arbitrary hydrogen of the alkyl is optionally substituted with a halogen;

A⁷¹ and A⁷² each independently represent an aromatic or nonaromatic 3-, 6-, or 8-membered or a fused ring having 9 or more carbon atoms, in which arbitrary hydrogen atoms of these rings are each optionally substituted with a halogen, an alkyl or haloalkyl group having 1 to 3 carbon atoms, one or more —CH₂— groups of each ring are each optionally substituted with —O—, —S—, or —NH—, and one or more —CH═ groups of each ring are each optionally substituted with —N═;

Z⁷¹ and Z⁷² each independently represent a single bond or an alkylene group having 1 to 8 carbon atoms, in which arbitrary —CH₂— in the alkylene group is optionally substituted with —O—, —S—, —COO—, —OCO—, —CSO—, —OCS—, —N═N—, —CH═N—, —N═CH—, —N(O)═N—, —N═N(O)—, —CH═CH—, —CF═CF—, or —C≡C—, and arbitrary hydrogen is optionally substituted with a halogen;

X⁷¹ and X⁷² each independently represent a single bond, —COO—, —OCO—, —CH₂O—, —OCH₂—, —CF₂O—, —OCF₂—, or —CH₂CH₂—; and

m₇₁ and m₇₂ each independently represent an integer of 1 to 4, except that either m₇₁ or m₇₂ in Formula (IV-d5) may represent 0.

R^{k} represents a hydrogen atom or a halogen atom or is synonymous with —X⁷¹-(A⁷¹-Z⁷¹)—R⁷¹.

In Formulae (IV-c1) and (IV-c2), at least one of X⁶¹ and Y⁶¹ and at least one of X⁶² and Y⁶² are present; and X⁶¹, X⁶², Y⁶¹ and Y⁶² each independently represent CH₂, C═O, O, N, S, P, B, or Si, in which N, P, B, and Si are each optionally bound to a substituent such as an alkyl group, an alkoxy group, or an acyl group for satisfying a desired valence.

E⁶¹ and E⁶² each independently represent a hydrogen atom, an alkyl group, an aryl group, an allyl group, a benzyl group, an alkenyl group, an alkynyl group, an alkyl ether group, an alkyl ester group, an alkyl ketone group, a heterocyclic group, or a derivative thereof.

In Formula (IV-c1), R⁶¹ and R⁶² each independently represent a phenyl, cyclopentyl, or cyclohexyl group optionally substituted with an alkyl group, an alkoxyl group, or a halogen atom;

R⁶³, R⁶⁴, R⁶⁵, R⁶⁶, R⁶⁷, and R⁶⁸ each independently represent a hydrogen atom, an alkyl group, an alkoxyl group, an acyloxy group, a halogen atom, a haloalkyl group, or a dialkylamino group, in which two of R⁶³, R⁶⁴ and R⁶⁵ optionally form a methylene chain optionally having a substituent or a mono- or polymethylenedioxy group optionally having a substituent; and two of R⁶⁶, R⁶⁷, and R⁶⁸ optionally form a methylene chain optionally having a substituent or a mono- or polymethylenedioxy group optionally having a substituent, provided that R⁶⁵ and R⁶⁶ are not simultaneously hydrogen atoms.

When a large helical twisting power is particularly required, a compound represented by Formula (IV-d4) or (IV-d5) is particularly preferred.

Specifically, the axially asymmetric compound is preferably a compound represented by any of Formulae (E−1) to (E-3):

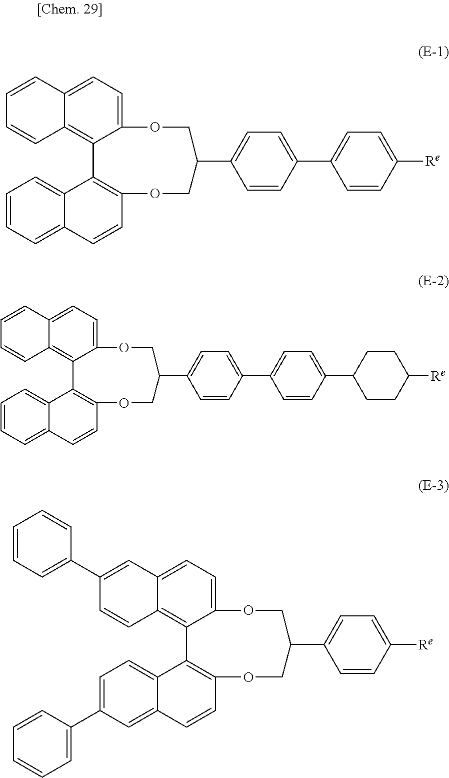

(R^{e}'s each independently represent an alkyl group having 3 to 10 carbon atoms, in which —CH₂—, adjacent to the ring, of the alkyl group is optionally substituted with —O—, and arbitrary —CH₂— is optionally substituted with —CH═CH—.) Here, the axis of axial asymmetry is a bond linking the α-positions of two naphthalene rings in Formulae (E-1), (E-2), and (E-3).

The planar asymmetric compound is preferably, for example, a helicene derivative shown below:

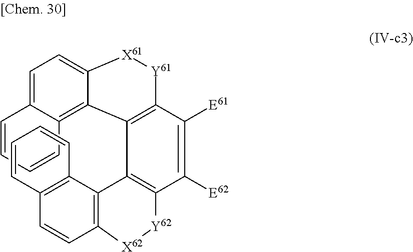

(where, at least one of X⁶¹ and Y⁶¹ and at least one of X⁶² and Y⁶² are present; and X⁶¹, X⁶², Y⁶¹, and Y⁶² each independently represent CH₂, C═O, O, N, S, P, B, or Si, in which N, P, B, and Si are each optionally bound to a substituent such as an alkyl group, an alkoxy group, or an acyl group for satisfying a desired valence.

E⁶¹ and E⁶² each independently represent a hydrogen atom, an alkyl group, an aryl group, an allyl group, a benzyl group, an alkenyl group, an alkynyl group, an alkyl ether group, an alkyl ester group, an alkyl ketone group, a heterocyclic group, or a derivative thereof). In such a helicene derivative, since overlapping adjacent rings cannot freely change the positional relationship, a ring having a right-handed helical structure and a ring having a left-handed helical structure are distinguished from each other to express chirality.

### <Polymerizable Compound>

The ferroelectric liquid crystal composition in the liquid crystal display apparatus of the present invention may contain one or more polymerizable compounds. The polymerizable compound can have a cyclic structure (mesogenic supporting group) such as a cyclohexane skeleton or a benzene skeleton or does not have any mesogenic supporting group.

The polymerizable compound having a mesogenic supporting group is preferably represented by Formula (PC1):

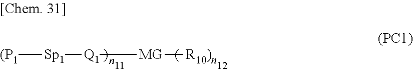

(where, P₁ represents a polymerizable group; Sp₁ represents a spacer group having 0 to 20 carbon atoms; Q₁ represents a single bond, —O—, —OCH₂—, —CH₂O—, —C₂H₄—, —COO—, —OCO—, —CH═CH—, —CO—, —OCOO—, —NH—, —NHCOO—, —OCONH—, —OCOCH₂—, —CH₂OCO—, —COOCH₂—, —CH₂COO—, —CH═CH—OCO—, —OCO—CH═CH—, —CH═CH—OCO—, —COO—CH═CH—, —CH═CCH₃—OCO—, —COO—CCH₃═CH—, —COOC₂H₄—, —OCOC₂H₄—, —C₂H₄OCO—, —C₂H₄COO—, —C≡C—, —CF₂O—, or —OCF₂—; n₁₁ and n₁₂ each independently represent 1, 2, or 3; and MG represents a mesogenic group or a mesogenic supporting group; and

R₁₀ represents a hydrogen atom, a halogen atom, a cyano group, or an alkyl group having 1 to 25 carbon atoms, in which one or more CH₂ groups of the alkyl group are each optionally substituted with —O—, —S—, —NH—, —N(CH₂)—, —CO—, —COO—, —OCO—, —OCOO—, —SCO—, —COS—, or —C≡C—, provided that oxygen atoms are not directly bound to each other, or R₁₀ represents P₂—Sp₂-Q₂- (where, P₂, Sp₂, and Q₂ are synonymous with P₁, Sp₁, Q₁, respectively)).

In Formula (PC1), MG is preferably has a structure represented by the following formula:

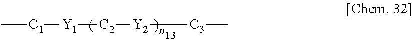

(where, C₁ to C₃ each independently represent a 1,4-phenylene group, a 1,4-cyclohexylene group, a 1,4-cyclohexenyl group, a tetrahydropyrazin-2,5-diyl group, a 1,3-dioxan-2,5-diyl group, a tetrahydrothiopyran-2,5-diyl group, a 1,4-bicyclo(2,2,2)octylene group, a decahydronaphthalen-2,6-diyl group, a pyridin-2,5-diyl group, a pyrimidin-2,5-diyl group, a pyrazin-2,5-diyl group, a 1,2,3,4-tetrahydronaphthalen-2,6-diyl group, a 2,6-naphthylene group, a phenanthren-2,7-diyl group, a 9,10-dinydrophenanthren-2,7-diyl group, a 1,2,3,4,4a,9,10a-octahydrophenanthren-2,7-diyl group, or a fluoren-2,7-diyl group, in which the 1,4-phenylene group, the 1,2,3,4-tetrahydronaphthalen-2,6-diyl group, the 2,6-naphthylene group, the phenanthren-2,7-diyl group, the 9,10-dihydrophenanthren-2,7-diyl group, the 1,2,3,4,4a,9,10a-octahydrophenanthren-2,7-diyl group, and the fluoren-2,7-diyl group are each optionally substituted with one or more of F, Cl, CF₃, OCF₃, a cyano group, an alkyl, alkoxy, alkanoyl, or alkanoyloxy group having 1 to 8 carbon atoms, and an alkenyl, alkenyloxy, alkenoyl, or alkenoyloxy groups having 2 to 8 carbon atoms; Y₁ and Y₂ each independently represent COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, or a single bond; and n₁₃ represents 0, 1, or 2); and

Sp₁ and Sp₂ each independently represent an alkylene group having 1 to 15 carbon atoms, in which one or more hydrogen atoms of the alkylene group are each independently optionally substituted with a halogen atom, a cyano group, a methyl group, or an ethyl group, and one or more CH₂ groups of the alkylene group are each optionally substituted with —O—, —S—, —NH—, —N(CH₃)—, —CO—, —COO—, —OCO—, —OCOO—, —SCO—, —COS—, or —C≡C—, provided that oxygen atoms are not directly bound to each other; and P₁ and P₂ preferably each independently have a structure represented by any of Formulae (R−1) to (R-15):

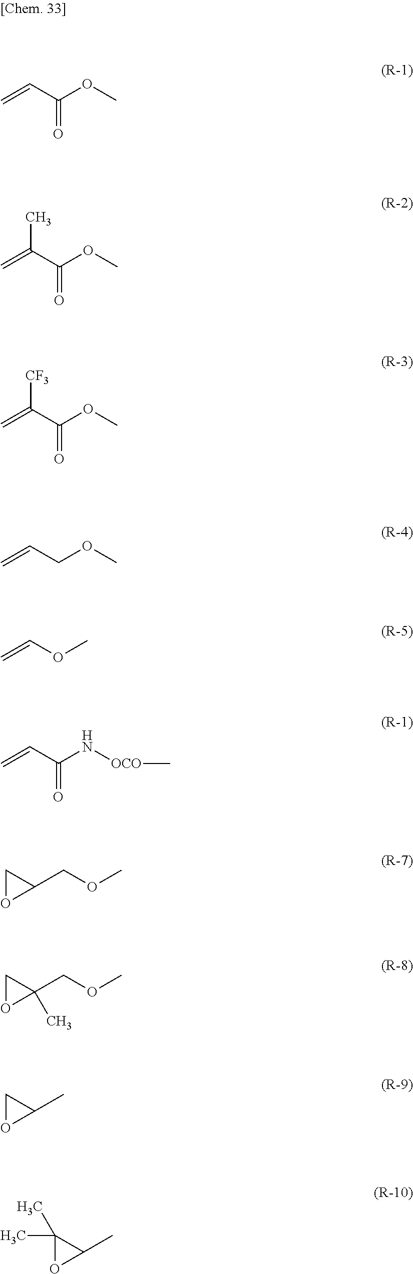

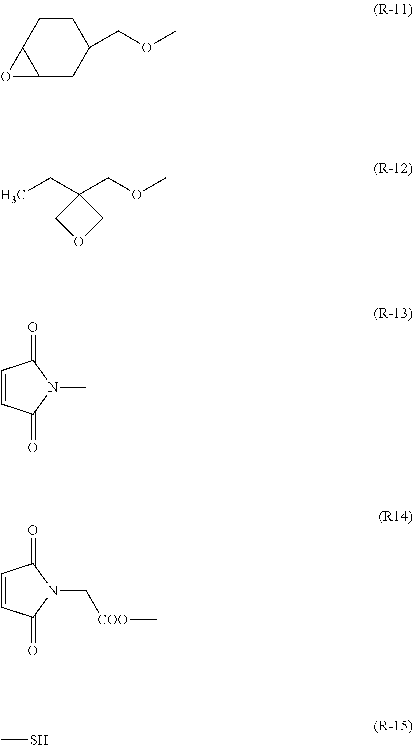

These polymerizable groups are cured through radical polymerization, radical addition polymerization, cationic polymerization, or anionic polymerization. In particular, in ultraviolet polymerization, polymerizable groups represented by Formula (R−1), (R-2), (R-4), (R-5), (R-7), (R-11), (R-13), or (R-15) are preferred; polymerizable groups represented by Formula (R−1), (R-2), (R-7), (R-11), or (R-13) are more preferred; and polymerizable groups represented by Formula (R−1) or (R-2) are more preferred.

The polymerizable compound having a mesogenic supporting group represented by Formula (PC1) can have one polymerizable group in a molecule as shown in Formula (PC1)-0:

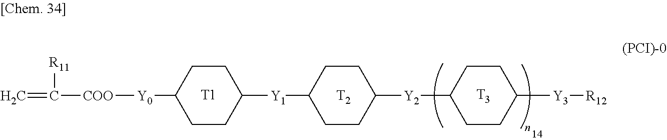

where, R₁₁ represents a hydrogen atom or a methyl group, and the 6-membered rings T₁, T₂, and T₃ each independently represent any of the following structures:

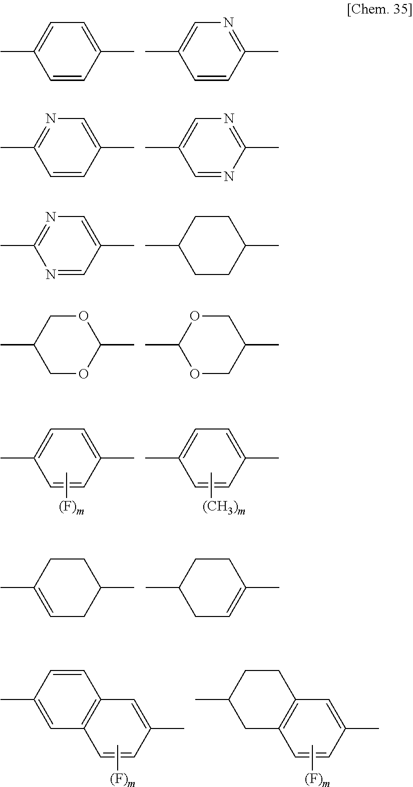

(where, m represents an integer of 1 to 4); and n₁₄ represents an integer of 0 or 1;

Y₀, Y₁, and Y₂ each independently represent a single bond, —O—, —OCH₂—, —OCH₂—, —C₂H₄—, —COO—, —OCO—, —CH═CH—, —CO—, —OCOO—, —NH—, —NHCOO—, —OCONH—, —OCOCH₂—, —CH₂OCO—, —COOCH₂—, —CH₂COO—, —CH═CH—OCO—, —OCO—CH═CH—, —CH═CH—OCO—, —COO—CH═CH—, —CH═CCH₃—OCO—, —COO—CCH₃═CH—, —COOC₂H₄—, —OCOC₂H₄—, —C₂H₄OCO—, —C₂H₄COO—, —C≡C—, —CF₂O—, or —OCF₂—; and Y₃ represents a single bond, —O—, —COO—, or —OCO—; and

R₁₂ represents a hydrogen atom, a halogen atom, a cyano group, an alkyl group having 1 to 20 carbon atoms, an alkenyl group having 1 to 20 carbon atoms, an alkoxy group having 1 to 20 carbon atoms, or a hydrocarbon group having 1 to 20 carbon atoms.

The polymerizable compound having a mesogenic supporting group represented by Formula (PC1) can have a structure having two or more polymerizable groups in a molecule as shown in Formula (PC1)-1 or (PC1)-2:

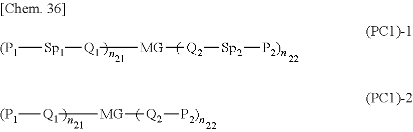

where, P₁, Sp₁, Q₁, P₂, Sp₂, Q₂, and MG are synonymous with those in Formula (PC1); and n₃ and n₄ each independently represent 1, 2, or 3.

The polymerizable compound represented by Formula (PC1)-1 is preferably one or a mixture of two or more polymerizable compounds selected from the group consisting of compounds represented by Formulae (PC1)-3 to (PC1)-11:

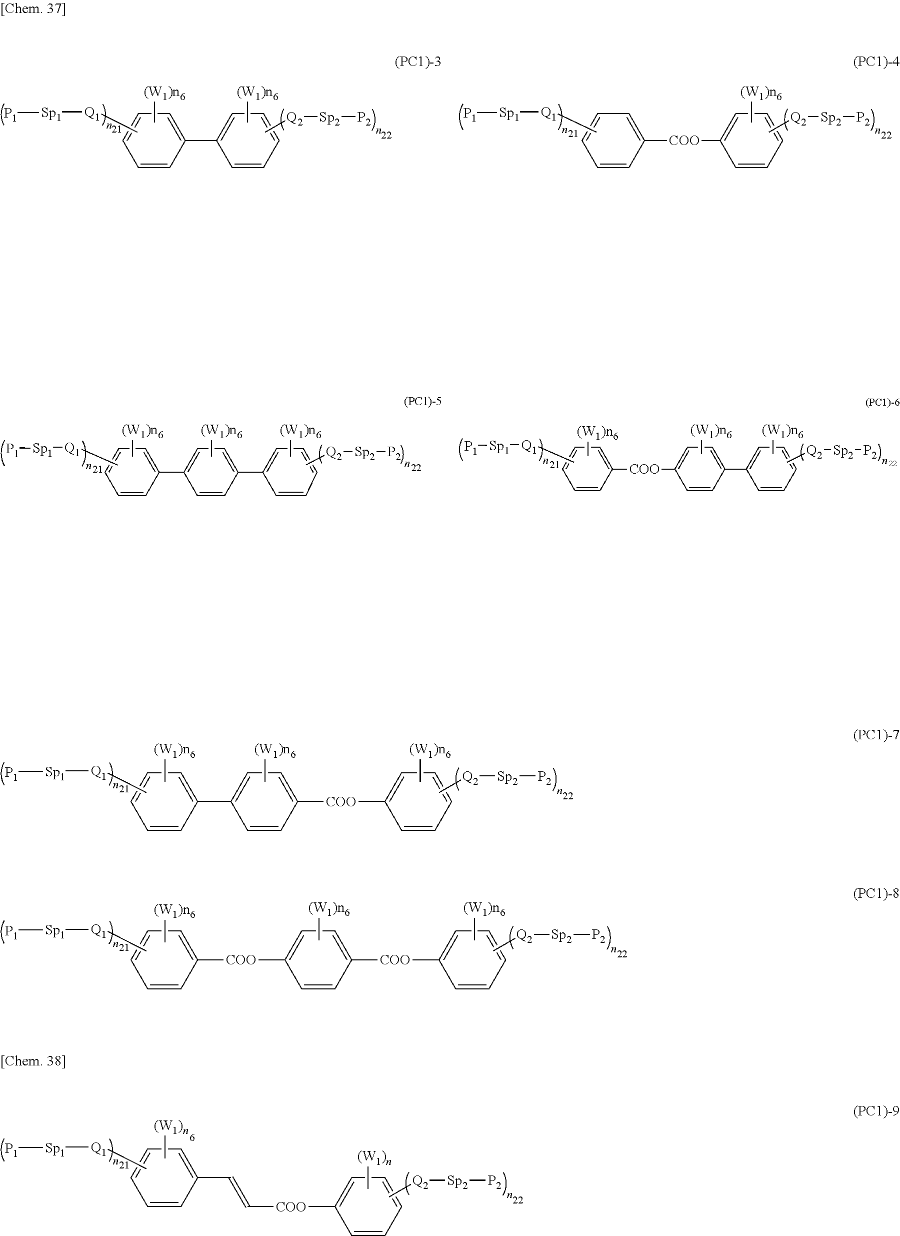

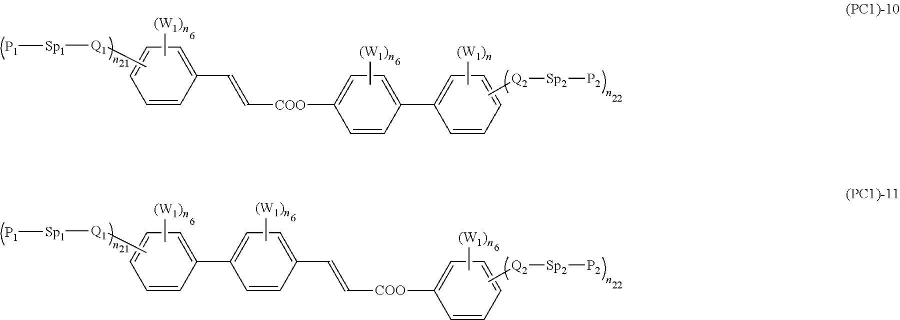

(where, P₁, P₂, Sp₁, Sp₂, Q₁, and Q₂ are synonymous with those in Formula (PC1); W₁'s each independently represent F, CF₃, OCF₃, CH₃, OCH₃, an alkyl, alkoxy, or alkenyl group having 2 to 5 carbon atoms, COOW₂, OCOW₂, or OCOOW₂ (where, W₂'s each independently represent a linear or branched alkyl group having 1 to 10 carbon atoms, or an alkenyl group having 2 to 5 carbon atoms); n₂₁'s each independently represent 1, 2, or 3; n₂₂'s each independently represent 1, 2, or 3; and n₆'s each independently represent 0, 1, 2, 3, or 4, provided that n₂₁+n₆ and n₂₂+n₆ on the same ring are each 5 or less).

In Formulae (PC1)-3 to (PC1)-11, Sp₁, Sp₂, Q₁, and Q₂ are preferably single bonds. n₂₁+n₂₂ is preferably 1 to 3 and more preferably 1 or 2. P₁ and P₂ are each preferably represented by Formula (R−1) or (R-2). W₁ is preferably F, CF₃, OCF₃, CH₃, or OCH₃. n₆ is preferably 1, 2, 3, or 4.

Specifically, compounds shown below are preferred.

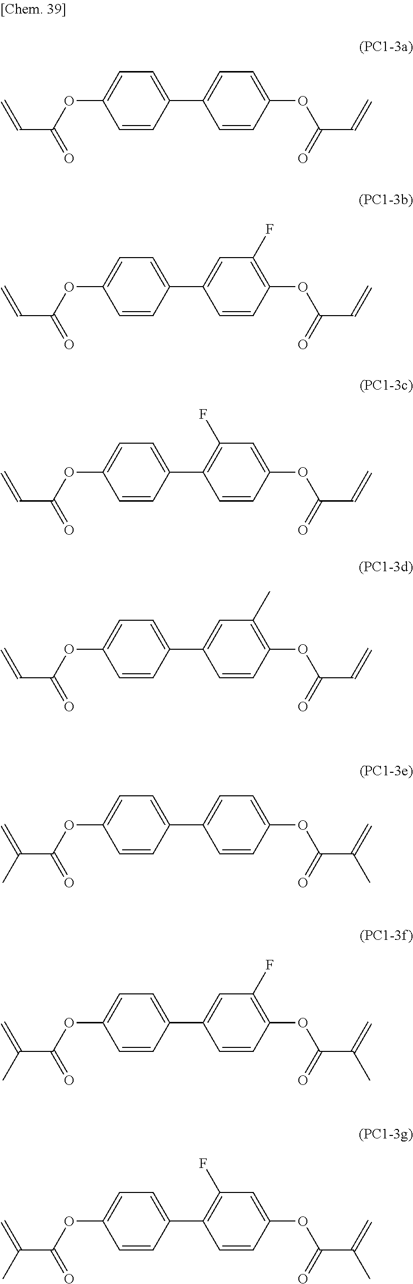

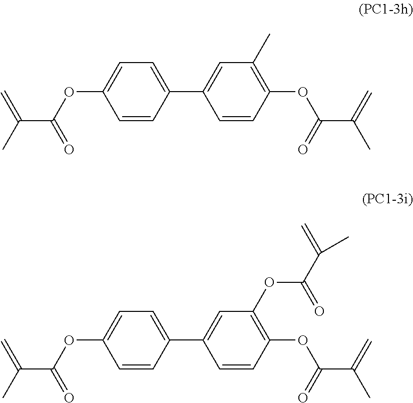

Furthermore, in the compounds represented by Formulae (PC1-3a) to (PC1-3i), a hydrogen atom of each benzene ring is optionally substituted with a fluorine atom.

The Compound represented by Formula (PC1)-1 is also preferably one or a mixture of two or more polymerizable compounds selected from the group consisting of compounds represented by Formula (II-a):

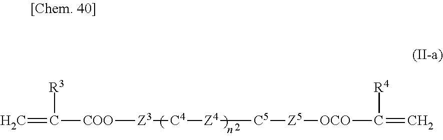

(in Formula (II-a), R³ and R⁴ each independently represent a hydrogen atom or a methyl group;

C⁴ and C⁵ each independently represent a 1,4-phenylene group, a 1,4-cyclohexylene group, a pyridin-2,5-diyl group, a pyrimidin-2,5-diyl group, a pyridazin-3,6-diyl group, a 1,3-dioxan-2,5-diyl group, a cyclohexen-1,4-diyl group, a decahydronaphthalen-2,6-diyl group, a 1,2,3,4-tetrahydronaphthalen-2,6-diyl group, a 2,6-naphthylene group, or an indan-2,5-diyl group (among these groups, the 1,4-phenylene group, the 1,2,3,4-tetrahydronaphthalen-2,6-diyl group, the 2,6-naphthylene group, and the indan-2,5-diyl group may be unsubstituted or are each optionally substituted with one or more of a fluorine atom, a chlorine atom, a methyl group, a trifluoromethyl group, and a trifluoromethoxy group);

Z³ and Z⁵ each independently represent a single bond or an alkylene group having 1 to 15 carbon atoms (where, one or more methyl groups of the alkylene group are each independently optionally substituted with an oxygen atom, —CO—, —COO—, or —OCO—, provided that oxygen atoms are not directly bound to each other, and one or more hydrogen atoms of the alkylene group are each independently optionally substituted with a fluorine atom, a methyl group, or an ethyl group);

Z⁴ represents a single bond, —CH₂CH₂—, —CH₂O—, —OCH₂—, —CH₂CH₂O—, —OCH₂CH₂—, —CH₂CH₂CH₂O—, —OCH₂CH₂CH₂—, —CH₂CH₂OCO—, —COOCH₂CH₂—, —CH₂CH₂COO—, —OCOCH₂CH₂—, —CH═CH—, —C≡C—, —CF₂O—, —OCF₂—, —COO—, or —OCO—; and n² represents 0, 1, or 2, where when n² represents 2, two or more C⁴'s may be the same or different and two or more Z⁴'s may be the same or different), and compounds represented by Formula (II-b):

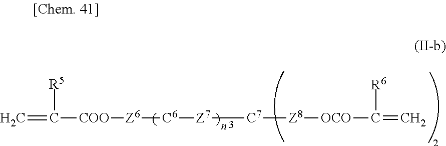

(in Formula (II-b), R⁵ and R⁶ each independently represent a hydrogen atom or a methyl group;

C⁶ represents a 1,4-phenylene group, a 1,4-cyclohexylene group, a pyridin-2,5-diyl group, a pyrimidin-2,5-diyl group, a pyridazin-3,6-diyl group, a 1,3-dioxan-2,5-diyl group, a cyclohexen-1,4-diyl group, a decahydronaphthalen-2,6-diyl group, a 1,2,3,4-tetrahydronaphthalen-2,6-diyl group, a 2,6-naphthylene group, or an indan-2,5-diyl group (among these groups, the 1,4-phenylene group, the 1,2,3,4-tetrahydronaphthalen-2,6-diyl group, the 2,6-naphthylene group, and the indan-2,5-diyl group may be unsubstituted or are each optionally substituted with one or more of a fluorine atom, a chlorine atom, a methyl group, a trifluoromethyl group, and a trifluoromethoxy group);

C⁷ represents a benzen-1,2,4-triyl group, a benzen-1,3,4-triyl group, a benzen-1,3,5-triyl group, a cyclohexan-1,2,4-triyl group, a cyclohexan-1,3,4-triyl group, or a cyclohexan-1,3,5-triyl group;

Z⁶ and Z⁸ each independently represent a single bond or an alkylene group having 1 to 15 carbon atoms (where, one or more methylene groups of the alkylene group are each independently optionally substituted with an oxygen atom, —CO—, —COO—, or —OCO—, provided that oxygen atoms are not directly bound to each other, and one or more hydrogen atoms of the alkylene group are each independently optionally substituted with a fluorine atom, a methyl group, or an ethyl group);

Z⁷ represents a single bond, —CH₂CH₂—, —CH₂O—, —OCH₂—, —CH₂CH₂O—, —OCH₂CH₂—, —CH₂CH₂CH₂O—, —OCH₂CH₂CH₂—, —CH₂CH₂OCO—, —COOCH₂CH₂—, —CH₂CH₂COO—, —OCOCH₂CH₂—, —CH═CH—, —C≡C—, —CF₂O—, —OCF₂—, —COO—, or —OCO—; and n³ represents 0, 1, or 2, where when n³ represents 2, two or more C⁶'s may be the same or different and two or more Z⁷'s may be the same or different).

The compound represented by Formula (II-a) is preferably represented by Formula (II-d) or (II-e):

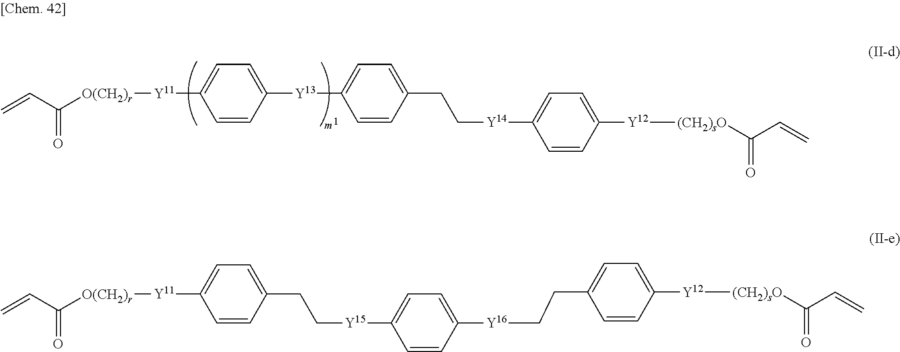

(in Formulae (II-d) and (II-e), m¹ represents 0 or 1;

Y¹¹ and Y¹² each independently represents a single bond, —O—, —COO—, or —OCO—; Y¹³ and Y¹⁴ each independently represent COO— or —OCO—; Y¹⁵ and Y¹⁶ each independently represent COO— or —OCO—; and r and s each independently represent an integer of 2 to 14. The 1,4-phenylene group in each formula may be unsubstituted or is optionally substituted with one or more of a fluorine atom, a chlorine atom, a methyl group, a trifluoromethyl group, or a trifluoromethoxy group). The use of these compounds can provide optically anisotropic compounds having high mechanical strength and excellent heat resistance and is therefore preferred.

Examples of the compounds represented by Formula (II-a) include compounds represented by Formulae (II-1) to (II-10):

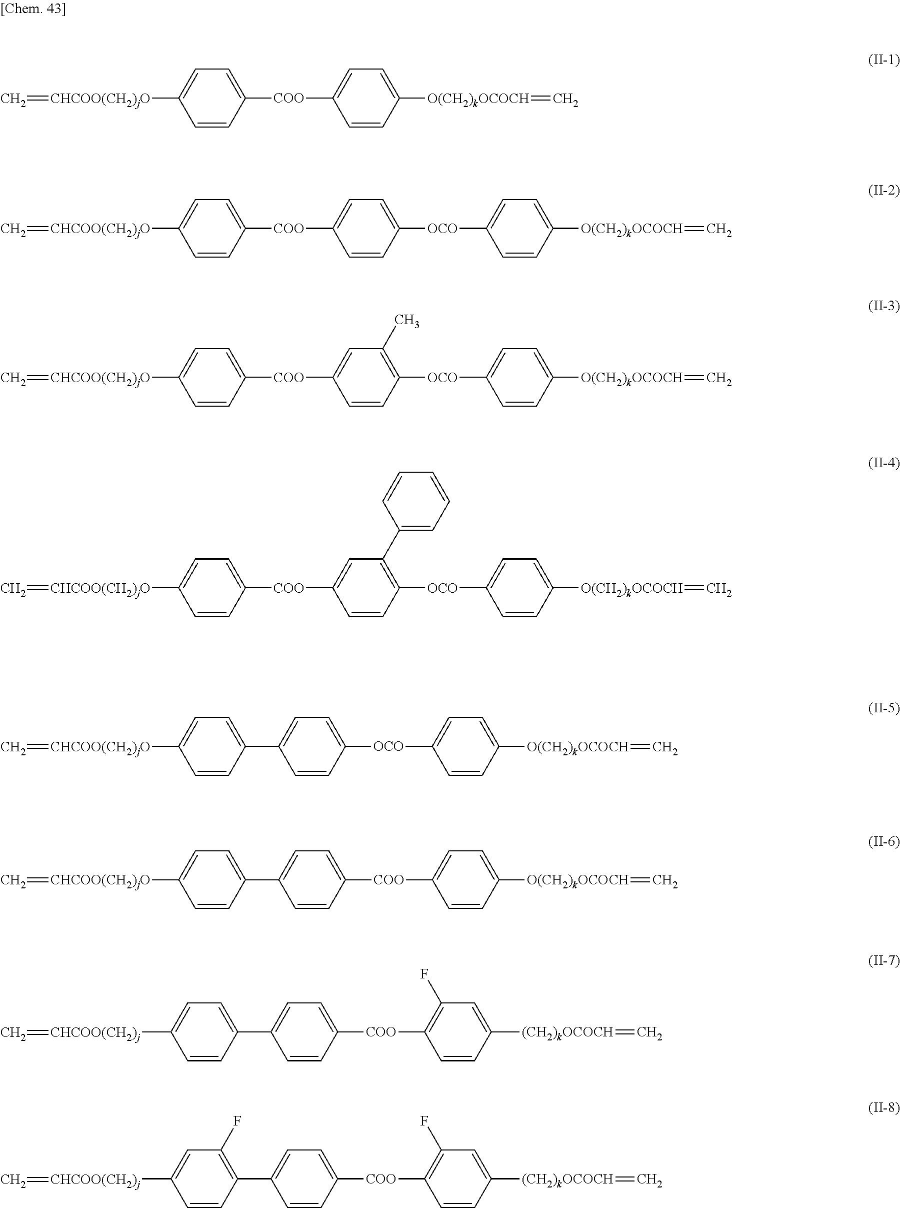

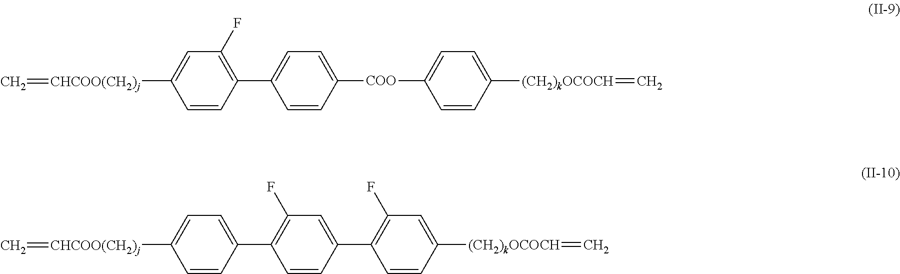

where, j and k each independently represent an integer of 2 to 14.

Examples of the compounds represented by Formulae (II-d) and (II-e) include compounds represented by Formulae (II-11) to (II-20):

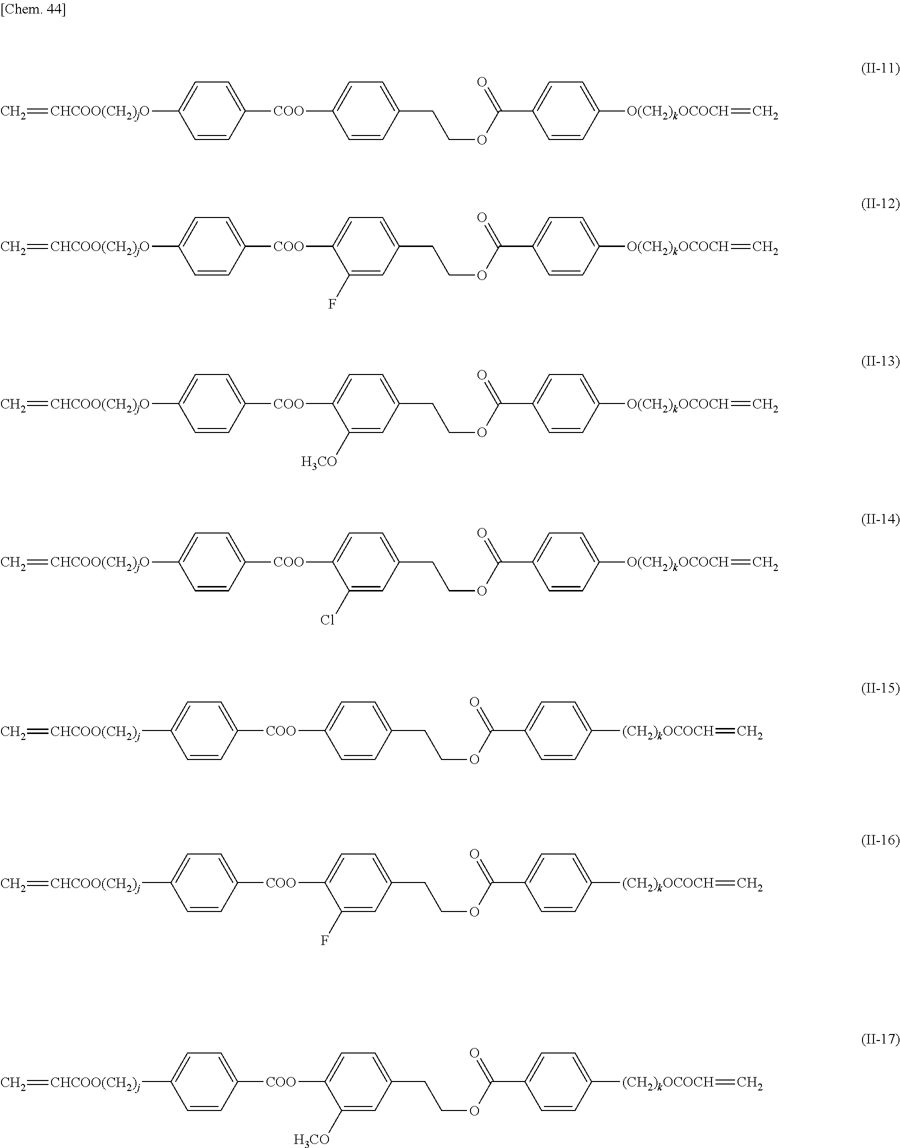

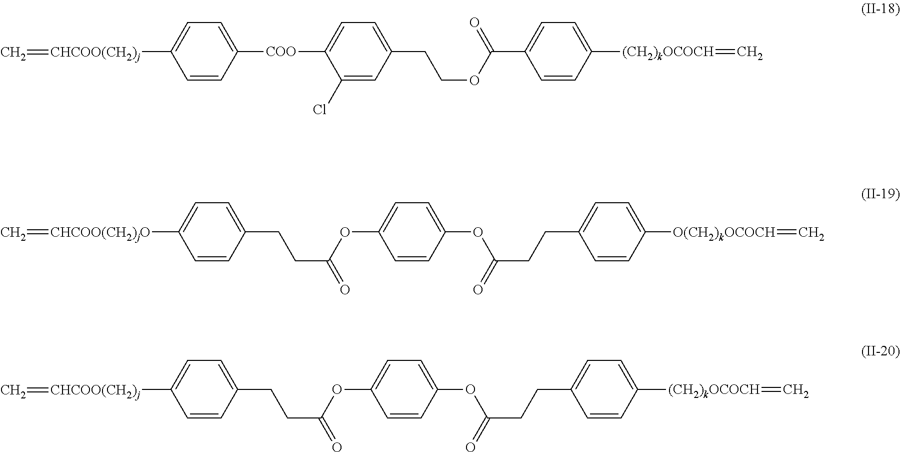

where, j and k each independently represent an integer of 2 to 14.

Polymerizable compounds not having mesogenic supporting groups are preferably represented by Formula (PC2):

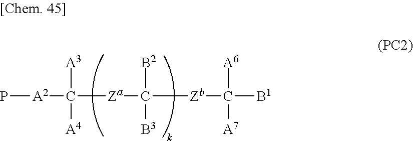

(where, P represents a polymerizable group, A² represents a single bond or an alkylene group having 1 to 15 carbon atoms (where, one or more methylene groups of the alkylene group are each independently optionally substituted with an oxygen atom, —CO—, —COO—, or —OCO—, provided that oxygen atoms are not directly bound to each other, and one or more hydrogen atoms of the alkylene group are each independently optionally substituted with a fluorine atom, a methyl group, or an ethyl group);

Z^{a} and Z^{b} are each represent a single bond or an alkylene group having 1 to 15 carbon atoms (where, one or more methylene groups of the alkylene group are each independently optionally substituted with an oxygen atom, —CO—, —COO—, or —OCO—, provided that oxygen atoms are not directly bound to each other, and one or more hydrogen atoms of the alkylene group are each independently optionally substituted with a fluorine atom, a methyl group, or an ethyl group);

A³ and A⁶ each independently represent a hydrogen atom or an alkyl group having 1 to 30 carbon atoms (where, one or more methylene groups of the alkyl group are each independently optionally substituted with an oxygen atom, —CO—, —COO—, or —OCO—, provided that oxygen atoms are not directly bound to each other, and one or more hydrogen atoms of the alkyl group are each independently optionally substituted with a halogen atom or an alkyl group having 1 to 17 carbon atoms);

A⁴ and A⁷ each independently represent a hydrogen atom or an alkyl group having 1 to 10 carbon atoms (where, one or more methylene groups of the alkyl group are each independently optionally substituted with an oxygen atom, —CO—, —COO—, or —OCO—, provided that oxygen atoms are not directly bound to each other, and one or more hydrogen atoms of the alkyl group are each independently optionally substituted with a halogen atom or an alkyl group having 1 to 9 carbon atoms); k represents 0 to 40; and

B¹, B², and B³ each independently represent a hydrogen atom, a linear or branched alkyl group having 1 to 10 carbon atoms (where, one or more methylene groups of the alkyl group are each independently optionally substituted with an oxygen atom, —CO—, —COO—, or —OCO—, provided that oxygen atoms are not directly bound to each other), or a group represented by -A⁸-P (where, A⁸ represents a single bond or an alkylene group having 1 to 15 carbon atoms (where, one or more methylene groups of the alkylene group are each independently optionally substituted with an oxygen atom, —CO—, —COO—, or —OCO—, provided that oxygen atoms are not directly bound to each other, and one or more hydrogen atoms of the alkylene group are each independently optionally substituted with a fluorine atom, a methyl group, or an ethyl group), where, the number of B¹, B², and B³, of which the total number is 2k+1, represented by -A⁸-P is 0 to 3). The polymerizable compounds represented by Formula (PC2) of which the main chains or the alkyl side chains have different lengths may be used in combination.

The polymerizable compound represented by Formula (PC2) preferably has a structure containing one or more compounds selected from the group consisting of compounds represented by Formula (PC2)-1:

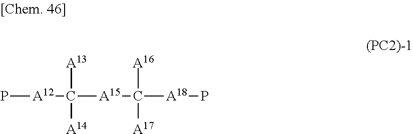

(where, P represents a polymerizable group; A¹² and A¹⁸ each independently represent a single bond or an alkylene group having 1 to 15 carbon atoms (where, one or more methylene groups of the alkylene group are each independently optionally substituted with an oxygen atom, —CO—, —COO—, or —OCO—, provided that oxygen atoms are not directly bound to each other, and one or more hydrogen atoms of the alkylene group are each independently optionally substituted with a fluorine atom, a methyl group, or an ethyl group);

A¹³ and A¹⁶ each independently represent a linear alkyl group having 2 to 20 carbon atoms (where, one or more methylene groups of the linear alkyl group are each independently optionally substituted with an oxygen atom, —CO—, —COO—, or —OCO—, provided that oxygen atoms are not directly bound to each other);

A¹⁴ and A¹⁷ each independently represent a hydrogen atom or an alkyl group having 1 to 10 carbon atoms (where, one or more methylene groups of the alkyl group are each independently optionally substituted with an oxygen atom, —CO—, —COO—, or —OCO—, provided that oxygen atoms are not directly bound to each other, and one or more hydrogen atoms of the alkyl group are each independently optionally substituted with a halogen atom or an alkyl group having 1 to 9 carbon atoms);

A¹⁵ represents an alkylene group having 9 to 16 carbon atoms (where, one hydrogen atom of each of one to five methylene groups of the alkylene group is independently substituted with a linear or branched alkyl group having 1 to 10 carbon atoms, and one or more methylene groups of the alkylene group are each independently optionally substituted with an oxygen atom, —CO—, —COO—, or —OCO—, provided that oxygen atoms are not directly bound to each other); compounds represented by Formula (PC2)-2:

P—(CH₂)ₐ—P(PC2)-2 [Chem. 47]

(where, P represents a polymerizable group; and a represents an integer of 6 to 22);
compounds represented by Formula (PC2)-3:

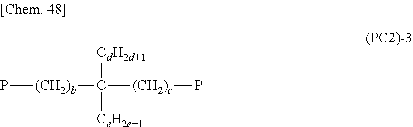

(where, P represents a polymerizable group; b and c each independently represent an integer of 1 to 10; d represents an integer of 1 to 10; and e represents an integer of 0 to 6); and
compounds represented by Formula (PC2)-4:

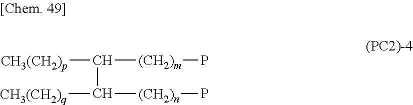

(where, P represents a polymerizable group; and m, n, p, and q each independently represent an integer of 1 to 10). Among these compounds, compounds represented by Formula (PC2)-1 are more preferred.

The polymerizable group P can have a structure represented by any of Formulae (R−1) to (R-15):

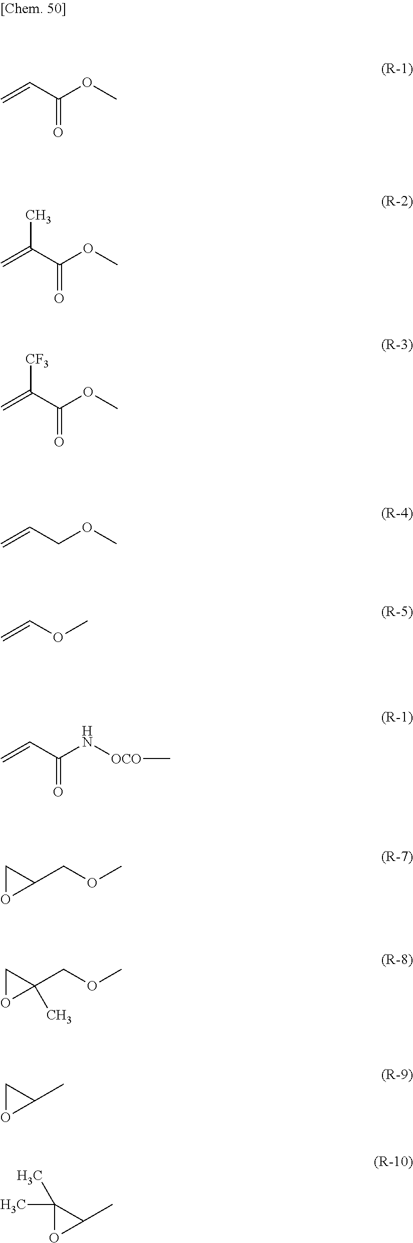

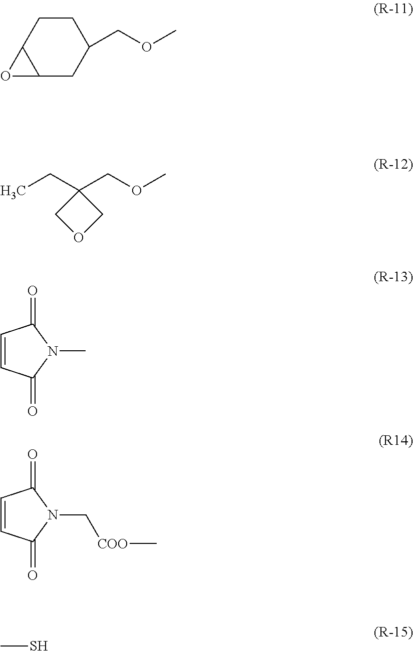

Preferred polymerizable groups are represented by Formula (R−1), (R-2), (R-4), (R-5), (R-7), (R-11), (R-13), or (R-15); more preferred polymerizable groups are represented by Formula (R−1), (R-2), (R-7), (R-11), or (R-13); and more preferred polymerizable groups are represented by Formula (R−1) or (R-2). Furthermore, polymerizable compounds represented by Formula (R−1) are particularly preferred because of its high rate of polymerization.

A¹² and A¹⁸ preferably each independently represent a single bond or an alkylene group having 1 to 3 carbon atoms. The distance between two polymerizable groups can be adjusted by independently varying the numbers of carbon atoms of A¹², A¹⁸, and A¹⁵. The compound represented by Formula (PC2)-1 is characterized by the long distance between polymerizable functional groups (distance between crosslinking points). However, a too long distance causes a significant reduction in polymerization rate to adversely affect the phase separation. Accordingly, the distance between polymerizable functional groups has an upper limit. On the other hand, the distance between two side chains, A¹³ and A¹⁶, affects the mobility of the main chain. That is, a short distance between A¹³ and A¹⁶ causes interference between side chains A¹³ and A¹⁶, resulting in a decrease in mobility. Accordingly, the compound represented by Formula (PC2)-1 is preferred to have a long distance between polymerizable functional groups, which is determined based on the sum of the lengths of A¹², A¹⁸, and A¹⁵, by elongating the length of A¹⁵ not by elongating the lengths of A¹² and A¹⁸.

In addition, the lengths of side chains A¹³, A¹⁴, A¹⁶ and A¹⁷ are preferably determined as follows.

In Formula (PC2)-1, when side chains A¹³ and A¹⁴ bound to the same carbon atom of the main chain have different lengths from each other, a longer side chain is referred to as A¹³ (when A¹³ and A¹⁴ have the same length, either one of them is referred to as A¹³). Similarly, when the lengths of A¹⁶ and A¹⁷ are different from each other, the longer side chain is referred to as A¹⁶ (when A¹⁶ and A¹⁷ have the same length, either one of them is referred to as A¹⁶).

Such A¹³ and A¹⁶ are, in the present invention, each independently a linear alkyl group having 2 to 20 carbon atoms (where, one or more methylene groups of the linear alkyl group are each independently optionally substituted with an oxygen atom, —CO—, —COO—, or —OCO—, provided that oxygen atoms are not directly bound to each other).

Preferably, A¹³ and A¹⁶ are each independently a linear alkyl group having 2 to 18 carbon atoms (where, one or more methylene groups of the linear alkyl group are each independently optionally substituted with an oxygen atom, —CO—, —COO—, or —OCO—, provided that oxygen atoms are not directly bound to each other).

More preferably, A¹³ and A¹⁶ are each independently a linear alkyl group having 3 to 15 carbon atoms (where, one or more methylene groups of the linear alkyl group are each independently optionally substituted with an oxygen atom, —CO—, —COO—, or —OCO—, provided that oxygen atoms are not directly bound to each other).

A side chain has a higher mobility than the main chain and thereby contributes to an improvement in the mobility of a polymer chain at low temperature, but conversely, occurrence of spatial interference between two side chains as described above reduces the mobility. In order to inhibit the spatial interference between side chains, it is effective to increase the distance between side chains and to decrease the lengths of the side chains within a necessary range.

Furthermore, in the present invention, A¹⁴ and A¹⁷ are each independently a hydrogen atom or an alkyl group having 1 to 10 carbon atoms (where, one or more methylene groups of the alkyl group are each independently optionally substituted with an oxygen atom, —CO—, —COO—, or —OCO—, provided that oxygen atoms are not directly bound to each other, and one or more hydrogen atoms of the alkyl group are each independently optionally substituted with a halogen atom or an alkyl group having 1 to 9 carbon atoms). A¹⁴ and A¹⁷ preferably each independently represent a hydrogen atom or an alkyl group having 1 to 7 carbon atoms (where, one or more methylene groups of the alkyl group are each independently optionally substituted with an oxygen atom, —CO—, —COO—, or —OCO—, provided that oxygen atoms are not directly bound to each other); more preferably each independently represent a hydrogen atom or an alkyl group having 1 to 5 carbon atoms (where, one or more methylene groups of the alkyl group are each independently optionally substituted with an oxygen atom, —CO—, —COO—, or —OCO—, provided that oxygen atoms are not directly bound to each other); and most preferably each independently represent a hydrogen atom or an alkyl group having 1 to 3 carbon atoms (where, one or more methylene groups of the alkyl group are each independently optionally substituted with an oxygen atom, —CO—, —COO—, or —OCO—, provided that oxygen atoms are not directly bound to each other).

Also in A¹⁴ and A¹⁷, if the lengths thereof are too long, spatial interference is disadvantageously caused between the side chains. On the other hand, when A¹⁴ and A¹⁷ are alkyl chains having short lengths, it is believed that they can have high mobility and inhibit an approach between adjacent main-chain moieties and that they can prevent interference between polymer main-chain moieties to enhance the mobility of the main chain, which can prevent an increase in anchoring energy at low temperature and is effective for improving the characteristics of a polymer stabilized liquid crystal optical device in a low temperature region.

A¹⁵ lying between two side chains preferably has a long length from a viewpoint of varying the distance between side chains and from a viewpoint of broadening the distance between crosslinking points to reduce the glass transition temperature. However, if A¹⁵ is too long, the molecular weight of the compound represented by Formula (PC2)-1 is too large, which reduces the compatibility with a liquid crystal composition and adversely affects the phase separation due to a too low rate of polymerization. These reasons spontaneously restrict the upper limit of the length.

Accordingly, in the present invention, A¹⁵ is preferably an alkylene group having 9 to 16 carbon atoms (where, one hydrogen atom of each of one to five methylene groups of the alkylene group is independently substituted with a linear or branched alkyl group having 1 to 10 carbon atoms, and one or more methylene groups of the alkylene group are each independently optionally substituted with an oxygen atom, —CO—, —COO—, or —OCO—, provided that oxygen atoms are not directly bound to each other).

That is, in the present invention, A¹⁵ preferably has an alkylene chain length of 9 to 16 carbon atoms. A¹⁵ has, as structural characteristics, a structure in which a hydrogen atom of the alkylene group is substituted with an alkyl group having 1 to 10 carbon atoms. The number of substitutions of the alkyl group is one to five, preferably one to three, and more preferably two or three. The number of carbon atoms of the alkyl group as a substituent is preferably one to five and more preferably one to three.

For example, a compound represented by Formula (PC2)-1 in which A¹⁴ and A¹⁷ are hydrogen can be prepared by reacting a compound having a plurality of epoxy groups with a polymerizable compound having active hydrogen reactive with an epoxy group, such as acrylic acid or methacrylic acid, to synthesize a polymerizable hydroxyl group-containing compound and then reacting the polymerizable compound with saturated fatty acid.

Alternatively, the compound can be prepared by reacting a compound having a plurality of epoxy groups with saturated fatty acid to synthesize a hydroxyl group-containing compound and reacting the hydroxyl group-containing compound with a polymerizable compound having a group reactive a hydroxyl group, such as an acrylic acid chloride.

A radically polymerizable compound, for example, represented by Formula (PC2)-1 in which A¹⁴ and A¹⁷ are alkyl groups and A¹² and A¹⁸ are methylene groups having one carbon atom can be prepared by reacting a compound having a plurality of oxetane groups with an oxetane group-reactive compound, such as a fatty acid chloride or fatty acid and further reacting the reaction product with a polymerizable compound having active hydrogen, such as acrylic acid; or by reacting a compound having one oxetane group with an oxetane group-reactive polyvalent fatty acid chloride or fatty acid and further reacting the reaction product with a polymerizable compound having active hydrogen, such as acrylic acid.

A polymerizable compound represented by Formula (PC2)-1 in which A¹² and A¹⁸ are alkylene groups having three carbon atoms (propylene group: —CH₂CH₂CH₂—) can be prepared by using a compound having a plurality of furan groups instead of the oxetane groups. A polymerizable compound represented by Formula (PC2)-1 in which A¹² and A¹⁸ are alkylene groups having four carbon atoms (butylene group: —CH₂CH₂CH₂CH₂—) can be prepared by using a compound having a plurality of pyran groups instead of the oxetane groups.

The polymerizable compound used in the ferroelectric liquid crystal composition in the liquid crystal display apparatus of the present invention is not limited to the above-described achiral materials and may be a chiral material. The photopolymerizable compound showing chirality can be, for example, a polymerizable compound represented by Formula (II-x) or (II-y):

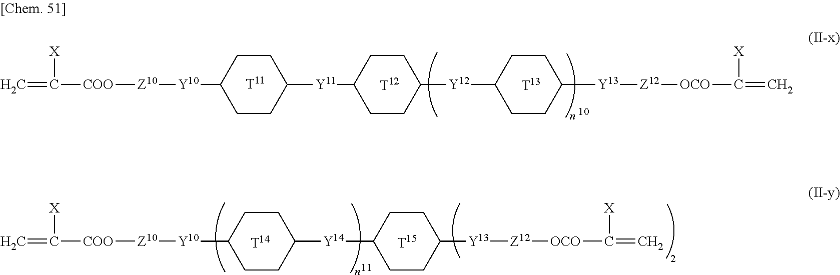

In Formulae (II-x) and (II-y), X represents a hydrogen atom or a methyl group. n¹⁰ represents an integer of 0 or 1, and n¹¹ represents an integer of 0, 1, or 2. When n¹¹ represents 2, two or more T¹⁴'s may be the same or different, and two or more Y¹⁴'s may be the same or different.

The 6-membered rings, Tⁿ, T¹², T¹³, and T¹⁴, each represent a substituent having a 6-membered structure such as a 1,4-phenylene group or a trans-1,4-cyclohexylene group. The 6-membered rings T¹¹, T¹², and T¹³ are not limited to these substituents and may be any one of substituents having the following structures:

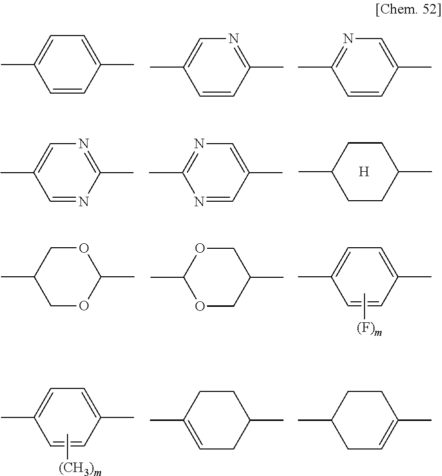

The substituents may be the same or different. In the above-mentioned substituents, m represents an integer of 1 to 4.

In Formula (II-y), T¹⁵ represents a trivalent cyclic group such as a benzen-1,2,4-triyl group, a benzen-1,3,4-triyl group, a benzen-1,3,5-triyl group, a cyclohexan-1,2,4-triyl group, a cyclohexan-1,3,4-triyl group, or a cyclohexan-1,3,5-triyl group.

In Formulae (II-x) and (II-y), Y¹¹, Y¹², and Y¹⁴ each independently represent a linear or branched alkylene group having 1 to 10 carbon atoms, in which one CH₂ group or two non-adjacent CH₂ groups of the alkylene group are each optionally substituted with —O—, —S—, —CO—O—, or —O—CO—, or each optionally contain a single bond, —CH₂CH₂—, —CH₂O—, —OCH₂—, —COO—, —OCO—, —C≡C—, —CH═CH—, —CF═CF—, —(CH₂)₄—, —CH₂CH₂CH₂O—, —OCH₂CH₂CH₂—, —CH═CHCH₂CH₂—, or —CH₂CH₂CH═CH—. Y¹¹, Y¹², and Y¹⁴ each independently contain an asymmetric carbon atom or not. That is, Y¹¹ and Y¹² may be the same or different as long as they have any structure described above.

Y¹⁰ and Y¹³ each represent a single bond, —O—, —OCO—, or —COO—.

Z¹¹ represents an alkylene group having 3 to 20 carbon atoms, containing an asymmetric carbon atom and having a branched chain structure.

Z¹² represents an alkylene group having 1 to 20 carbon atoms and may contain an asymmetric carbon atom or not.

A discotic liquid crystal compound represented by the following Formula (PC1)-9 is also a preferred polymerizable compound.

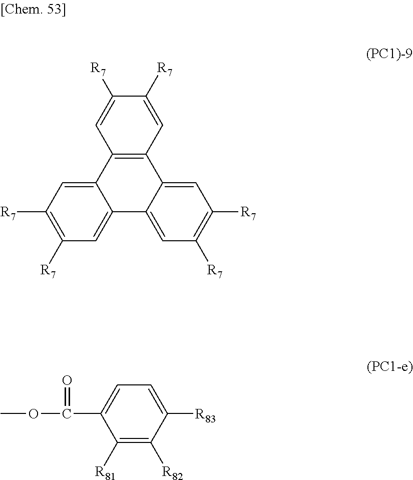

(where, R₇'s each independently represent P₁-Sp₁-Q₁ or a substituent represented by Formula (PC1-e) (where, P₁, Sp₁, and Q₁ are synonymous with those in Formula (PC1), R₈₁ and R₈₂ each independently represent a hydrogen atom, a halogen atom, or a methyl group, and R₈₃ represents an alkoxy group having 1 to 20 carbon atoms, in which at least one hydrogen atom of the alkoxy group is substituted with any of substituents represented by Formulae (R−1) to (R-15)).

The amount of such a polymerizable compound is preferably 10% by mass or less, more preferably 5% by mass or less, and most preferably 2% by mass or less.

### <Ferroelectric Liquid Crystal Composition>

In order to obtain satisfactory orientation, a longer pitch of the chiral nematic phase is preferred. It is preferable to elongate the pitch by cancelling the pitch with a combination of chiral compounds having different chiral pitches as a pitch canceller, an additive for cancelling a pitch. In such a case, it is preferable to select chiral compounds having the same sign not to cancel the spontaneous polarization, or it is preferable to use a combination of chiral compounds having high spontaneous polarization and low spontaneous polarization to obtain sufficient spontaneous polarization as a whole, even if the signs of the spontaneous polarization. Alternatively, it is preferable to select a chiral compound that can give sufficiently high orientation even if such pitch cancelling is not performed.

When the ferroelectric liquid crystal composition of the present invention contains a polymerizable compound, polymerization, such as radical polymerization, anionic polymerization, or cationic polymerization, can be performed. In particular, radical polymerization is preferred.

As a radical polymerization initiator, a thermal polymerization initiator or a photopolymerization initiator can be used. A photopolymerization initiator is preferred, and preferred examples thereof include the following compounds:

acetophenone compounds such as diethoxyacetophenone, 2-hydroxy-2-methyl-1-phenylpropan-1-one, benzyldimethylketal, 1-(4-isopropylphenyl)-2-hydroxy-2-methylpropan-1-one, 4-(2-hydroxyethoxy)phenyl-(2-hydroxy-2-propyl)ketone, 1-hydroxycyclohexyl-phenylketone, 2-methyl-2-morpholino(4-thiomethylphenyl)propan-1-one, and 2-benzyl-2-dimethylamino-1-(4-morpholinophenyl)-butanone;

benzoyl compounds such as benzoin, benzoin isopropyl ether, and benzoin isobutyl ether;

acylphosphine oxides such as 2,4,6-trimethylbenzoyl diphenylphosphine oxide;

benzyl and methylphenylglyoxy ester;

benzophenone compounds such as benzophenone, methyl o-benzoyl benzoate, 4-phenyl-benzophenone, 4,4′-dichlorobenzophenone, hydroxybenzophenone, 4-benzoyl-4′-methyl-diphenyl sulfide, acrylated benzophenone, 3,3′,4,4′-tetra(t-butylperoxycarbonyl)benzophenone, and 3,3′-dimethyl-4-methoxybenzophenone;

thioxanthone compounds such as 2-isopropylthioxanthone, 2,4-dimethylthioxanthone, 2,4-diethylthioxanthone, and 2,4-dichlorothioxanthone;

aminobenzophenone compounds such as Michler ketone and 4,4′-diethylaminobenzophenone; and

10-butyl-2-chloroacridone, 2-ethylanthraquinone, 9,10-phenanthrenequinone, and camphorquinone. Among these compounds, benzyldimethylketal is most preferred.

In the present invention, in addition to the polymerizable liquid crystal compound (PC1), a multifunctional liquid crystalline monomer can be used. Examples of the polymerizable functional group of the multifunctional liquid crystalline monomer include an acryloyloxy group, a methacryloyloxy group, an acrylamido group, a methacrylamido group, an epoxy group, a vinyl group, a vinyloxy group, an ethynyl group, a mercapto group, a maleimide group, ClCH═CHCONH—, CH₂═CCl—, CHCl═CH—, and RCH═CHCOO—(where, R represents chlorine, fluorine, or a hydrocarbon group having 1 to 18 carbon atoms). Among these polymerizable functional groups, preferred are an acryloyloxy group, a methacryloyloxy group, an epoxy group, a mercapto group, and a vinyloxy group, more preferred are a methacryloyloxy group and an acryloyloxy group, and most preferred is an acryloyloxy group.

The multifunctional liquid crystalline monomer has a molecular structure comprising a liquid crystal skeleton having two or more cyclic structures, a polymerizable functional group, and preferably at least two, more preferably at least three, flexible groups linking the liquid crystal skeleton and the polymerizable functional group. Examples of the flexible group include alkylene spacer groups represented by —(CH₂)ₙ— (where, n represents an integer) and siloxane spacer groups represented by —(Si(CH₃)₂—O)ₙ— (where, n represents an integer). Among these spacer groups, alkylene spacer groups are preferred. The linking site between the flexible group and the liquid crystal skeleton or the polymerizable functional group may have a bond such as —O—, —OCO—, or —CO— for mediating the linkage.

In order to assist orientation of a liquid crystal composition (orientation adjuvant), nanoparticles, such as organic particles, inorganic particles, or organic inorganic hybrid particles, may be used. Examples of the organic particles include polymer particles such as polystyrene, polymethyl metacrylate, polyhydroxy acrylate, and divinylbenzene. Examples of the inorganic particles include oxides such as barium titanate (BaTiO₃), SiO₂, TiO₂, and Al₂O₃ and metals such as Au, Ag, Cu, and Pd. The organic particles and the inorganic particles may be hybrid particles having surfaces coated with other materials. The organic inorganic hybrid particles may be inorganic particles having surfaces coated with organic materials. If the organic material applied to the surface of inorganic particles shows liquid crystalline properties, liquid crystal molecules around the particles are advantageously easily oriented.

In addition, as necessary, for example, an antioxidant, an ultraviolet absorber, an unreactive oligomer or inorganic filler, an organic filler, a polymerization inhibitor, an antifoaming agent, a leveling agent, a plasticizer, or a silane coupling agent can be appropriately used. In addition, for example, a biaxial compound such as discotic liquid crystal and a trapping material for ionic and polar compounds can be used.

When two polarizing plates are used, the viewing angle and the contrast can be adjusted by controlling the polarization axis of each polarizing plate.

The substrate surface supporting liquid crystal can be provided with an oriented film. The oriented film can be a general oriented film such as a polyimide film or a photo-oriented film.

The oriented film is preferably a vertically oriented film.

The oriented film is preferably a vertically oriented polyimide film, and examples thereof include acid anhydrides having a substituted long alkyl chain or alicyclic group, polyamic acid prepared by reacting diamine having a substituted long alkyl chain or alicyclic group with an acid-dianhydride, and polyimide prepared by dehydration and decyclization of the polyamic acid. A liquid crystal oriented film having vertical orientation can be produced by forming a film of a liquid crystal orienting agent composed of polyimide, polyamide, or polyamic acid having such a bulk group on a substrate.

Examples of the acid anhydride include compounds represented by Formulae (VII-a1) to (VII-a3). Examples of the diamine include compounds represented by Formulae (VII-b1) to (VII-b3).

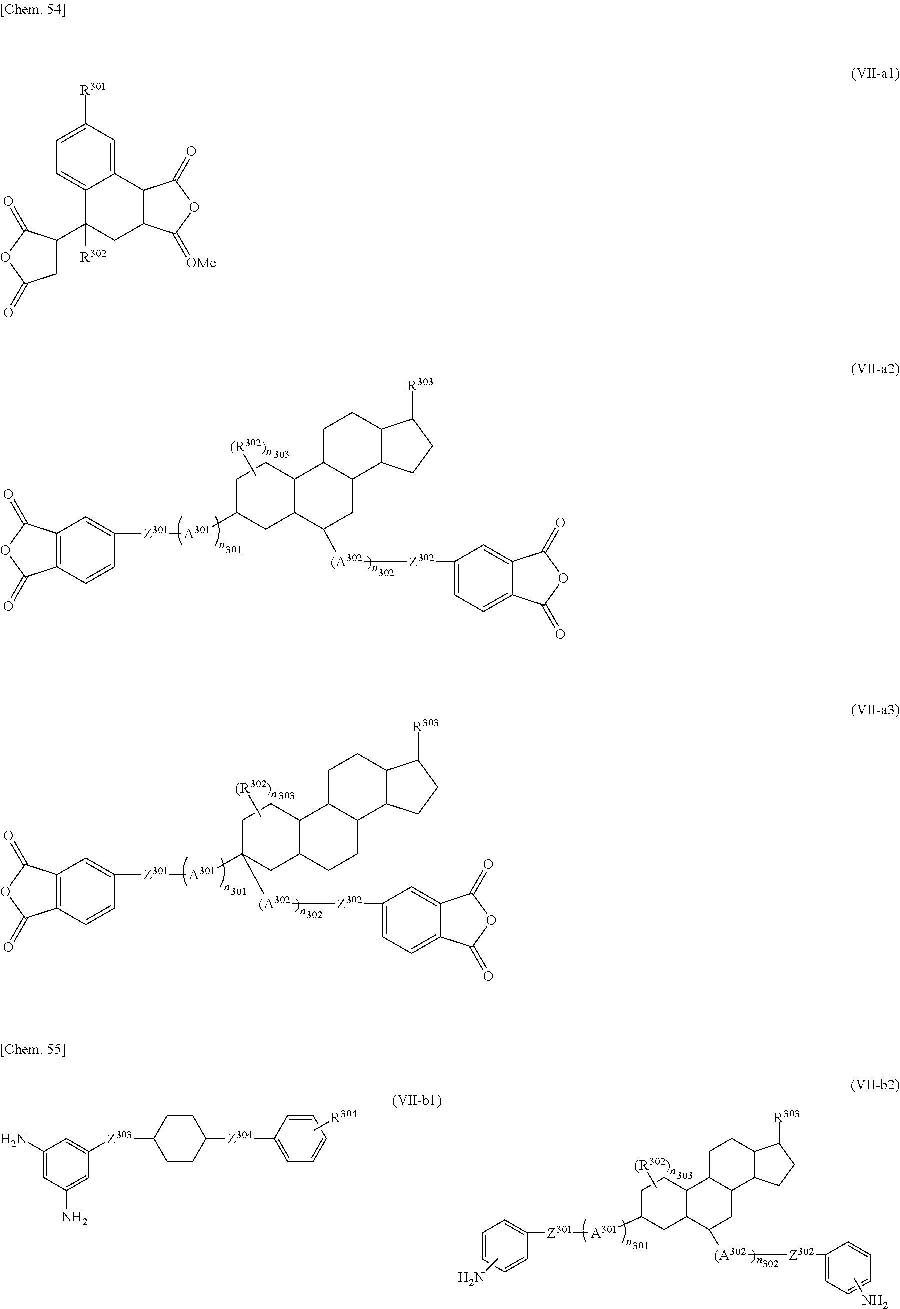

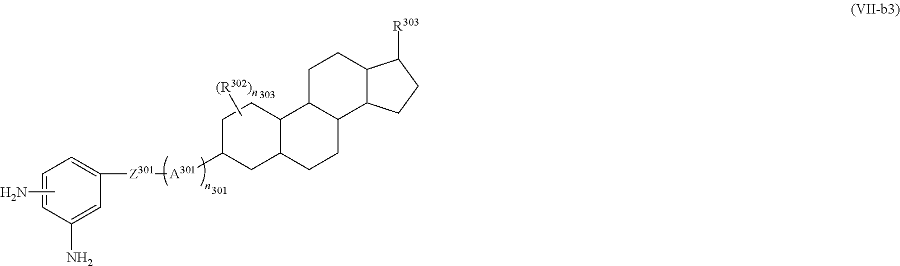

In Formulae (VII-a1) to (VII-a3) and (VII-b1) to (VII-b3), R³⁰¹, R³⁰², R³⁰³, and R³⁰⁴ each independently represent a linear or branched alkyl group having 1 to 30 carbon atoms, a hydrogen atom, or a fluorine atom, in which one —CH₂— group or two or more non-adjacent —CH₂— of the alkyl group are each optionally substituted with —O—, —S—, —NH—, —N(CH₃)—, —CO—, —CO—O—, —O—CO—, —O—CO—O—, —S—CO—, —CO—S—, —O—SO₂—, —SO₂—O—, —CH═CH—, —C≡C—, a cyclopropylene group, or —Si(CH₃)₂—, and one or more hydrogen atoms of the alkyl group are each optionally substituted with a fluorine atom, a chlorine atom, or a bromine atom, a CN group;

Z³⁰¹, Z³⁰², Z³⁰⁵, and Z³⁰⁴ each independently represent —O—, —S—, —CO—, —CO—O—, —O—CO—, —O—CO—O—, —OCH₂—, —CH₂O—, —SCH₂—, —CH₂S—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—CO—O—, —O—CO—CH═CH—, or a single bond;

A³⁰¹ and A³⁰² each independently represent a cyclic group selected from a phenylene group, a cyclohexylene group, a dioxolanediyl group, a cyclohexenylene group, a bicyclo[2.2.2]octylene group, a piperidinediyl group, a naphthalenediyl group, a decahydronaphthalenediyl group, a tetrahydronaphthalenediyl group, and an indanediyl group. In the phenylene group, the naphthalenediyl group, the tetrahydronaphthalenediyl group, and the indanediyl group, one or more —CH═ groups in each ring are each optionally substituted with a nitrogen atom. In the cyclohexylene group, the dioxolanediyl group, the cyclohexenylene group, the bicyclo[2.2.2]octylene group, the piperidinediyl group, the decahydronaphthalenediyl group, the tetrahydronaphthalenediyl group, and the indanediyl group, one —CH₂— group or two non-adjacent —CH₂— groups in each ring are each optionally substituted with —O— and/or —S—, and one or more hydrogen atoms of the cyclic group are each optionally substituted with a fluorine atom, a chlorine atom, a bromine atom, a CN group, a NO₂ group, or an alkyl, alkoxy, alkylcarbonyl, or alkoxycarbonyl group having 1 to 7 carbon atoms in which one or more hydrogen atoms are each optionally substituted with a fluorine atom or a chlorine atom.

n³⁰¹ and n³⁰² each independently represent 0 or 1, and n³⁰³ represents an integer of 0 to 5.

In Formulae (VII-a2) to (VII-a3) and (VII-b2) to (VII-b3), a —CH₂— group of the steroid skeleton is optionally substituted with —O— and/or —S—, and the steroid skeleton optionally contains one or more unsaturated bonds (C═C) at arbitrary positions.

In a transverse electric field type liquid crystal display device applying an electric field in a transverse direction, an oriented film containing a polyamic acid or polyimide having a structure represented by Formula (VII-c1) or (VII-c2) as a liquid crystal orienting agent has excellent afterimage characteristics and can reduce light transmittance in a dark state by unapplying an electric field and is therefore preferred.

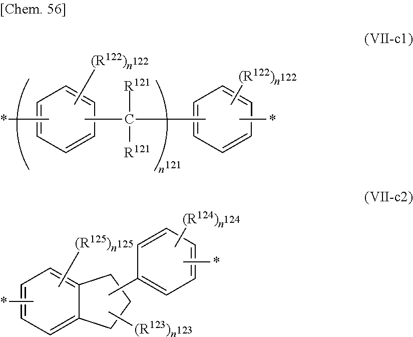

In Formula (VII-c1), R¹²¹'s each independently represent an alkyl group having 1 to 6 carbon atoms;

R¹²²'s each independently represent an alkyl group having 1 to 6 carbon atoms, a halogen atom, a cyano group, a hydroxyl group, or a carboxyl group;
n¹²¹ represents an integer of 1 to 10;
n¹²²'s each independently represent an integer of 0 to 4; and the symbol “*” represents a bonding hand.

In Formula (VII-c2), R¹²³'s each independently represent an alkyl group having 1 to 6 carbon atoms;

R¹²⁴'s each independently represent an alkyl group having 1 to 6 carbon atoms, a halogen atom, a cyano group, a hydroxyl group, or a carboxyl group;
n¹²³ represents an integer of 0 to 5;
n¹²⁴ represents an integer of 0 to 4;
n¹²⁵ represents an integer of 0 to 3; and the symbol “*” represents a bonding hand.

A polyamic acid having both a structure represented by Formula (VII-c1) and a structure represented by Formula (VII-c2) in at least a part of the molecule can be prepared by, for example, reacting a tetracarboxylic dianhydride having a structure represented by Formula (VII-c1) and a tetracarboxylic dianhydride having a structure represented by Formula (VII-c2) with a diamine or by reacting a diamine having a structure represented by Formula (VII-c1) and a diamine having a structure represented by Formula (VII-c2) with a tetracarboxylic dianhydride.

Examples of the tetracarboxylic dianhydride having a structure represented by Formula (VII-c1) or (VII-c2) include compounds having phthalic anhydride groups as benzene rings on both ends each having a bonding hand represented by symbol “*”.

Examples of the diamine having a structure represented by Formula (VII-c1) or (VII-c2) include compounds having aniline groups as benzene rings on both ends each having a bonding hand represented by symbol “*”.

Examples of the photo-oriented film include photo-oriented films having a structure such as azobenzene, stilbene, α-hydrazono-β-keto ester, or coumarin and formed by photoisomerization; photo-oriented films having a structure such as azobenzene, stilbene, benzylidene phthalic diimide, or cinnamoyl and formed by photogeometric isomerization; photo-oriented films having a structure such as spiropyran or spirooxazine and formed by photo-ring-opening or closing reaction; photo-oriented films having a structure such as cinnamoyl, chalcone, coumarin, or diphenylacetylene and formed by photodimerization; photo-oriented films having a structure such as soluble polyimide or cyclobutane polyimide and formed by photolysis through light irradiation; and photo-oriented films formed by light irradiation of polyimide prepared through reaction of biphenyltetracarboxylic dianhydride and diaminodiphenyl ether (BPDA/DPE).

The photo-oriented film can be produced by irradiating a coating film containing a compound having a photo orientation group with light having anisotropy to arrange the photo orientation group and fixing the photo-oriented state.

When the compound having a photo orientation group has a polymerizable group, the compound is preferably polymerized after light irradiation for imparting liquid crystal orienting capability. Polymerization may be either photopolymerization or thermal polymerization. In photopolymerization, a photopolymerization initiator is added to a photo orienting agent, and photo irradiation photopolymerization is performed by irradiation with, for example, light having different wavelengths after light irradiation. On the other hand, in thermal polymerization, a thermal polymerization initiator is added to a photo orienting agent, and thermal polymerization is performed by heating after light irradiation.

In order to fix the photo-oriented state of a photo-oriented film, a photo-crosslinking polymer may be also used. Examples of the photo-crosslinking polymer for the photo-oriented film include the compounds described below:

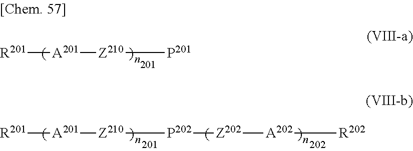

(where, R²⁰¹ and R²⁰² each independently represent a linear or branched alkyl group having 1 to 30 carbon atoms, a hydrogen atom, or a fluorine atom, in which one —CH₂— group or two or more non-adjacent —CH₂— group of the alkyl group are each optionally substituted with —O—, —S—, —NH—, —N(CH₃)—, —CO—, —CO—O—, —O—CO—, —O—CO—O—, —S—CO—, —CO—S—, —O—SO₂—, —SO₂—O—, —CH═CH—, —C≡C—, a cyclopropylene group, or —Si(CH₃)₂—, and one or more hydrogen atoms of the alkyl group are each optionally substituted with a fluorine atom, a chlorine atom, a bromine atom, or a CN group; the alkyl group optionally contains a polymerizable group; the alkyl group optionally contains a fused or spirocyclic system; and the alkyl group optionally contains one or more aromatic or aliphatic rings optionally containing one or more hetero atoms, in which each of the rings is optionally substituted with an alkyl group, an alkoxy group, or a halogen;

Z²⁰¹ and Z²⁰² each independently represent —O—, —S—, —CO—, —CO—O—, —O—CO—, —O—CO—O—, —CO—N(R^{a})—, —N(R^{a})—CO—, —OCH₂—, —CH₂O—, —SCH₂—, —CH₂S—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—CO—O—, —O—CO—CH═CH—, or a single bond, in which R^{a} of —CO—N(R^{a})— or —N(R^{a})—CO— represents a hydrogen atom or a linear or branched alkyl group having 1 to 4 carbon atoms;

A²⁰¹ and A²⁰² each independently represent a cyclic group selected from a phenylene group, a cyclohexylene group, a dioxolanediyl group, a cyclohexenylene group, a bicyclo[2.2.2]octylene group, a piperidinediyl group, a naphthalenediyl group, a decahydronaphthalenediyl group, a tetrahydronaphthalenediyl group, and an indanediyl group. In the phenylene group, the naphthalenediyl group, the tetrahydronaphthalenediyl group, and the indanediyl group, one or more —CH═ groups in each ring are each optionally substituted with a nitrogen atom. In the cyclohexylene group, the dioxolanediyl group, the cyclohexenylene group, the bicyclo[2.2.2]octylene group, the piperidinediyl group, the decahydronaphthalenediyl group, the tetrahydronaphthalenediyl group, and the indanediyl group, one —CH₂— group or two non-adjacent —CH₂— groups in each ring are each optionally substituted with —O— and/or —S—, and one or more hydrogen atoms of the cyclic group are each optionally substituted with a fluorine atom, a chlorine atom, a bromine atom, a CN group, a NO₂ group, or an alkyl, alkoxy, alkylcarbonyl, or alkoxycarbonyl group having 1 to 7 carbon atoms in which one or more hydrogen atoms are optionally substituted with a fluorine atom or a chlorine atom.

n₂₀₁ and n₂₀₂ each independently represent an integer of 1 to 3;

P²⁰¹ and P²⁰² each independently represent a photo orientation group such as cinnamoyl, coumarin, benzylidene phthaldiimide, chalcone, azobenzene, or stilbene; P²⁰¹ represents a monovalent group; and P²⁰² represents a divalent group.

More preferred examples of the compound include compounds represented by Formula (VII-c) having a cinnamoyl group, represented by Formula (VII-d) having a coumarin group, and represented by Formula (VII-e) having a benzylidene phthaldiimide group.

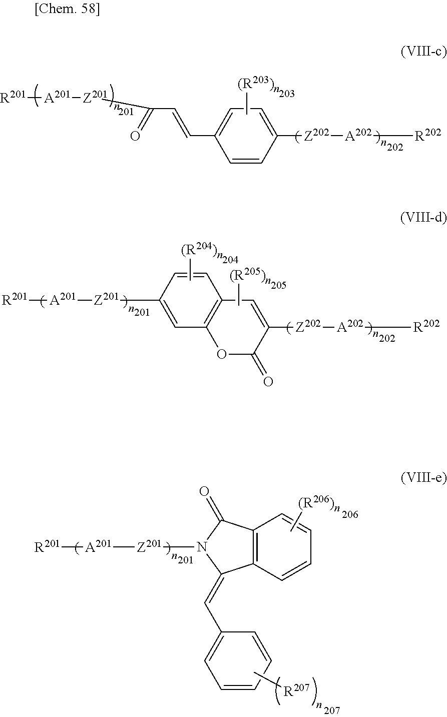

In Formulae (VII-c), (VII-d), and (VII-e), definitions of R²⁰¹, R²⁰², A²⁰¹, A²⁰², Z²⁰¹, Z²⁰², n₂₀₁, and n₂₀₂ are the same as in Formulae (VII-a) and (VII-b);

R²⁰³, R²⁰⁴, R²⁰⁵, R²⁰⁶, and R²⁰⁷ each independently represent a halogen atom (F, Cl, Br, or I), a methyl group, a methoxy group, —CF₃, —OCF₃, a carboxy group, a sulfo group, a nitro group, an amino group, or a hydroxy group;

n²⁰³ represents an integer of 0 to 4; n²⁰⁴ represents an integer of 0 to 3; n²⁰⁵ represents an integer of 0 to 1; n²⁰⁶ represents an integer of 0 to 4; and n²⁰⁷ represents an integer of 0 to 5.

### EXAMPLES

The present invention will now be specifically described by examples, but is not limited to the following examples. Note that “%” means “% by mass” unless otherwise specified.

The abbreviations and meanings of voltage-transmittance characteristics of the liquid crystal display devices shown in examples are as follows:

V₁₀: value of voltage necessary for achieving a light transmittance defined by (T₁₀₀−T₀)×0.1+T₀, when the light transmittance (T₀) of a liquid crystal display device in a no-voltage-application state is defined as 0%, and the light transmittance (T₁₀₀) at which the light transmittance no longer varies and is saturated by increasing the voltage applied to the device is defined as 100%; and
V₉₀: value of voltage necessary for achieving a light transmittance defined by (T₁₀₀−T₀)×0.9+T₀, when the light transmittance (T₀) of a liquid crystal display device in a no-voltage-application state is defined as 0%, and the light transmittance (T₁₀₀) at which the light transmittance no longer varies by increasing the voltage applied to the device is defined as 100%.

In voltage-transmittance measurement, a cell was placed between two polarizing plates in a cross Nicol state, interdigitated array electrodes are disposed such that the major axis forms an angle of 45° relative to the polarization axis of the polarizing plate, and the change in quantity of transmitted light was measured by applying a square-wave voltage with a frequency of 60 Hz in a range of 0 to 50 Vₒ₋ₚ.

### Example 1

Two substrates each provided with a vertically oriented film (polyimide vertically oriented film JALS 2096, manufactured by JSR Corporation) were prepared such that the vertically oriented film on the first substrate and the vertically oriented film on the second substrate were antiparallel to each other by rubbing as in parallel orientation, and interdigitated array electrodes (ITO transparent electrodes, distance between the electrodes: 12.5 μm, electrode width: 20 μm) were disposed. The two substrates were faced with a cell thickness (gap) of 4 μm, and a ferroelectric liquid crystal composition LC-1 shown below was injected therein by means of a capillary phenomenon by heating. After the injection, the liquid crystal cell was sealed to produce a liquid crystal display device of Example 1.

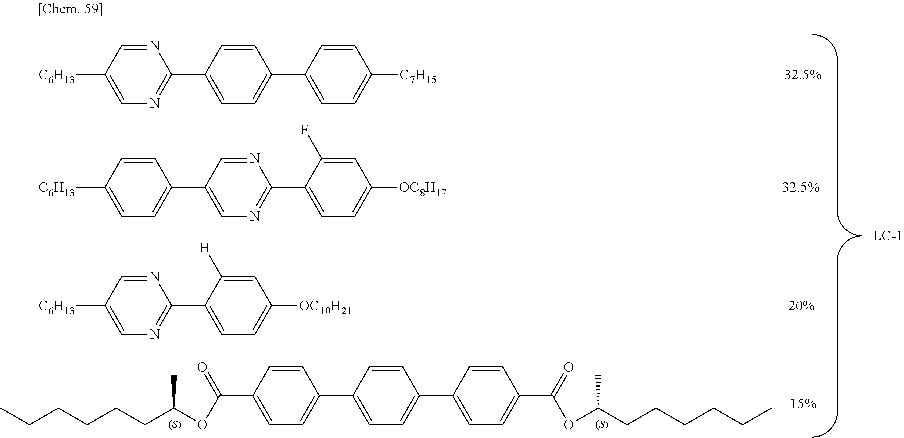

The ferroelectric liquid crystal composition LC-1 was ISO-N*-SmC* phase sequence, in which the phase transition temperature between the ISO and N* phases was 119° C., the phase transition temperature between the N* and SmC* phases was 86.5° C., and the width of the N* phase temperature was 32.5° C. The helical pitch at a temperature (88.5° C.) higher by 2° C. than the transition temperature from N* to SmC* was 87 μm. Slow cooling from a temperature of 90° C. showing the N* phase at a rate of 2° C./min formed a completely dark field at 89° C. and caused phase transition to SmC* in a vertical orientation. The dark field state was maintained even at room temperature.

In Example 1, the aperture ratio, which was the ratio of area between the interdigitated array electrodes through which light passed, was 0.385. The retardation was measured with REST-100 manufactured by Otsuka Electronics Co., Ltd. by a rotating photon detecting method.

The retardation in the electric field ON state was 140 nm, the retardation in the OFF state was 1.1 nm, the birefringence in the OFF state was 0.0003, the selective reflection in the OFF state was 980 nm, and the helical pitch was about 0.6 μm. When the cell thickness was 4 μm, the helix turned at least six times.

Observation with a polarizing microscope showed that the complete dark field was maintained when the cell was rotated, and any change was caused to give blackness equivalent to that of an isotropic phase and that there was not absence of light by an orientation defect.

The V-T characteristics measured were a minimum transmittance T₀ of 0.03%, a maximum transmittance T₁₀₀ of 24%, a voltage V₁₀ of 4.5 V, and a voltage V₉₀ of 30.9 V.

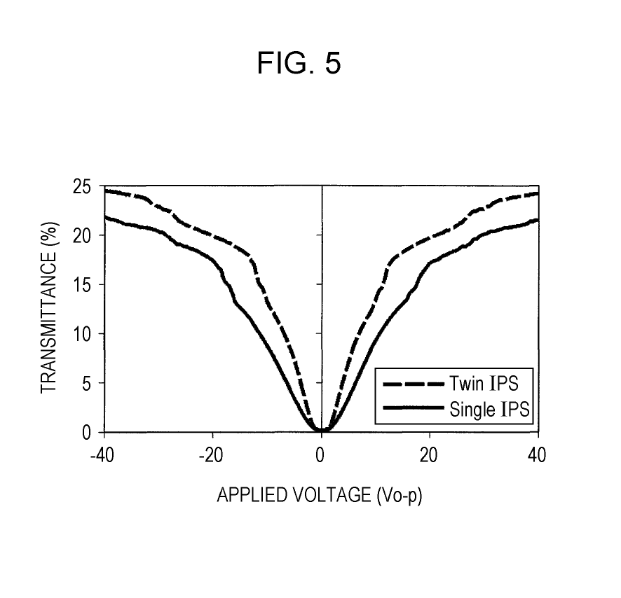

In the structure of Example 1, V-T characteristics were measured for a case of disposing the IPS electrodes on one substrate only (single IPS) and a case of disposing the IPS electrodes on both the pair of substrates (twin IPS). The results are shown in FIG. 5. The minimum transmittance T₀ was 0.03%, the maximum transmittance T₁₀₀ was 24%, the voltage V₁₀ was 2.8 V, and the voltage V₉₀ was 24.6 V.

In both the single IPS and the twin IPS, the transmittance could be modulated depending on the applied voltage. The completely dark field was maintained in the OFF state, and high contrast was achieved by switching ON and OFF.

### Example 2

Two substrates each having a vertically oriented film (polyimide vertically oriented film JALS 2096, manufactured by JSR Corporation) were prepared such that the vertically oriented film on the first substrate and the vertically oriented film on the second substrate were antiparallel to each other by rubbing as in parallel orientation, and interdigitated array electrodes (ITO transparent electrodes, distance between the electrodes: 12.5 μm, electrode width: 20 μm) were disposed. The two substrates were faced with a cell thickness (gap) of 4 μm, and a ferroelectric liquid crystal composition LC-2 shown below was injected therein by means of a capillary phenomenon by heating. After the injection, the liquid crystal cell was sealed to produce a liquid crystal display device of Example 2.

That is, a liquid crystal display device was produced as in Example 1 except that LC-2 was used, instead of LC-1, as the ferroelectric liquid crystal composition.

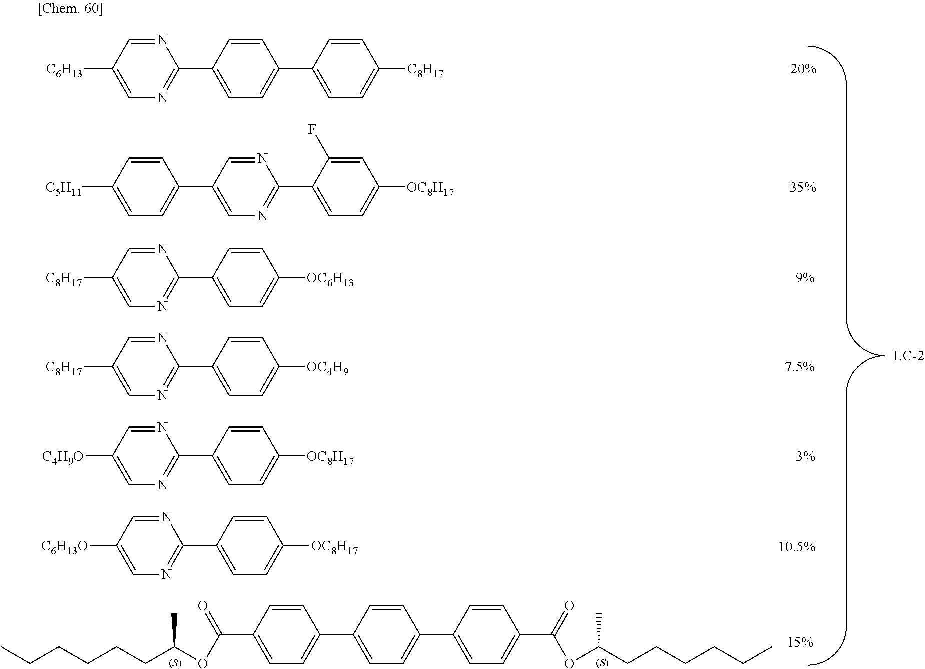

The ferroelectric liquid crystal composition LC-1 was ISO-N*-SmA-SmC* phase sequence, in which the phase transition temperature between the ISO and N* phases was 112.5° C., the phase transition temperature between the N* and SmA phases was 99.4° C., the phase transition temperature between the SmA and SmC* phases was 92.1° C. The helical pitch at a temperature (101.4° C.) higher by 2° C. than the transition temperature from N* to SmC* was 61 μm. Slow cooling from a temperature of 106° C. showing the N* phase at a rate of 2° C./min caused a modification in dark field at about 101° C. and caused phase transition to SmA in a vertical orientation. The dark field state was maintained even at room temperature.

In Example 2, the aperture ratio was 0.385, and the retardation was measured as in Example 1. The retardation in the electric field ON state was 148 nm, the retardation in the OFF state was 5.9 nm, the birefringence in the OFF state was 0.0015, the selective reflection in the OFF state was 1180 nm, and the helical pitch was about 0.8 μm. When the cell thickness was 4 μm, the helix turned at least five times.

Observation with a polarizing microscope showed that the complete dark field was maintained when the cell was rotated, and any change was caused to give blackness equivalent to that of an isotropic phase and that there was not absence of light by an orientation defect.

The V-T characteristics measured were a minimum transmittance T₀ of 0.02%, a maximum transmittance T₁₀₀ of 24%, a voltage V₁₀ of 2.4 V, and a voltage V₉₀ of 24.6 V.

### Example 3

Two substrates each having a vertically oriented film (polyimide vertically oriented film JALS 2096, manufactured by JSR Corporation) were prepared such that the vertically oriented film on the first substrate and the vertically oriented film on the second substrate were antiparallel to each other by rubbing as in parallel orientation, and interdigitated array electrodes (ITO transparent electrodes, distance between the electrodes: 12.5 μm, electrode width: 20 μm) were disposed. The two substrates were faced with a cell thickness (gap) of 14 μm, and a ferroelectric liquid crystal composition LC-4 shown below was injected therein by means of a capillary phenomenon by heating. After the injection, the liquid crystal cell was sealed to produce a liquid crystal display device of Example 3.

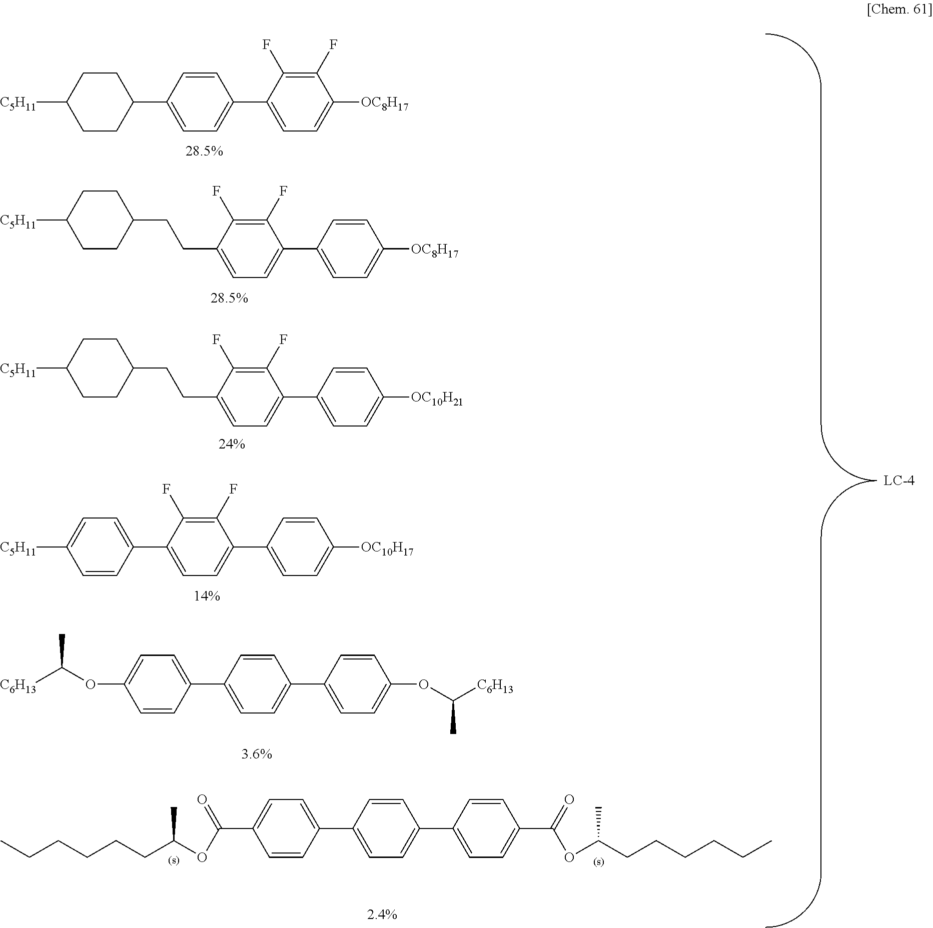

An orientation-free smectic A phase was obtained from a nematic phase by slow cooling at a rate of 2° C./min from a temperature higher by 3° C. than a phase transition temperature (109° C.) to a smectic A phase. Furthermore, phase transition (67° C.) from the smectic A phase to the smectic C* phase was performed, and the temperature was reduced to room temperature, followed by observation with a polarizing microscope. A vertically oriented smectic C* phase was observed as an orientation defect-free phase. The selective reflection was 2850 nm. The produced cell was placed between two polarizing plates in a cross Nicol state, and the V-T characteristics were measured. The driving voltage V₉₀ was 24 V, the minimum transmittance T₀ was 2.9%, and the maximum transmittance T₁₀₀ was 59%. An optical phase compensation film was inserted between the polarizing plates in a cross Nicol state so as to be laminated with the phase opposite to that of the liquid crystal cell, followed by measurement of the V-T characteristics. In the V-T characteristics, the driving voltage V₉₀ was 25 V, the minimum transmittance T₀ was 0.2%, and the maximum transmittance T₁₀₀ was 57%. The degree of polarization when linearly polarized light passed through the liquid crystal cell was measured. The ellipticity was 0.234, and the azimuth was 147°. Similarly, the degree of polarization of the optical phase compensation film was measured. The ellipticity was 0.245, and the azimuth was 3°. In addition, the degree of polarization of a laminate of the liquid crystal cell and the optical phase compensation film was measured. The ellipticity was reduced to 0.066, and the azimuth was 179°, which approximated the center of symmetry as a linear polarization axis of incident light to reduce the minimum transmittance.

### Comparative Example 1

Two substrates each having a vertically oriented film (polyimide vertically oriented film JALS 2096, manufactured by JSR Corporation) were prepared without subjecting the vertically oriented films to rubbing treatment, and interdigitated array electrodes (ITO transparent electrodes, distance between the electrodes: 12.5 μm, electrode width: 20 μm) were disposed. The two substrates were faced with a cell thickness (gap) of 4 μm, and a ferroelectric liquid crystal composition LC-1 was injected therein by means of a capillary phenomenon by heating. After the injection, the liquid crystal cell was sealed to produce a liquid crystal display device of Comparative Example 1.

That is, a liquid crystal display device was produced as in Example 1 except that a ferroelectric liquid crystal composition was injected into a cell not provided with rubbing treatment.

Observation with a polarizing microscope showed that schlieren texture caused by C-director was observed and that no complete dark field was obtained by the absence of light due to scattering.

Measurement of the V-T characteristics showed that the minimum transmittance T₀ was 0.8%, the maximum transmittance Tₙₒ was 23%, the voltage V₁₀ was 2.9 V, and the voltage V₉₀ was 27.8 V.

In Comparative Example 1, the minimum transmittance T₀ was significantly high, compared to Examples above.

### Comparative Example 2

Two substrates each having a vertically oriented film (polyimide vertically oriented film JALS 2096, manufactured by JSR Corporation) were prepared such that the vertically oriented film on the first substrate and the vertically oriented film on the second substrate were antiparallel to each other by rubbing as in parallel orientation, and interdigitated array electrodes (ITO transparent electrodes, distance between the electrodes: 12.5 μm, electrode width: 20 μm) were disposed. The two substrates were faced with a cell thickness (gap) of 3.5 μm, and a ferroelectric liquid crystal composition LC-3 shown below was injected therein by means of a capillary phenomenon by heating. After the injection, the liquid crystal cell was sealed to produce a liquid crystal display device of Comparative Example 2.

That is, a liquid crystal display device was produced as in Example 1 except that LC-3 was used, instead of LC-1, as the ferroelectric liquid crystal composition. In the composition of the following LC-3, the composition of the liquid crystal compounds was the same as that of LC-1, as shown in parentheses as the ratio of each component when the total amount is defined as 90%, and the amount of the chiral dopant contained in the composition was lower than that in Example 1.

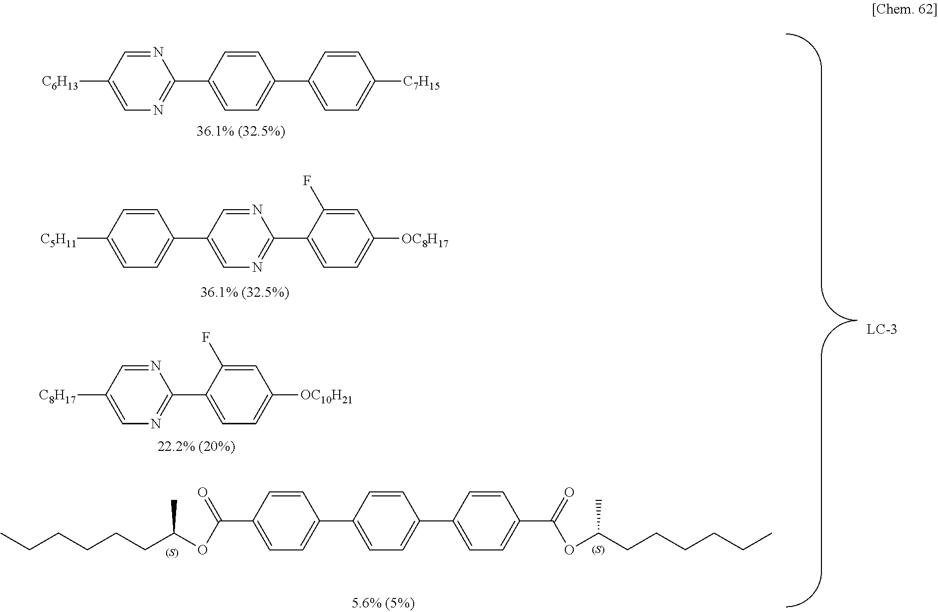

The ferroelectric liquid crystal composition LC-1 was ISO-N*-SmA-SmC* phase sequence, in which the phase transition temperature between the ISO and N* phases was 85.5° C., the phase transition temperature between the N* and SmA phases was 76.4° C., the phase transition temperature between the SmA and SmC* phases was 60.3° C. The helical pitch of chiral nematic liquid crystal at a temperature (87.5° C.) higher by 2° C. than the transition temperature from N* to SmC* was 127 μm.

In Comparative Example 2, the aperture ratio was 0.385, the retardation in the electric field ON state was 116 nm, the retardation in the OFF state was 35 nm, the birefringence in the OFF state was 0.015, and the helical pitch of the SmC* phase was 2.7 μm. The selective reflection in the OFF state was supposed to be about 4200 nm from the helical pitch, though the detection limit of spectrometry is 2700 nm.

Observation with a polarizing microscope showed that a completely dark field was formed when the rubbing orientation direction corresponded to the polarization direction and that a bright field was formed by rotating the cell and was brightest at a tilt of 45 degrees. That is, it was revealed that liquid crystal was uniaxially oriented. This is caused by loosening of the helix.

Measurement of the V-T characteristics showed that the minimum transmittance T₀ was 1.5% (polarization direction), the maximum transmittance T₁₀₀ was 24%)(45°, the voltage V₁₀ was 6.5 V, and the voltage V₉₀ was 35.4 V.

In Comparative Example 2, the helical structure was loosened even at the voltage-OFF state, and the transmittance depended on the polarization direction of the light passing therethrough. As a result, formation of a dark field was uncertain.

### Comparative Example 3

The same cell as that in Example 3 was used. An optical phase compensation film was inserted between the polarizing plates in a cross Nicol state so as to be laminated with the phase coordinate to that of the liquid crystal cell, followed by measurement of the V-T characteristics. In the V-T characteristics, the driving voltage V₉₀ was 24 V, the minimum transmittance T₀ was 9.5%, and the maximum transmittance T₁₀₀ was 56%. The degree of polarization when linearly polarized light passed through the liquid crystal cell was measured. The ellipticity was 0.234, and the azimuth was 174°. Similarly, the degree of polarization of the optical phase compensation film was measured. The ellipticity was 0.245, and the azimuth was 176°. In addition, the degree of polarization of a laminate of the liquid crystal cell and the optical phase compensation film was measured. The ellipticity was increased to 0.515, and the azimuth was 157°, which deviated from the center of symmetry as a linear polarization axis of incident light to increase the minimum transmittance.

### REFERENCE SIGNS LIST

10, 20 substrate
11, 21 transparent base material
12, 22 vertically oriented film
13, 23 orientation direction of pretilt
24 electrode structure
31 liquid crystal composition layer
32 liquid crystal molecule
33 circular refractive index distribution
34 elliptical distribution of refractive index

1. A liquid crystal display device comprising:
a first substrate provided with an oriented film and a second substrate provided with an oriented film between two polarizing plates of which the planes of polarization are orthogonal to each other; and
a ferroelectric liquid crystal composition layer having a chiral smectic C-phase between the first and the second substrates, wherein
at least one of the vertically oriented films of the first substrate and the second substrate is provided with orientation treatment capable of forming a pretilt angle in a certain direction;
the ferroelectric liquid crystal composition layer in which the C-director of the liquid crystal molecule is oriented in the certain direction at a portion being in contact with the substrate having the vertically oriented film provided with the orientation treatment;
the director of liquid crystal is twisted by at least 180° between the first substrate and the second substrate;
a substrate surface of at least one of the first substrate and the second substrate is provided with a pair of electrode structures generating electric fields approximately parallel to each other; and
the light transmittance is modulated by varying the birefringence of the ferroelectric liquid crystal composition layer with the electric fields generated by the electrode structures.

2. The liquid crystal display device according to claim 1, wherein retardation is varied by the electric field within a range of 0 to 330 nm.

3. The liquid crystal display device according to claim 1, wherein the helical axis of the chiral smectic C-phase is vertical to the substrate surface; and the selective reflection induced depending on the helical pitch is within 700 to 3000 nm.

4. The liquid crystal display device according to claim 1, wherein the birefringence is 0.007 or less at an electric field of zero.

5. The liquid crystal display device according to claim 1, wherein the ferroelectric liquid crystal composition has phase sequence at least composed of an isotropic phase, a chiral nematic phase, a smectic A phase, and a chiral smectic C-phase from the high temperature side, or has phase sequence at least composed of an isotropic phase, a chiral nematic phase, and a chiral smectic C-phase from the high temperature side.

6. The liquid crystal display device according to claim 1, wherein in the phase sequence of the ferroelectric liquid crystal composition, the helical pitch of the chiral nematic phase is 50 μm or more at a temperature of phase transition from the chiral nematic phase to the smectic A phase or the chiral smectic C-phase during a decrease in temperature or at a temperature higher than the lower limit temperature of the chiral nematic phase by 2° C.

7. The liquid crystal display device according to claim 1, the device further comprising an optical phase compensation film.

8. The liquid crystal display device according to claim 1, the device further comprising an optical phase compensation film, wherein
when the polarization axis of linearly polarized light having the same ellipticity as that of the elliptically polarized light emitted from the liquid crystal layer and entering the liquid crystal layer is defined as a center of symmetry, the optical phase compensation film shows an opposite phase symmetrical relative to the azimuth of elliptically polarized light emitted from the liquid crystal layer.
